(19) United States
(12) Patent Application Publication
(10) Pub. No.: US 2025/0206639 A1
(43) Pub. Date: Jun. 26, 2025

(54) SMART WATER TREATMENT DEVICES, SYSTEMS, AND RELATED METHODS

(71) Applicant: Fritze Technologies LLC, MARCELL, MN (US)

(72) Inventors: Karl J. Fritze, Marcell, MN (US); August J. Fritze, Big Fork, MN (US); Hans K. Fritze, Olathe, KS (US)

(21) Appl. No.: 18/999,635

(22) Filed: Dec. 23, 2024

Related U.S. Application Data
(60) Provisional application No. 63/614,325, filed on Dec. 22, 2023.
(60) Provisional application No. 63/614,339, filed on Dec. 22, 2023.
(60) Provisional application No. 63/614,352, filed on Dec. 22, 2023.

(51) Int. Cl. C02F 1/00

(52) U.S. Cl. CPC C02F 1/008; C02F 2201/005; C02F 2201/006; C02F 2209/006; C02F 2209/40; C02F 2301/043

(57) ABSTRACT

A water treatment apparatus comprises a housing configured to receive pressurized untreated water and output pressurized treated water. A replaceable fluid treatment cartridge with a thin-walled housing is structurally supported by a superstructure within the housing. A fluid flow management module controls the flow of water through the replaceable fluid treatment cartridge. The superstructure provides structural support to the thin-walled housing to withstand pressurized water conditions. The fluid flow management module includes solenoid valves, with at least one normally closed and one normally open solenoid valve. The replaceable fluid treatment cartridge features a smart memory unit that stores data related to usage and performance, communicates with an external controller, and interfaces with internal sensors to monitor water properties. The apparatus also includes a water leak sensor, wireless communication capabilities, multiple flow modes, a control panel, and a fault detection module that monitors operational status and detects fault conditions.

### RELATED APPLICATION(S)

This disclosure claims priority to U.S. Provisional Patent Application Ser. No. 63/614,325, filed on Dec. 22, 2023, and entitled “SMART WATER TREATMENT APPLIANCE AND METHODS FOR ITS USE,” U.S. Provisional Patent Application Ser. No. 63/614,339, filed on Dec. 22, 2023, and entitled “SMART FLUID TREATMENT CARTRIDGE PLATFORM,” and U.S. Provisional Patent Application Ser. No. 63/614,352, filed on Dec. 22, 2023, and entitled “FLUID FLOW MANAGEMENT MODULE,” the disclosures of each of which are hereby incorporated by reference in their entireties.

### TECHNICAL FIELD

This disclosure relates to the field of fluidic treatment to both remove undesired contaminants and condition for beneficial improvement. In particular, the present disclosure is directed to a fluid treatment appliance including low-cost and easily replaceable smart cartridge units, automatic device configuration and monitoring, and ease of installation and use. This application is directed to an example device and related methods of employing this technology.

### BACKGROUND

The treatment of fluids is well known and extensively practiced today. Treatment devices and their associated treatment elements are widely used throughout industry and residential use. The media or treatment element is very often located in an enclosed container which allows a fluid to be directed into the container, interact with the treatment element, and then be directed out of the container. Replaceable treatment cartridges are used in many industries for removal or deactivation of contaminants and conditioning or enhancement of a fluid. Primary examples of these include cartridges for water treatment and filtration such as for use in hospitals, restaurants, water fountains, whole house, under sink, countertop, and refrigerators.

Water treatment media normally found in many water treatment systems today are either in a large bulk tank, a replaceable wet change element, or replaceable dry-change cartridges which use a polymer housing with an internal media element. Treatment media with replaceable elements can be classified as wet-change or dry-change. The main advantage of a wet-change element is their low cost of replacement and their minimal impact to the environment for discarding or recycling. Many of the water treatment systems currently in use are connected to a water supply system which can have water pressures typically as high as 80 pounds per square inch (psi), but water pressures can be as high as 120 psi. Structural testing for this application according to NSF-42 typically requires surviving thousands of cyclic pressure pulses from 0 to 150 psi and a static pressure test of 3 and 4 times the rated system pressure. A structural housing sufficient to safely enclose a wet-change treatment element is typically molded from a robust chemically inert polymer with substantially thick walls and has a large opening threaded sump. The head of the wet-change housing (or sump) is often times attached to a mounting bracket and screwed to a surface such as a cabinet or wall. It is often difficult to unthread and open the sump and can require a specialized spanner wrench to get sufficient torque to crack the sump free, unthread the wet sump, pour off the water, remove the treatment element, clean the sump, reinstall a new treatment element, and tighten it enough to keep it from leaking. The wet-change replacement process is not always something a consumer is willing or able to do.

Dry-change cartridges are used for example in refrigerators and provide an easy way for consumers to change them without getting wet in the process. Unfortunately, the simple convenience of using quick dry-change cartridges negatively impacts the environment with landfills containing spent cartridges, which do not decompose and are difficult to recycle. Most dry-change water filter cartridges are designed to be connected to a pressurized water system and typically are used at the point-of-use. Replaceable treatment cartridge housings sufficient to handle residential or commercial water pressures approaching 120 psi must also be made from thick-walled construction sufficient to survive cyclic fatigue, burst pressures, and in some cases, freezing. These structural cartridges are expensive and their treatment elements only last a few months to a year in service before being discarded into a landfill. They are expensive to manufacture, waste precious resources, are non-biodegradable, easy to throw away, but difficult to recycle.

The majority of water filter cartridges are rotated or twisted to install them into their respective water manifold, thus connecting them with the water system. These “quarter-turn” quick dry-change filters typically operate some type of valving by the act of rotating the filter as it is received and secured. The rotation process can become difficult as the sealing members with the filter ports can become stuck and require significant torque for the user to remove. In some instances, the user will need to use a tool to apply the necessary torque to break any stiction and release the filter. Wet sump systems are also difficult to change because their sealing element diameters are much larger, which is required to receive the large diameter of the entire wet treatment element. Further, the traditional type of seal used in wet-change housings is an O-ring, which is compressed at the last stage of tightening which compresses its face axially. The ability of the wet sump housing to seal against its mating head is dependent on the amount of torque used and forces generated to draw the sump tight placing the o-ring in compression with its axial face seal. The resulting stiction of the housing threads engaged with its head threads and coupled with elastomeric sealing faces getting bonded together over time requires even more torque to disassemble. A large custom wrench is generally used to break the stiction. Releasing the housing can even tear out the fasteners holding the head bracket to the wall or mounting surface.

### SUMMARY

According to one aspect of the present disclosure, an apparatus for water treatment comprises a cabinet configured to receive a source of pressurized untreated water and output pressurized treated water; a replaceable fluid treatment cartridge with a thin-walled housing, the cartridge being structurally supported by a superstructure within the cabinet; a fluid flow management module configured to control the flow of water through the replaceable fluid treatment cartridge; wherein the superstructure is configured to provide the necessary structural support to the thin-walled housing of the replaceable fluid treatment cartridge to withstand pressurized water conditions.

The present disclosure provides an apparatus that comprises a housing configured to receive a source of pressurized untreated water and output pressurized treated water. Within the cabinet, a replaceable fluid treatment cartridge with a thin-walled housing is structurally supported by a superstructure. A fluid flow management module controls the flow of water through the replaceable fluid treatment cartridge. The superstructure provides the necessary structural support to the thin-walled housing of the replaceable fluid treatment cartridge to withstand pressurized water conditions. This design allows for easy replacement of the cartridge without the need for specialized tools or excessive force.

The apparatus for water treatment described herein introduces a novel design that incorporates a replaceable fluid treatment cartridge with a thin-walled housing, which is structurally supported by a superstructure within the housing. This arrangement allows the thin-walled cartridge to withstand pressurized water conditions, which would otherwise require a thicker, more robust housing. The superstructure provides the necessary support, enabling the use of lightweight, recyclable materials for the cartridge housing, thereby reducing manufacturing costs and environmental impact.

The fluid flow management module within the apparatus is configured to control the flow of water through the replaceable fluid treatment cartridge, ensuring efficient and effective water treatment. The integration of the superstructure with the thin-walled cartridge housing simplifies the replacement process, eliminating the need for specialized tools or excessive force, which is often required with traditional thick-walled cartridges. This design enhances user convenience and accessibility, making it easier for consumers to maintain their water treatment systems.

Additionally, the use of a superstructure to support the thin-walled cartridge housing allows for a more compact and lightweight design, which can be beneficial for various applications, including residential and commercial water treatment systems. The ability to withstand high-pressure conditions while using a thin-walled housing also ensures the durability and reliability of the apparatus, meeting industry standards for water treatment systems.

According to another aspect, the apparatus comprises a fluid flow management module with a plurality of solenoid valves configured to control the flow of water through the replaceable fluid treatment cartridge.

According to yet another aspect, the plurality of solenoid valves includes at least one normally closed solenoid valve and at least one normally open solenoid valve.

According to another aspect, the replaceable fluid treatment cartridge comprises a smart memory unit configured to store data related to the cartridge's usage and performance.

According to yet another aspect, the smart memory unit is configured to communicate with an external controller to provide real-time data on the cartridge's status.

According to another aspect, the smart memory unit is configured to interface with at least one internal sensor within the replaceable fluid treatment cartridge to monitor water properties.

According to yet another aspect, the internal sensor is selected from the group consisting of a lead sensor, a pH sensor, a PFAS sensor, a chlorine sensor, a heavy metals sensor, and a total dissolved solids (TDS) sensor.

According to another aspect, the smart memory unit is configured to store data collected by the internal sensor and communicate this data to an external controller.

According to yet another aspect, the smart memory unit is configured to provide power to the internal sensor.

According to another aspect, the smart memory unit is configured to receive data from the internal sensor and adjust the operation of the fluid flow management module based on the sensor data. According to yet another aspect, the smart memory unit is configured to log historical data from the internal sensor for analysis of water treatment performance over time.

According to another aspect, the apparatus further comprises a water leak sensor configured to detect leaks within the cabinet and provide an alert to the user.

According to yet another aspect, the cabinet is configured to be connected to a remote device via wireless communication for monitoring and control.

According to another aspect, the fluid flow management module is configured to operate in multiple flow modes, including serial flow, parallel flow, and bypass flow.

According to yet another aspect, the apparatus further comprises a control panel configured to display operational status and fault conditions of the apparatus.

According to another aspect, the apparatus further comprises a fault detection module configured to monitor the operational status of the apparatus and detect fault conditions.

According to yet another aspect, the fault detection module is configured to detect conditions including, but not limited to, water pressure anomalies, flow rate deviations, and sensor malfunctions.

According to another aspect, the fault detection module is configured to shut off the water supply or switch to bypass mode upon detecting a fault condition.

According to yet another aspect, the fault detection module is configured to send alerts to a remote device via wireless communication upon detecting a fault condition.

According to another aspect, the fault detection module is configured to log fault conditions and operational data for later analysis.

According to yet another aspect, the fault detection module is configured to provide audible or visual alerts to the user upon detecting a fault condition.

Some embodiments of this disclosure provide for a replaceable fluid treatment cartridge which uses a thin-walled housing. For example, the majority wall portion of the housing can 2402 in this embodiment can only be capable of meeting structural standards when encased within a suitable superstructure. Further it is a goal of this disclosure to provide for a housing that can be easily recycled by the consumer or manufacturer. Since the housing cap 401 and housing can 402 can be manufactured and joined by a wide variety of materials and methods, it could be favorable to provide a material and method which is also easy to be recycled. Certainly, any consumer product can be discarded into the trash, but Some embodiments may have the ability to be separated into its key recyclable elements if possible. Using a simple threaded joint provides for both easy assembly and disassembly if desired.

Some embodiments provide a replaceable fluid treatment cartridge that is efficient to manufacture.

Some embodiments provide a replaceable fluid treatment cartridge that is low in material cost.

Some embodiments provide a replaceable fluid treatment cartridge that comprises material which commonly recycled.

Some embodiments provide a replaceable fluid treatment cartridge that is easy for users to handle and change.

Some embodiments provide a replaceable fluid treatment cartridge that keeps spent media encased.

Some embodiments provide a replaceable fluid treatment cartridge that is robust enough to comply with NSF structural standards.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

The following drawings are illustrative of particular examples of the present disclosure and therefore do not limit the scope of disclosure. The drawings are not necessarily to scale, though embodiments can include the scale illustrated, and are intended for use in conjunction with the explanations in the following detailed description wherein like reference characters denote like elements. Examples of the present disclosure will hereinafter be described in conjunction with the appended drawings.

FIG. 1 is a front perspective view of a representative smart water treatment appliance as connected to its environment according to some embodiments.

FIG. 2 is a front view of the Smart Water Treatment Appliance according to some embodiments.

FIG. 3 is a rear perspective view of the smart water treatment appliance according to some embodiments.

FIG. 4 is a front view of the smart water treatment appliance with its treatment cartridges in position for replacement according to some embodiments.

FIG. 5 is a sectioned side view of the smart water treatment appliance with its treatment cartridges in replacement position according to some embodiments.

FIG. 6 is a sectioned side view of the smart water treatment appliance with its treatment cartridges being returned to service position according to some embodiments.

FIG. 7 is a sectioned side view of the smart water treatment appliance with its treatment cartridges in alignment with service position according to some embodiments.

FIG. 8 is a sectioned side view of the smart water treatment appliance with its treatment cartridges being secured into service position according to some embodiments.

FIG. 9 is a fully sectioned side view of the smart water treatment appliance with its treatment cartridges and fluid flow management module according to some embodiments.

FIG. 10 is a perspective view of the treatment cartridge receiver according to some embodiments.

FIG. 11 is a bottom view of the treatment cartridge receiver according to some embodiments.

FIG. 12 a rear perspective view of the smart water treatment appliance showing fluid flow paths according to some embodiments.

FIG. 13 a front perspective view of the fluid flow management module according to some embodiments.

FIG. 14 is a front and top view with side cross section of a smart fluid treatment cartridge according to some embodiments.

FIG. 15 is an exploded perspective view of the tray assembly and drawer assembly according to some embodiments.

FIG. 16 is a side view and front section view of the tray assembly and drawer assembly according to some embodiments.

FIG. 17 is an exploded perspective view showing the relationship of the camming system according to some embodiments.

FIG. 18 is a plan view of the control panel according to some embodiments.

FIG. 19 is a plan view of the controller according to some embodiments.

FIG. 20 is a system controls diagram according to some embodiments.

FIG. 21 is an exploded perspective view showing the support structure for the appliance according to some embodiments.

FIG. 22 shows methods of operating the smart water treatment appliance system as connected to faucet according to some embodiments.

FIG. 23 shows methods of operating the smart water treatment appliance system as connected to spout according to some embodiments.

FIG. 24 is a flow chart for depicting the user interaction with the smart appliance during automated cartridge replacement according to some embodiments.

FIG. 25 shows encoder timing diagrams for position control of engagement collar according to some embodiments.

FIG. 26 is a perspective view of a representative fluid flow management module according to some embodiments.

FIG. 27 is a piping and instrumentation diagram (P&ID) of fluid flow management module system for series and parallel flow-shown in OFF condition according to some embodiments.

FIG. 28 is a P&ID configured for series and parallel flow-shown in BYPASS condition according to some embodiments.

FIG. 29 is a P&ID configured for series and parallel flow-shown in SERIAL condition according to some embodiments.

FIG. 30 is a P&ID configured for series and parallel flow-shown in PARALLEL condition according to some embodiments.

FIG. 31 is a P&ID configured for series and parallel flow-shown in SINGLE condition according to some embodiments.

FIG. 32 is a P&ID configured for series and parallel flow-shown in PARALLEL condition using directional valves according to some embodiments.

FIG. 33 is a top view of a representative fluid flow management module according to some embodiments.

FIG. 34 is a section view of pilot-actuated directionally-biased solenoid valve according to some embodiments.

FIG. 35 is an exploded view of a fluid flow management module according to some embodiments.

FIG. 36 is an exploded view of a modular sensor assembly according to some embodiments.

FIG. 37 is a P&ID configured for single device with back flow-shown in REVERSE condition according to some embodiments.

FIG. 38 is a P&ID for single device with on/off, bypass, and treatment-shown in TREATMENT condition according to some embodiments.

FIG. 39 is a perspective view of a representative smart fluid treatment cartridge platform according to some embodiments.

FIG. 40 is a front exploded view of the smart fluid treatment cartridge platform according to some embodiments.

FIG. 41 is a side section view of the smart fluid treatment cartridge platform according to some embodiments.

FIG. 42 is a perspective exploded view of the smart fluid treatment cartridge platform configured for automatic operation according to some embodiments.

FIG. 43 is a perspective exploded view of the smart electrical connector according to some embodiments.

FIG. 44 is a perspective exploded view of the smart memory unit according to some embodiments.

FIG. 45 is a chart showing the relationship between housing inner diameter and housing wall thickness according to some embodiments.

FIG. 46 perspective exploded view of a representative smart fluid treatment cartridge according to some embodiments.

FIG. 47 is a perspective view of threaded collar used in the smart fluid treatment cartridge platform superstructure according to some embodiments.

FIG. 48 is a perspective view of sump used in the smart fluid treatment cartridge platform superstructure according to some embodiments.

FIG. 49 shows two perspective views, top and bottom, of the treatment cartridge receiver head used in the smart fluid treatment cartridge platform superstructure according to some embodiments.

FIG. 50 shows sectioned view of treatment cartridge showing fluid flow detail, flow restrictor, and internal and electrical connections according to some embodiments.

FIG. 51 shows three views of representative treatment cartridge housing with detail View-C showing representative connection joint according to some embodiments.

FIG. 52 shows front, section side view, and exploded view of check valve port according to some embodiments.

FIG. 53 shows a variety of methods that can be used to construct a treatment cartridge superstructure according to some embodiments.

FIG. 54 shows schematic view of receiver head, sump, and treatment cartridge according to some embodiments.

FIG. 55 shows additional methods to form and join treatment cartridge housing can and cap according to some embodiments.

FIG. 56 shows a perspective view of a smart treatment cartridge with a wireless connection to provide communication and power using planar antennas according to some embodiments.

FIG. 57 shows a perspective view of a smart treatment cartridge with a wireless connection to provide communication and power using concentric antennas according to some embodiments.

### DETAILED DESCRIPTION

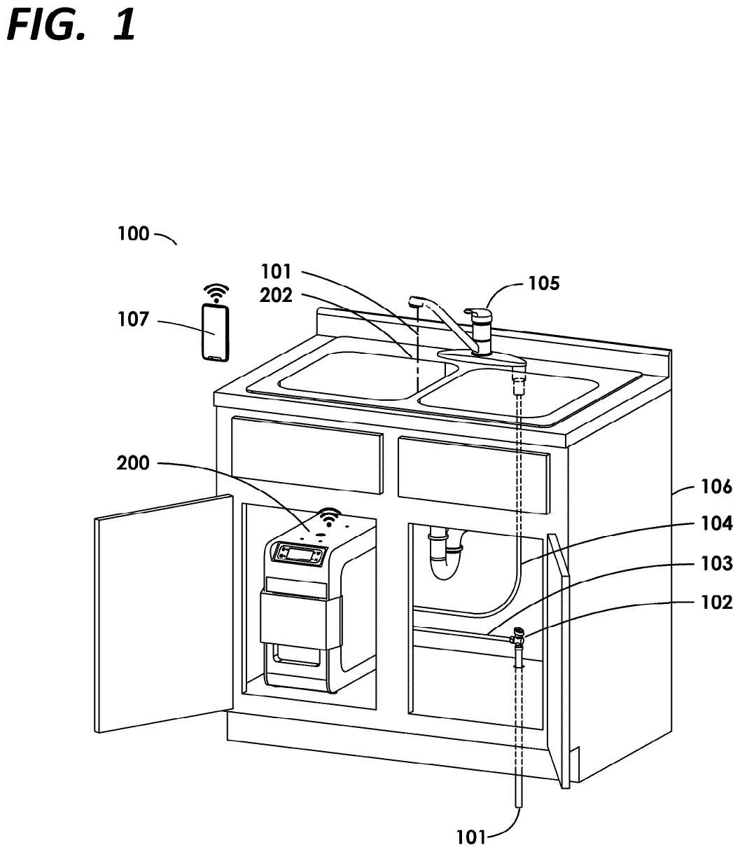

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As illustrated in FIG. 1, an exemplar embodiment of a smart water treatment appliance System 100, may include a source of raw pressurized untreated water 101, a service shut-off valve 102, an inlet water line 103 providing raw pressurized untreated water which is connected to the inlet of smart water treatment appliance 200. Smart water treatment appliance 200 can selectively output no water, raw pressurized untreated water 101 or pressurized treated water 202. An outlet waterline 104 is connected to a faucet 105 which can be manually opened or closed as desired by the user. Typically, smart water treatment appliance 200 is used in connection with a cabinet or vanity 106 such as found in a kitchen, etc. providing support for a mounted faucet. Optionally, smart water treatment appliance 200 can be connectable to a variety of remote devices and allow interaction with the Internet of Things (IoT) via wireless radio frequency communication 107 such as WI-FI or Bluetooth, optical, or wired connections to remote devices.

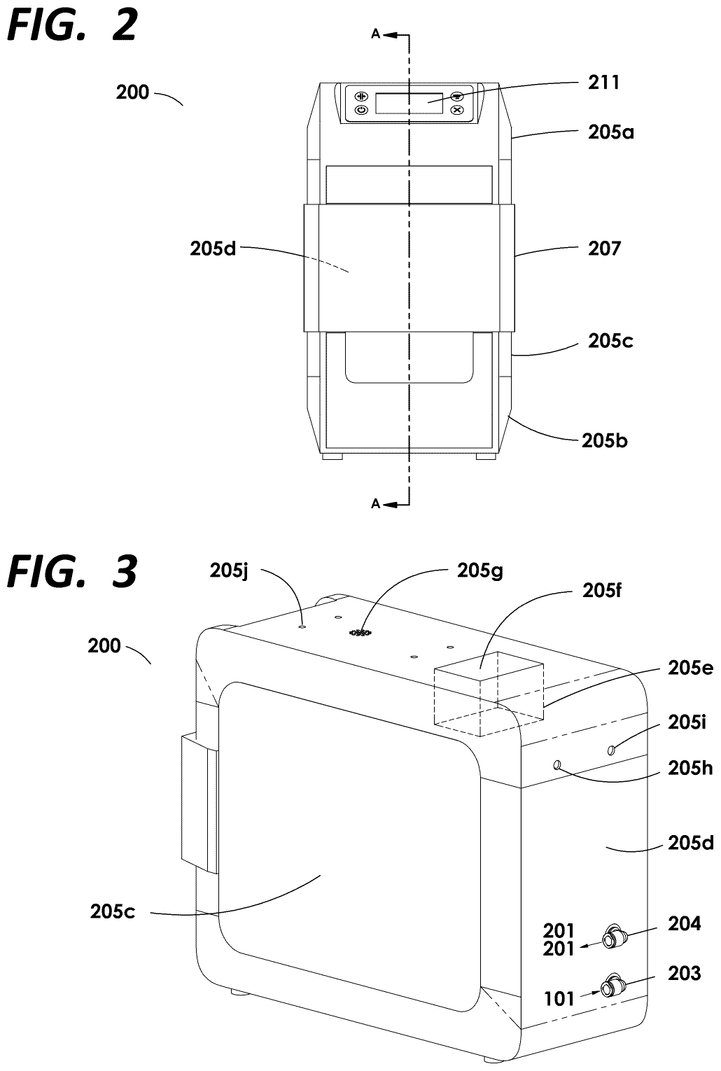

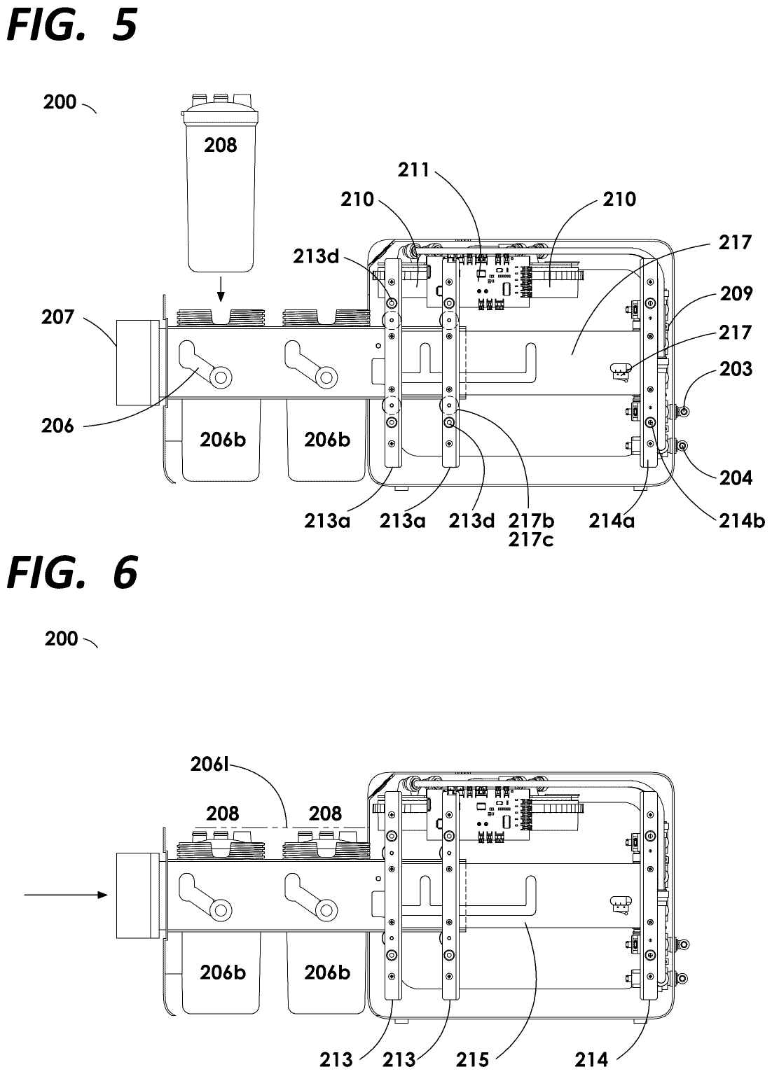

FIG. 2 illustrates the front of the smart water treatment appliance of some embodiments, showing its enclosure 205, operator control panel 211, and handle assembly 207. Enclosure 205 may include of its top cap 205a, bottom tray 205b, side panels 205c, and back panel 205d (also shown on FIG. 3.) Top cap 205a provides mounting means for the treatment cartridge receiver 210 FIG. 5, control panel 211, battery compartment 205e, battery cover 205f, and can have optional speaker vents 205g and the like. Enclosure 205 can be formed from various materials such as plastic, aluminum, steel and composites as desired. Enclosure and its sub parts may be molded from plastic such as ABS or polycarbonate, but there are many other plastic materials which can be used for injection molding or thermal-forming as desired. Enclosure sub parts can be combined using snap-fits, adhesive, screws, magnets, and various methods which are well known in the industry. Enclosure 205 is designed and shaped for a pleasant appearance, easy assembly and maintenance.

FIG. 3 illustrates the rear of the smart water treatment appliance of some embodiments, showing its connections to the environment. The source of raw pressurized untreated water 101 is connected to the input port 203. Similarly, output port 204 is connected outlet water line 104 connecting faucet 105 or other point of use tap. Ports 203 and 204 can be arranged as straight fittings or elbow fittings which allow for easily rotating the water lines in any convenient orientation. Input port 203 and output port 204 can utilize a wide variety of water line connection means including push-to-connect, pipe threads, compression fittings, or other proprietary connection means to securely attach a water line with leak tight connections. Water lines 102 and 103 in FIG. 1 can be made from tubing, for example, such as LDPE or LLDPE or PEX, nylon, or copper as desired. Water lines 102 and 103 may be adapted to have threaded attachment ends such that they can readily interact with the existing plumbing connections on faucet 105 and service shut-off valve 102 such as a ⅜ compression fitting and the like. Top cover 205a may have a variety of apertures for various functions such as; speaker vents 205g, remote device 205h, power connector 205i, and filter manual eject 205j. Top cover 205a may have an integral means to house optional batteries for operation when external power is not available or convenient. Battery compartment 205e could house batteries sufficient for the voltage and capacity desired within 205a. Battery cover 205f allows for access to the replaceable or rechargeable batteries. Top cover 205a has provision for mounting an operator control panel 211. Enclosure 205 may have a separate rear panel 205d for maintenance access to components or for assembly convenience as desired. Alternatively, rear panel 205d can have remote device connector 205h and power connector 205i.

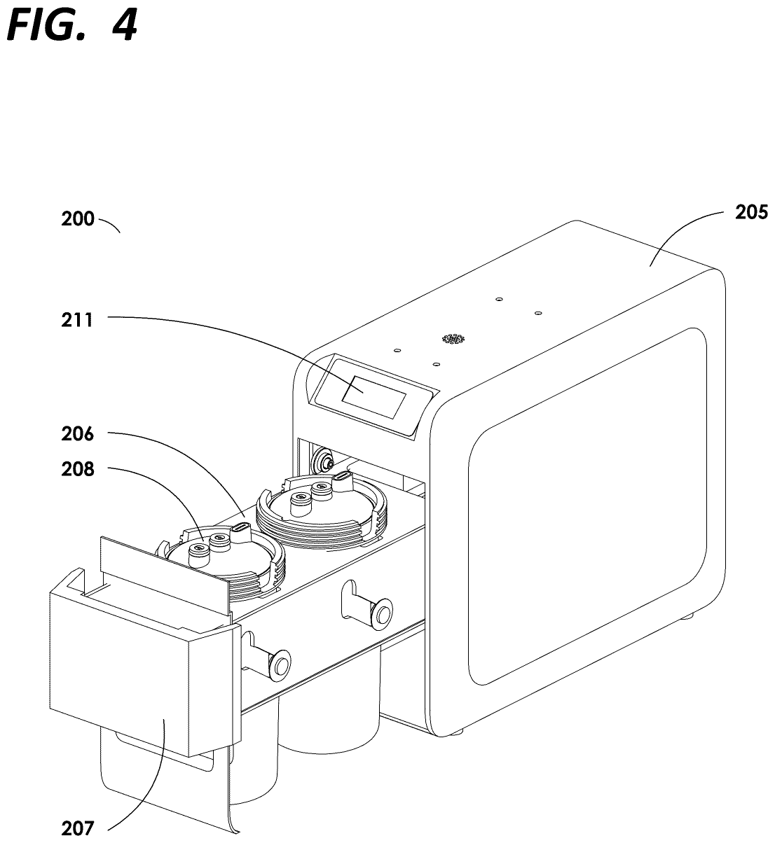

FIG. 4 illustrates an embodiment of the smart water treatment appliance 200 with its handle 207 extended and an access panel such as a drawer 206 fully open. The smart treatment cartridges 208 are shown within treatment cartridge sumps 206b FIG. 5. The smart treatment cartridges 208 are ready for removal in this position. While the access structure shown in FIG. 5 is a drawer, it should be known that any access structure may be used such as a door or the like.

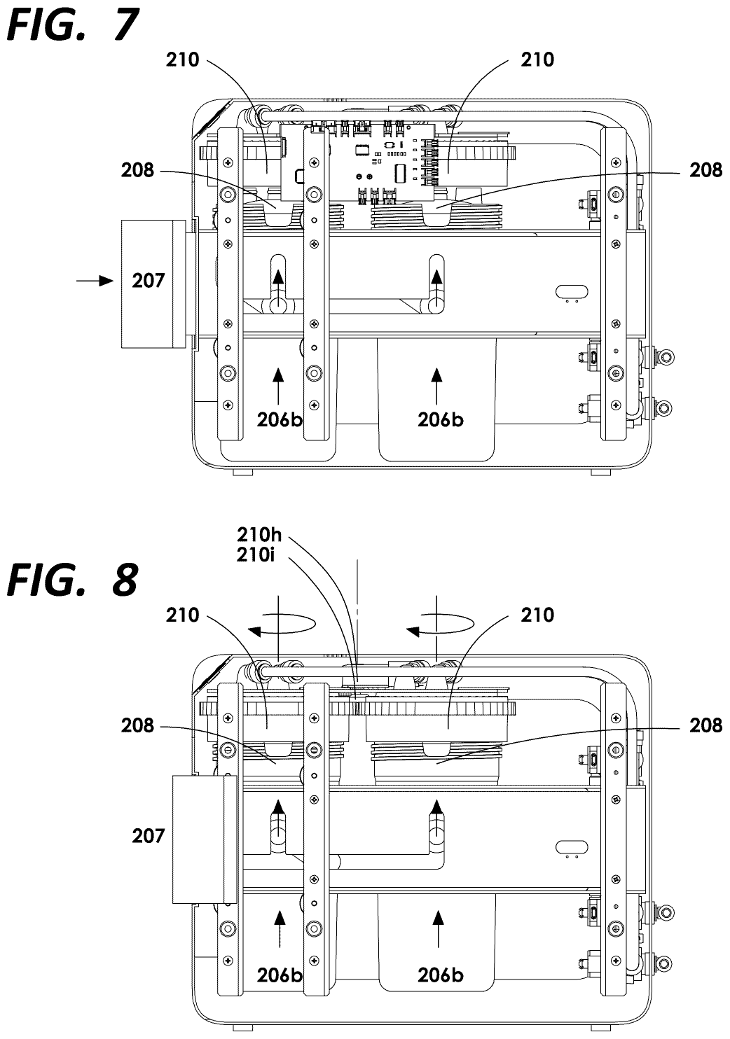

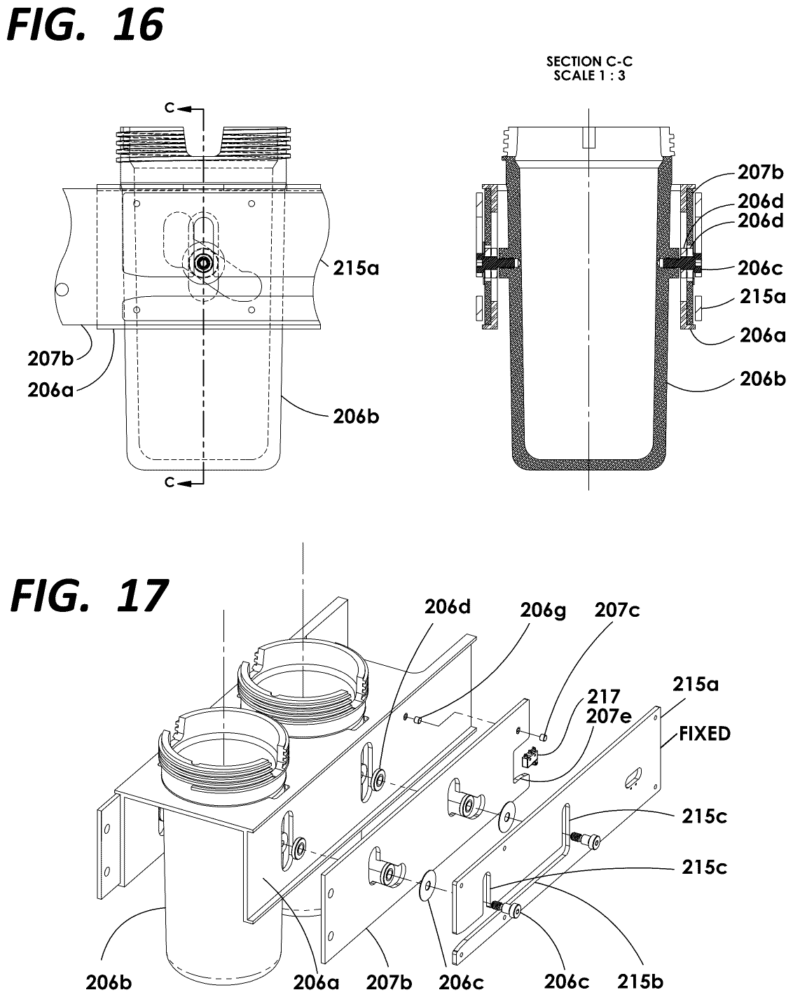

FIGS. 5-8 illustrate some embodiments of the smart water treatment appliance 200 as it is operated beginning with the installation of smart treatment cartridges 208 FIG. 5, pushing the handle and drawer in FIG. 6, camming the smart treatment cartridges 208 upward once inside the housing 205 FIG. 7, and finally the smart water treatment appliance 200 receives the smart treatment cartridges 208 into secure fluid connection with treatment cartridge receiver 210 in FIG. 8. The process of pushing the handle 207 inward or pulling the handle 207 outward causes the treatment cartridge sumps 206b to move vertically upward or downward using cam features that will be detailed more thoroughly in FIG. 16 and FIG. 17. The smart treatment cartridges 208 are automatically brought into or out of secure fluid and electrical communication using a motor arranged within the treatment cartridge receiver 210, which serves to eliminate a difficult process of securing and releasing the smart treatment cartridges 208 manually.

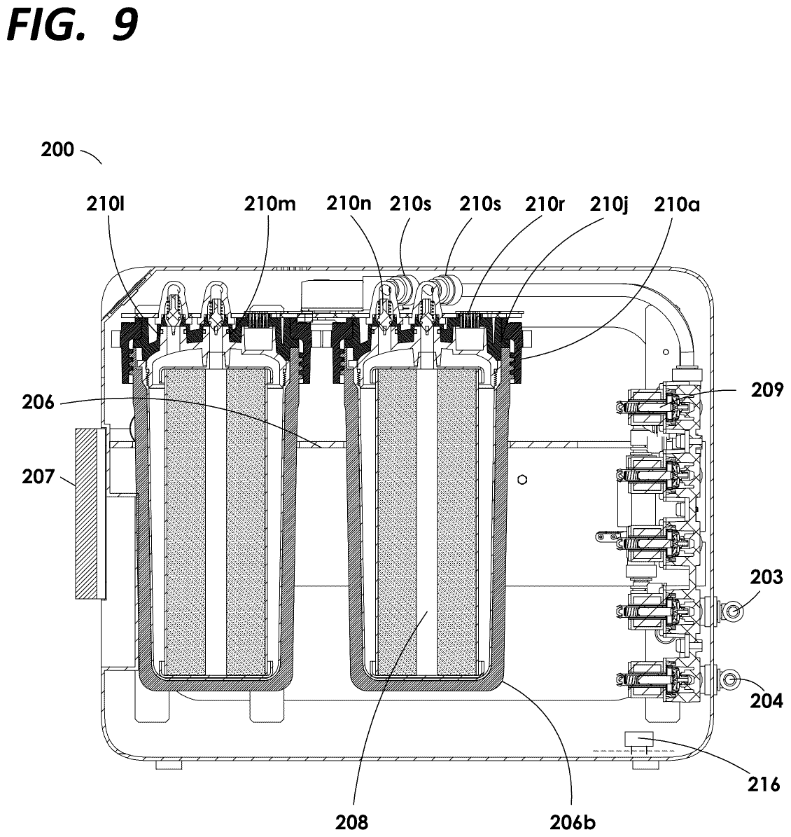

The design of the smart water treatment appliance 200 according to some embodiments serves to automate the difficult engaging and disengaging of the smart treatment cartridges 208 without cartridge rotation. The smart treatment cartridge seals 208h FIG. 14 are suitably small and configured to seal radially within tapered inlet sockets 210l and 210m, respectively, which reduce or eliminate separation forces as shown in FIG. 9. The treatment cartridge sump 206 may be devoid of any seals and does not make a watertight connection to its mating receiver head 210j FIG. 9. The coupling of cartridge sump 206b with receiver head 210j creates a containment superstructure. The associated smart treatment cartridge 208 is constructed to have its housing of insufficient structure to withstand high-water pressure and requires being contained by a superstructure sufficient to keep the smart treatment cartridge 208 from failing and leaking under operating or higher pressures.

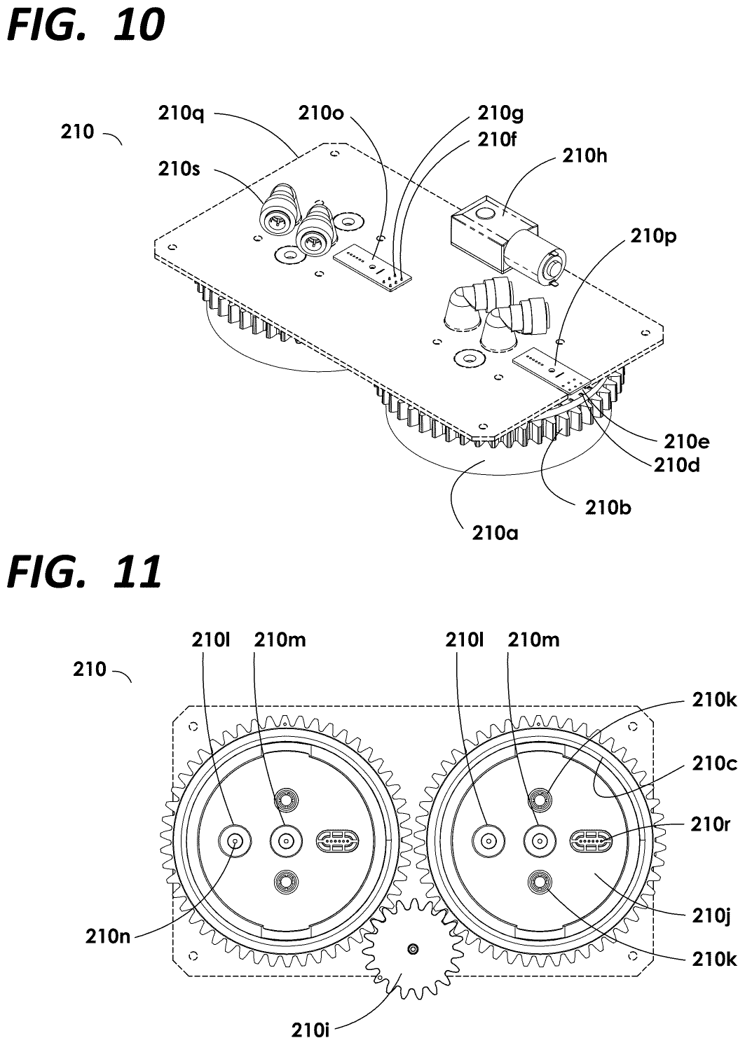

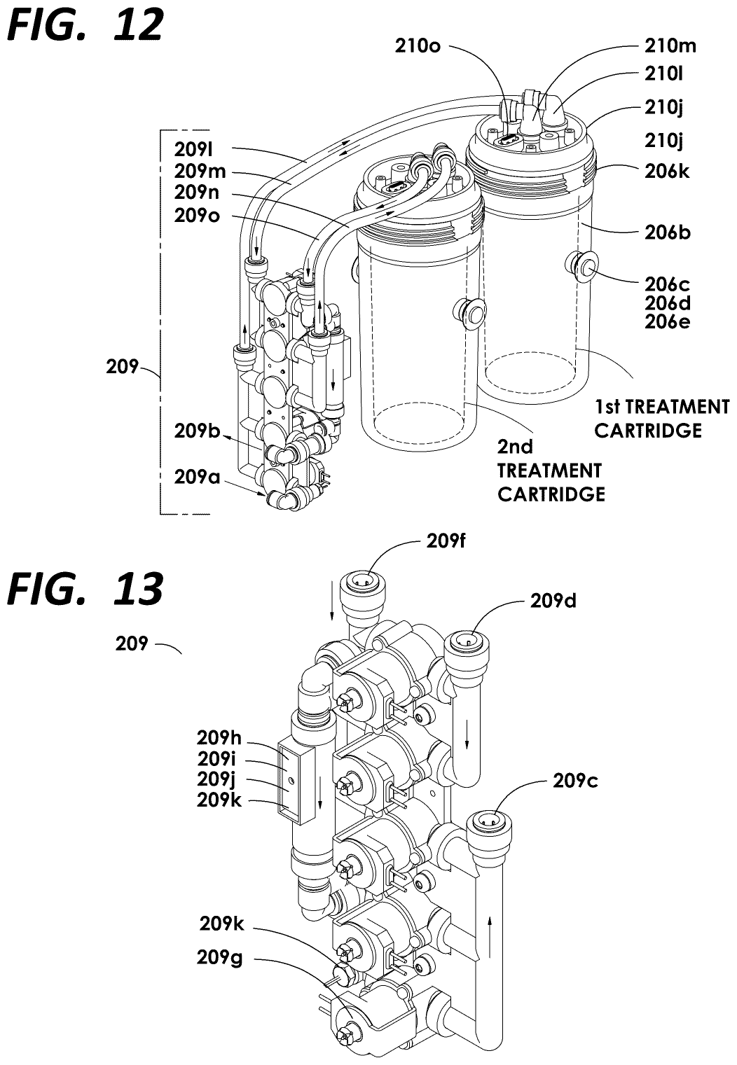

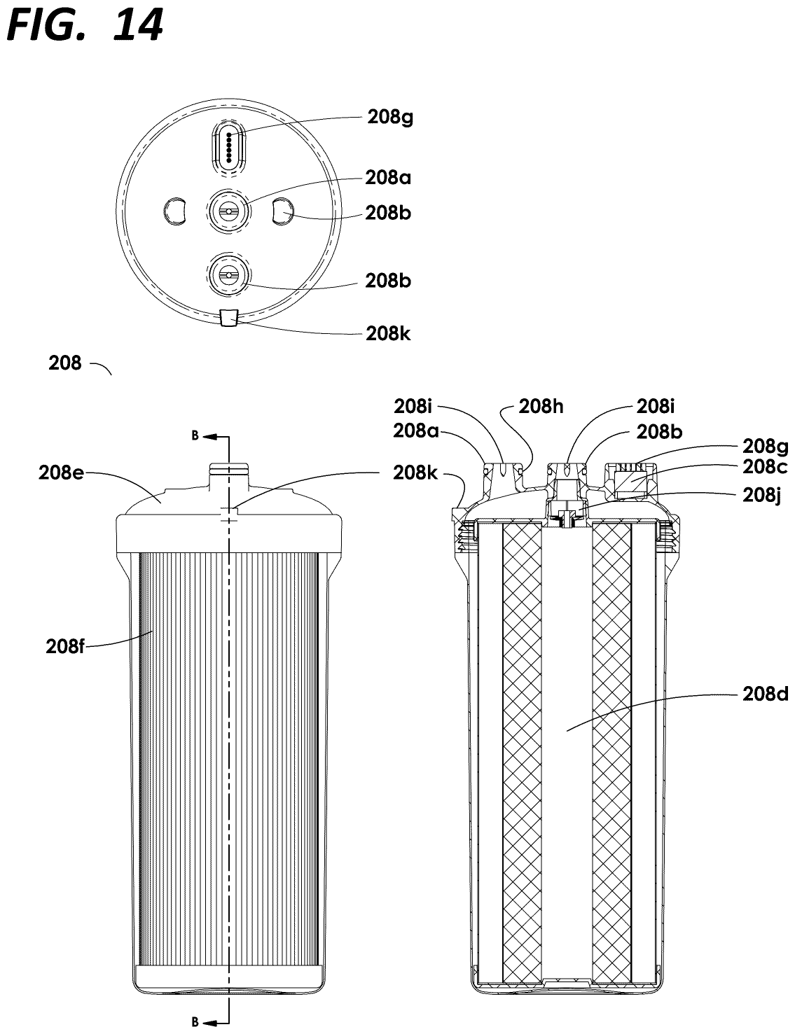

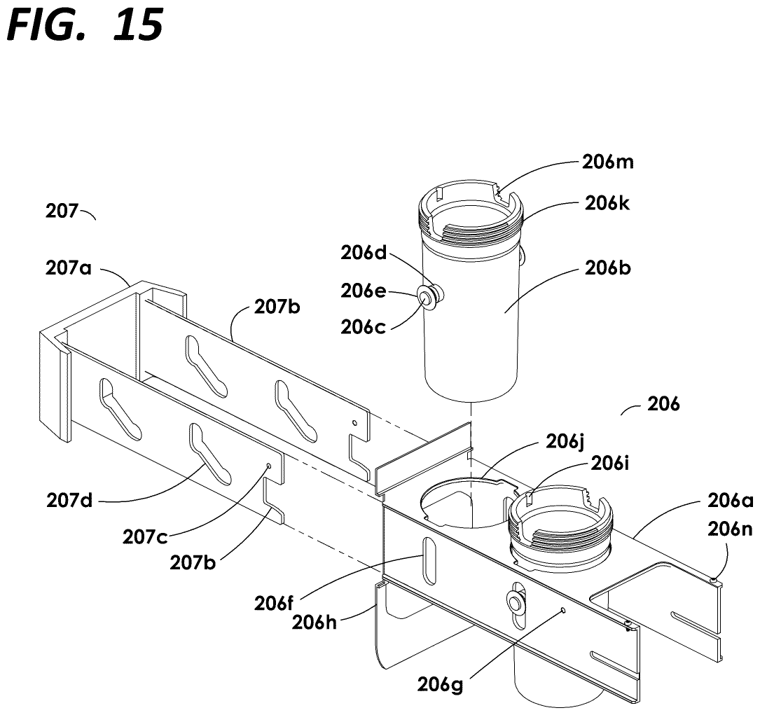

Referring to FIG. 10 and FIG. 11, the main elements of some embodiments of the treatment cartridge receiver 210 is the receiver head 210j, engagement collar 210a, motor 210h and pinion gear 210i, which automates the engagement and closure of the superstructure which encloses the smart treatment cartridge 208. The mounting plate 210q provides a mounting structure to retain the elbow ports 210s and check valves 210n. Mounting plate 210q provides a structure to mount the motor 210h in the correct location for pinion gear 210i to mesh with engagement collar torque members 210b which drive engagement collar 210a. The smart treatment cartridge 208 is properly aligned when feature 208a as shown in FIG. 14 is oriented in sump locating feature 206i as shown in FIG. 15. Smart treatment cartridge 208 is divorced from rotational forces when internal to sump 206b. The rotation of engagement collar 210a when treatment cartridge sump 206b is in vertical position, draws the treatment cartridge sump 206b vertically into communion with receiver head 210j.

In such embodiments, the engagement collar engagement members 210c thread together with sump engagement means 206k by way of helical threads. Multi-turn helical threads may require minimal torque to rotate and draw the mating parts together with a relatively large amount of force over a greater distance. For example, using a thread pitch of 0.250″ and three full threads provide 0.75″ of axial threaded engagement. The axial engagement distance traveled using multiple rotations ensures a number of advantages. Namely that:
a. the cartridge inlet plug 208a and cartridge outlet plug 208b of FIG. 14 engage receiver head tapered inlet socket 210l and receiver head tapered outlet socket 210m respectively, are fully mated while under automated force,
b. the receiver head check valves 210n are fully opened by cartridge check valve actuators 208i FIG. 14, are fully mated while under automated force,
c. the cartridge electrical contacts 208g of FIG. 14 make secure contact with receiver head electrical connector pins 210r FIG. 11, are fully mated while under automated force, and/or
d. compress eject springs 210k FIG. 11 are fully compressed while under automated force.

In some embodiments, a pitch may be selected such that the separation forces generated at maximum hydraulic pressure do not easily backdrive the engagement collar 210a and therefore can hold fast without requiring a brake or other significant external anti-backdrive torque. If the motor is a gearmotor with sufficient gearing, the gearmotor can provide any necessary anti-backdriving torque. Some embodiments provide a thread geometry such that the threaded members hit a hard stop without sinching together tightly as opposed to an ever-tightening condition as maximum torque is applied.

Some embodiments may use motor torque to position the engagement collar 210a from full stop CW to full stop CCW without any excess start or stop torque required. In some embodiments, receiver head 210j may be securely attached to sump 206b so as to prevent treatment cartridge housing cap 208e FIG. 14 separating from cartridge housing can 208f as shown in FIG. 14 and developing a cartridge housing leak. It could be considered that the relationship of the treatment cartridge housing can 208f and treatment cartridge sump 206b superstructure is that of a tire and an innertube. However, in the case of the housing can 208f as shown in FIG. 14, it does not need to be entirely impervious to leaking. Some embodiments may provide a suitable leak path for water to drain if there is any leakage from the treatment cartridge 208. Any leaks can be collected and released through an aperture on the bottom of cartridge sump 206b so as to direct leakage downward into bottom tray 205b where it can be detected by a water sensor.

It is understood that the thin-walled housing 208f will expand under increasing pressure and grow to fill the entire internal shape of sump 206b. The sump 206 of some embodiments provides sufficient strength to sustain operation when the treatment cartridge 208 is at full design pressure. Some embodiments may provide an interior surface texture of sump 206b to allow leaked water to migrate downward between the expanded treatment cartridge housing 208f without being fully sealed by the expanded treatment cartridge housing 208f.

The engagement collar 210a of certain embodiments may allow a sensor to determine its rotational position such as mechanical, optical, or electrical reference features along with a corresponding sensor. As shown in FIG. 10, some embodiments of this treatment cartridge receiver 210 would have a series of bumps, or timing cam surfaces 210d, integral with the top surface of engagement collar 210a, such that they would actuate a microswitch encoder sensor 210f when the collar is rotated. Some embodiments may have another singular home cam surface 210e which provides a signal when the collar is in its home position relative to home sensor 210g. The combination of the encoder and home signals can be used for accurate position control or used to determine various fault conditions. Applying a voltage to the microswitch results in a pulse train signal back to the controller as the collar 210a rotates.

As a non-limiting example, fifty (50) equally spaced timing cam surfaces would provide 150 counts in three rotations with three home cam surface pulses. Some embodiments may determine the normal rotational speed by measuring the pulses in time and monitoring the rate of pulses for normal operation. Frequencies outside of normal could be used to interpret a variety of fault conditions such as: incorrect treatment cartridge orientation, low motor power, damaged threads, damaged gears, tired motor, jammed cartridge, etc. The home sensor 210g can be used to verify that the engagement collar is in its home orientation during start-up. The receiver head 210j has at least one via sufficient to house at least one electrical connector pin 210r, which can be optionally mounted to smart electrical connector with encoders 2100 or smart electrical connector 210p without encoders. It is also anticipated that smart electrical connector with encoders 2100 can have both microswitches 210g and 210f as part of its assembly. The electrical connector pins 210r of some embodiments may include at least one contact to induce an electrical charge with smart cartridge electrical contact 208g. FIG. 10 illustrates electrical contact 208g having (6) contacts as shown. Electrical connector pins 210r can be of any conductive variety and it is anticipated that they might be a gold-plated spring energized variety suitable to allow for a small amount of misalignment and survive a moist environment without excessive corrosion.

There are many different electrical schemes for communication using any number (1, 2, 3, 4, 8 etc.) of electrical conductors to include various data bus architectures for serial or parallel two-way communication. For example, four contacts can be used; a pair for power and a pair to read and write data. Adding an additional pair of contacts may provide electrical power within the wetted interior of smart cartridge 208 for any number of uses, such as but not limited to; electrically powered treatment media, integral water chemical sensors, electrolysis, or reducing or elimination of mold, fungus, biofilm, bacteria, or viruses with voltage fields. Electrical power within the wetted interior of smart cartridge can be static or dynamic, forward or reverse polarity, direct or alternating, and can even be a series of voltage waveforms as desired.

When the treatment cartridge 208 is installed within sump 206b and the sump 206b is vertically aligned with its vertical axis coincident with receiver head 210j vertical axis and sump 206b is lifted upward to contact its sump engagement means 206k with receiver engagement member 210c, rotation of engagement collar 210a causes smart treatment cartridge 208 to engage with treatment cartridge receiver 210. As the smart treatment cartridge 208 raises upward it compresses at least one eject spring 210k. The force developed from eject spring 210k is used to forcibly push or urge the smart treatment cartridge 208 downward such that during reverse rotation of engagement collar 210a when the sump 206b is separated from receiver head 210j and driven downward, the smart treatment cartridge 208 is also releasably disengaged and remains resting fully within the sump 206b.

According to some embodiments, the monitoring of electrical contact communication provides feedback as to when the cartridge is fully installed and connected and also provides feedback that successful cartridge separation has occurred. The use of tapered receiver sockets 210l and 210m, small diameter seals 208h, and the use of effective seal lubrication such as PTFE based silicone or parylene coatings all work together to allow for easy connection and disconnection forces. In the event that smart treatment cartridge 208 does not release during the automatic disconnection process, a notice can be provided to the user via the control panel 211 or audio annunciation to assist in cartridge removal by using the manual eject apertures 210t located in the treatment cartridge receiver 210, which are accessible from the top of the cabinet assembly top cover 205a filter manual eject apertures 205j. A typical Phillips screwdriver can be used to gently force the cartridge downward to release completely.

The fluid flow path of one embodiment can be understood from FIG. 12 which shows the hydraulic system alone and its fluid connections. Fluid flow management module 209 receives pressurized water to be treated when connected to raw water inlet 209a. Raw water inlet port 209a can be of any type or style connection and made from any material. In some embodiments, raw water inlet 209a is a push-to-connect style sized for ⅜″ PEX tubing, but any diameter tube and tube material can be used as desired. If raw water inlet 209a is of an elbow construction and is configured to swivel, the raw water inlet 209a can be easily rotated to align with inlet water line 103 FIG. 1 in any direction and allow the rear of the smart water treatment appliance 200 to be placed close to a wall while in service. Similarly, treated water outlet 209b serves to connect to outlet water line 104 which can flow raw or treated water depending on the mode of operation. Multiple water lines 209l, 209m, 209n, 209o convey water to and from fluid flow management module 209, which can be PEX tubing of a diameter suitable for the desired water flow rate at operating pressure. It is common to use ¼″ OD tubing for flows lower than 2 gallons per minute (gpm), and ⅜″ OD for flow rates such as found in a typical kitchen faucet. Although the fluid flow management module 209 is shown and described as a module, it should be known that the described water lines and valves of the fluid flow management module 209 may be located in various locations without being attached to a common structure or located in a common location.

In such embodiments, fluid flow management module 209 is shown with push-fittings sized for ⅜″ PEX tubing but ¼″ is also acceptable given that treated water is likely to flow slower than untreated water as it bypasses all treatment devices. Water is sent out of fluid flow management module 209 via its push-fitting port shown as inlet, treatment cartridge 1 209c FIG. 13 and is connected via water line 209l to a first treatment cartridge being connected to its inlet port 210s, which provides water to the smart water treatment cartridge 1 inlet 210l. In like fashion, the outlet of the smart water treatment cartridge 1 is connected via water line 209m. Water lines 209n and 209o connect water to treatment cartridge 2 providing a flow circuit in and out correspondingly, such that water can be sent to and received from smart treatment cartridge 1 and smart treatment cartridge 2 in either serial or parallel flow configuration. Fluid flow management module with its plurality of solenoid valves 209g of FIG. 13 can receive raw untreated water or prevent untreated raw water, flow water through treatment cartridges 1 and 2 in serial fashion, flow water equally though both treatment cartridges 1 and 2 in parallel, or bypass both treatment cartridges completely such that only raw untreated water is sent out of port 209b.

In some embodiments, the plurality of solenoid valves 209g can be configured to be normally closed such that they remain closed until voltage is applied to their coil and open, or normally open such that they remain open until is voltage applied to their coil and they close. Alternately, solenoid valves can be selected to be bistable and either remain always open or always closed and only change state when a pulse of forward or reverse bias voltage is applied. Fluid flow management module 209 can be driven into any of the flow modes by providing plus or minus biased voltages to the plurality of solenoid valves 209g using discrete command signals. The nature and timing of the on/off voltages and positioning of the valves within the flow circuit allows the smart water treatment appliance 200 full instant control of all flow modes in any order and at any time. This type of discrete operation is distinct from more common types of valved water appliances such as water softeners and the like, which provide water flow paths in sequential order forward and backward according to motorized gears and cams which drive sliding spools, pistons, or rotary valves in their operation.

According to some embodiments, fluid flow management module 209 is also able to measure various water properties and performance metrics, as show in FIG. 13 such as with water flow sensor 209h, water pressure sensor 209i, water temperature sensor 209j, and water contaminants with water contaminant sensor 209k. The types and operations for these types of sensors is well understood. The sensors are selected to provide an electrical signal proportional to the water performance metric, such that the controller can gather real time data on the water characteristics. For example, water that is flowing too fast or to slow can be a concern and may result in a fault that shuts off the water completely, changes it to bypass mode, or sends an alert to the user. Any of the sensor ranges can provoke action and cause automatic changes to the operation of the smart water treatment appliance. Further, it is the intention that some or all of the sensor data is read and processed in historical fashion and that processed data be written back to the smart treatment cartridge for subsequent discovery and analysis. Data written to the smart water treatment cartridge during use and contained within its persistent memory can be used for fault analysis, treatment history, treatment effectiveness, treatment capacity, and environment history. Smart water treatment appliance 200 can make decisions on how best to utilize the smart treatment cartridge 208 when the historical data is read before and during use.

In some embodiments, the fluid flow management module 209 is enabled to contain a water contaminant sensor 209k, configured, for example, to measure the concentration of for example, total dissolved hardness, pH, chlorine, chloramine, tannins, PFAS, heavy metals, nitrates, and nitrites. Many new sensor technologies are being developed for low-cost real time measurement of key contaminants such as lead and PFAS. Some embodiments may be able to easily attach and remove sensors from the fluid flow management module 209 and provisions such as the push-fitting elbows connecting the sensor housing assembly 209p enable easy model changes, repair, and upgrades.

The smart water treatment cartridge 208 according to some embodiments is shown in FIG. 14 and is illustrated in its basic parts with inlet plug 208a and outlet plug 208b used to connect the cartridge to its water source and destination. Inlet plug 208a is sealingly connected to receiver tapered inlet socket 210l and outlet plug 208b is sealingly connected to receiver tapered outlet socket 210m. In some embodiments, the two sealing elements 208h of the male plugs can be replaced each time a new treatment cartridge is changed. It is more difficult to manufacture a cartridge with seals that reside inside a socket for example, but female sockets are also an acceptable alternative geometry. Also, independent plug geometry can take advantage of using two relatively small diameter seals and thereby resulting in suitably low thrust forces when subjected to water pressure. Alternatively, a coaxial port geometry can be used but inherently produces a larger thrust with its greater effective piston area.

In some embodiments, the sealing elements 208h may be o-rings using small cross-sections as to minimize installation and removal friction and helping to mitigate longer term stiction. The treatment cartridge 208 is considered smart because in this disclosure it contains smart memory 208c. Smart memory 208c is persistent non-volatile read-write capable and may include several integrated circuits (ICs) to perform various smart functions and data communication.

Some non-limiting examples of initial data stored in cartridge and read by appliance may include:
a. treatment cartridge identification;
b. manufacturer information;
c. date and time of manufacturer;
d. treatment capacity;
e. operating temperature range;
f. operating pressure range;
g. flow rate range;
h. target treatment capability;
i. serial or parallel flow preference; and/or
j. position 1 or position 2 preference.

Some non-limiting examples of in-service data written to cartridge and readable by the same or other smart appliances may include:
a. date entering service;
b. amount of treatment used;
c. coded fault conditions;
d. flow rate history;
e. temperature history;
f. pressure history;
g. date withdrawn from service; and/or
h. ID and S/N of appliance installed in.

In some embodiments, the smart memory 208c has at least one electrical contact to be used to provide power and data communication, but it is anticipated that multiple contacts can be used to provide greater functionality, including communication inside the cartridge fluid interior to provide enhanced powered filter capabilities. Some non-limiting examples of information on how to operate the interior conductors stored in Smart memory 208c may include:
a. Target voltage;
b. Target current;
c. Static or Dynamic;
d. Voltage on or off during flow;
e. Voltage on or off during stagnation;
f. Polarity of voltage; and/or
g. Frequency of voltage.

In some embodiments, smart memory 208c may be protected from corrosion by suitable encapsulating strategies such as epoxy, urethane, acrylic, or silicone conformal coatings and potting agents. It is also beneficial to have cartridge electrical contacts 208g shielded from and positioned above any surface which can get fouled by water causing corrosion and open or short circuits. In some embodiments contacts are both electrically conductive and corrosion resistant. Contact material choice should avoid materials that might passivate and become insulating during wet conduction such as uncoated titanium. Treatment element 208d is housed within thin-wall cartridge closure including housing can 208f and housing cap 208e. Treatment elements are typically made from a material which reduces or renders unwanted water contaminants and works by exposing water to be treated to its chemical matrix such that water flows therethrough establishing sufficient contact time. For example, a common treatment element used would be an activated carbon block with an exterior pre-filter particulate wrap. Treatment element would have its distal end sealed with an end cap and its proximal end capped with an outlet stem. The fluid flow is typically from the exterior outside cylindrical surface inward through the treatment media and collected within its interior to be directed out of the center stem. Treatment element 208d is sealingly connected to housing cap 208e along the central axis directing treated fluid to outlet plug 208b. Treatment elements 208d are not limited to being constructed of a filtering media but also include an entire range of technologies to modify, enhance, filter, treat, flavor, disinfect, gasify, and electrify the fluid as it flows through the smart water treatment cartridge 208. The smart water treatment appliance 200 anticipates the wide range of technologies today and forthcoming in the future whereby the fluid can be treated in many different ways. It is the read-write smart memory 208c residing in the smart water treatment cartridge 208 which informs the smart water treatment appliance 200 how to be configured for use, and how to operate and track its performance.

It is a particular goal of this smart water treatment system 100 to provide the user with very economical replacement treatment cartridges and provide the options necessary for ecological stewardship by recycle-ready solutions. The smart water treatment appliance 200 uses a more complex and expensive superstructure for its construction so as to permit the use of thin-wall dry-change replacement cartridges which are otherwise structurally insufficient for pressurized use. When the housing can 208f and housing cap 208e are manufactured with thin-walled construction techniques, very little material is used to manufacture the cartridges. With less material used and less material wasted, the cartridge can be produced at lower cost, while still providing the dry-changing benefits users have come to enjoy. Also, the thin-walled construction of housing can 208f and housing cap 208e are able to be recycled. It is anticipated that the stretch blow-molding process used in soft drink containers be used to make the housing can 208f from polyethylene terephthalate PET, and the housing cap 208e molded from polyethylene terephthalate PET, high density polyethylene, or polypropylene. It is advantageous to use PET because it is the most commonly recycled plastic. The use of a superstructure also provides for an opportunity for the cartridge housing to be sealingly joined using a simple threaded connection and radial sealing element. The simple threaded connection enables easy disassembly of the smart treatment cartridge 208 as compared to a welded joint. A threaded treatment cartridge housing promotes environmental stewardship as it can be easily opened to discard the treatment element and recycle its housing. Alternately, housing can 208f and housing cap 208e can be joined by spin welding, Emabond RF welding, hot plate welding, sonic welding, adhesive bonding, laser welding, seam welding, or banding as desired.

The smart water treatment cartridge 208 may additionally have an internal mechanism to control the rate of fluid flow through the cartridge. Flow limiter 208j can be added to restrict the flow rates as desired to ensure that said treatment cartridge will not exceed its design fluid flow rate. Flow limiter 208j can be a simple orifice forcing choked flow, capillary tube, or a deformable element which alters its geometry relative to fluid flow forces and provides relatively flat flow curves under a wide range of operating pressures. Flow limiter 208j can be integrally molded or be a component or assembly added as desired.

In some embodiments, alignment feature 208k can be used for orienting housing can 208f with housing cap 208e, orienting housing can 208f with sump locating pocket 206i or providing a means to assemble parts together. The smart water treatment cartridge 208 can have check valve actuators 208i such that when the cartridge is undergoing the last increment of installation when the cartridge plugs 208a and 208b are sealingly engaging the receiver taper sockets, 210l and 210m respectively, check valve actuators 208i push the spring energized check valves 210m within port cap 210s upward to open the flow passages. Using check valves as described, treatment cartridge receiver 210 will not accept fluid flow unless a smart treatment cartridge is installed and physically opens the inlet and outlet check valves contained therein.

As shown in FIGS. 15, 16 and 17, the drawer assembly 206 and handle assembly 207 of some embodiments are shown in more detail. The drawer assembly 206 is constrained to move inward and outward to open and close. The treatment cartridge sumps 206b are constrained to move upward and downward along their vertical cylindrical axis within the drawer 206a. Sump roller axle bolts 206c are attached to sump 206a on opposite sides with rollers 206d being constrained within vertical slots 206f. Rollers 206d and washer 206e reduce rolling friction and are used to cam the sump 206a upwards and downwards in relation to the handle assembly 207 motion in and out. Handle assembly 207 is constrained to limit its motion to a short distance outward or inward as the user pushes or pulls on the handle 207a. Cam tracks 207b attach to the handle 207a and have corresponding cam slots 207d which confine the sump 206b vertically to the relative position of the handle 207a. For example, as handle 207a is pushed inwards, sump 206b is cammed upward and when handle 207a is pulled outwards, sump 206b is cammed downward. Magnets 206g embedded within drawer 206a attract to magnets 207c embedded within handle 207c when they align with each other. Magnetic alignment occurs when the handle 207a is pulled outward relative to the drawer 206a forcing sump 206b to its lowest height. Once magnets align and attract, they provide a firm yet breakable force to keep handle 207a and drawer 206a coupled during the drawer opening and closing motions. Once the drawer 206a is fully pushed inwards, the handle 207a can still be pushed in further breaking the magnetic couple and raising the sumps 206b upward to their ready-to-thread position. While the sumps 206a are being threaded together by forward rotation of engagement collar 210a and have risen to their highest upward position, the system is ready for use if treatment cartridges are electrically detected. Reverse rotation of engagement collar 210a forcibly lowers the sumps 206a until they are free of the engagement collar 210a. Once the sumps are disengaged, the pulling of the handle 207 further lowers the sumps 206b by way of cam slots 207d acting on sump rollers 206d. When sumps have be cammed downward fully, the drawer magnet 206g and handle magnet 207c realign and couple. At this point, the handle 207 and drawer 206 are magnetically latched and they are free to be pulled outward as an integral unit by continuing to pull on the handle 207a until the drawer 206a is stopped by roller stop 206n. Although it should be known that the magnets may be omitted without deviating from the scope of the disclosure.

In some embodiments, smart water treatment appliance 200 can employ another cam system shown in FIG. 17 that can be used to provide a master control motion to the drawer 206 operation. Master track assembly 215 includes a stationary member master track plate 215a which has a defined horizontal cam path 215b and two defined vertical cam paths 215c. Master track plate 215a provides the master path for the position of the sump 206b. When the sumps are moved outward any amount from their respective receiver heads 210j, each sump 206b axle roller assembly (206c, 206d, and 206e) remains confined to horizontal motion only. This confinement keeps the handle 207 and drawer 206 integral as no vertical sump 206b motion is permitted. As soon as the last sump 206b axle roller assembly (206c, 206d, and 206e) clears the master track plate horizontal cam path 215b there can be vertical sump 206b motion. The magnetic latching keeps the handle 207 and drawer 206 integral when outside the Master track plate 215. When the handle is pushed inward and the axle roller assemblies (206c, 206d, and 206e) re-enter the master track plate horizontal cam path 215b, are inside completely, and sumps 206b are axially aligned respective to their receiver heads 210j, continued inward handle 207 motion is converted into vertical sump 206b motion upward. Handle 207a has a door switch cam 207e which triggers door switch 217 mounted to master track plate 215a when handle 207 is in its fully inward position. When drawer 206 is fully closed, door cover 206h is flush with cabinet assembly 205. When handle is fully inward, it is nested to cabinet assembly 205 with hand opening accessible from the bottom.

As illustrated in FIG. 18, the smart water treatment appliance 200 has an operator control panel 211 which is positioned on the front of top cover 205a FIG. 4. Control panel 211 may have a display screen capable of showing appliance status as shown on 211a. Display device can be capable of displaying a variety of information such as but not limited to:
a. Operational mode; bypass, filtering, opening, flushing, etc.;
b. Warnings;
c. Fault codes;
d. Operational instructions;
e. Cartridge identification;
f. Cartridge position;
g. Flow configuration (serial/parallel);
h. Water flow rate;
i. Water temperature;
j. Water pressure;
k. Cartridge positions;
l. Time and date;
m. Battery capacity; and/or
n. Power status, battery %, charging etc.

In some embodiments, the control panel 211 can also have a variety of indicator lamps 211b which can confirm the selected button function or indicate a process or fault. Buttons; power 211c, open close 211d, filtered water 211e and bypass 211f are anticipated. Additional buttons for example, such as set date/time or menu are also anticipated. Buttons can also be unlabeled and given assignments by the display according to its menu structure and programming. Buttons may allow an operator to interact with the smart water treatment appliance 200 directly. Additionally, smart water treatment appliance 200 can be remotely operated by a smart device via wireless radio control such as a smart phone 107, or wired or wireless remote-control devices 105, and 108 FIG. 22.

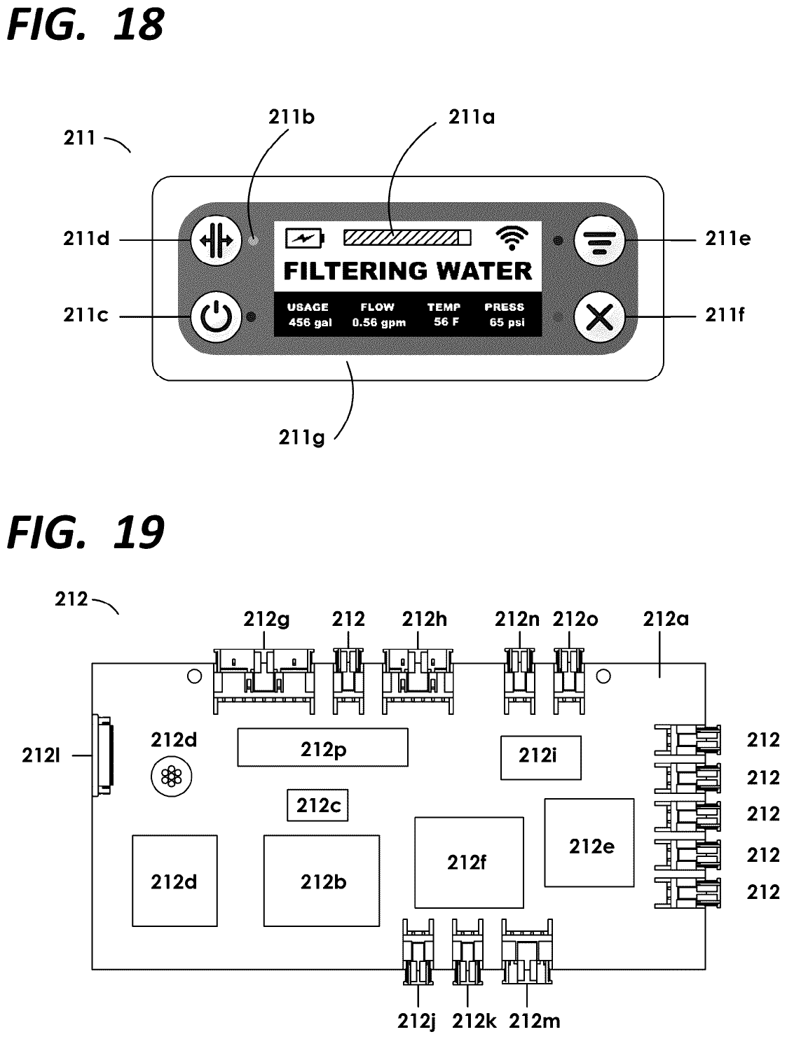

An example controller 212 architecture of certain embodiments is shown FIG. 19. Controller 212 is built upon PCB 212a with microprocessor 212b managing all input and output data. Security authentication 212c allows the manufacturer and user to be using the correct cartridge for the application and therefore controls the safe operation of the appliance. Wireless communication IC 212d provides for wireless Bluetooth, Wi-Fi, NFC, etc., communications capability to be remotely controlled and connected to the Internet of Things (IoT). Valve drivers 212e can provide forward or reverse voltages to drive bi-stable latching solenoid valve coils instantly and independently. The motor is operated by a motor controller 212f capable of providing forward and reversing voltages and may even have current limiting sensing to detect faults. The electrical communication interface TC1 memory connector with encoders 212g and TC2 memory connector 212h allows 2-way digital communication with smart treatment cartridge read-write memories and can receive pulsed data from the encoders, if so equipped, for interpreting the positioning, rpm, and home orientation of engagement collar 210a, as well as providing power to smart memory 208c, encoder sensor 210f, and home sensor 210g. Power conditioning 212i manages the battery 219 or DC power input 218 regulation and provides any necessary safety for unexpected voltages or polarities. Power conditioning 212i may provide voltage boosting for various sub systems such as motor voltage or voltage bucking for voltages at the board level. Controller 212 has digital input capability for the door sensor 212j, and water leak sensor 212k. Analog data inputs are provided to receive signals from sensors such as; flow 209h, pressure 209i, and temperature 209i. Battery connector 212n and DC power connector 2120 provide for power input. Communication I/O is received and conditioned by suitable serial communication I/O 212p. Speaker 210q provides audio feedback for key mode changes, faults, etc. Actual integrated circuit designs may consist of various modules, IC's, components and sub-systems different from that which is described herein, but the capability and functionality is hereby referenced to provide an overall control operation understanding for the appliance.

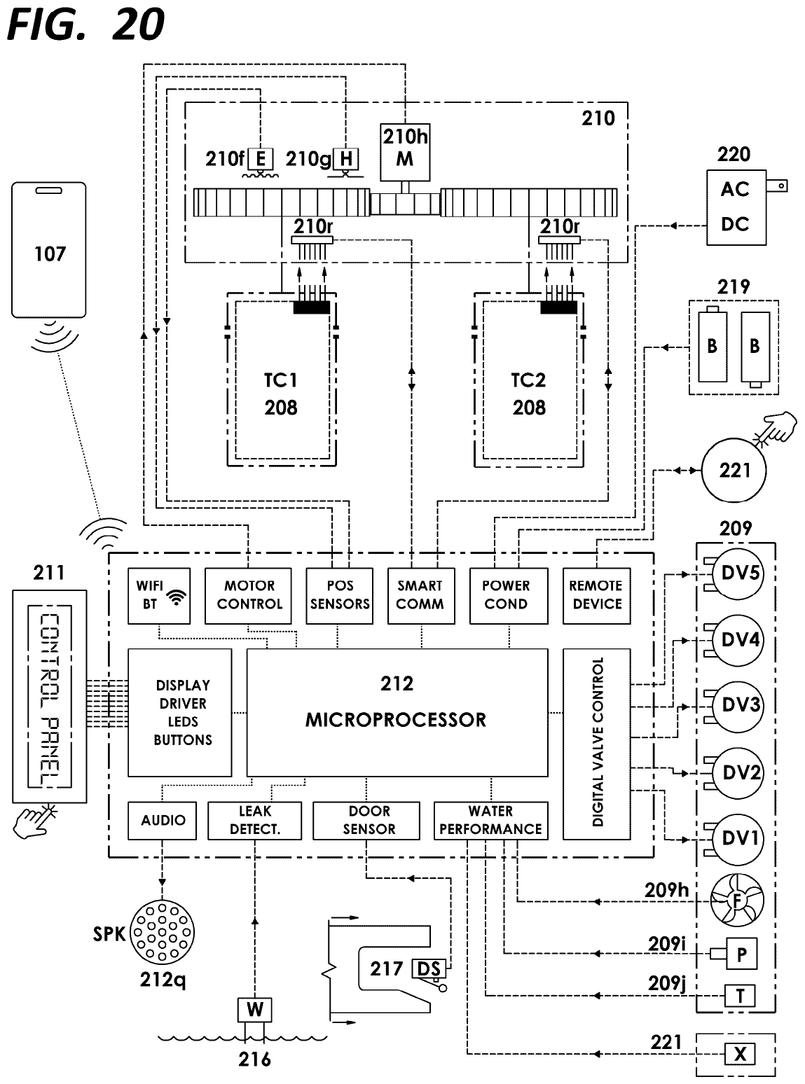

A system process and control diagram of some embodiments is detailed in FIG. 20 and shows how the controller 212 interacts with all of the electrical inputs and outputs. The microprocessor receives power, digital and analog electrical signals, processes the signals into data, and then sends a variety of outputs to drive various components. Power is supplied via battery 219 or AC/DC adapter 220 and is feed to suitable power conditioning components and provides full-time and back-up power for appliance operation. The treatment cartridge receiver 210 has multiple devices which interact with the controller; motor 210h, encoders 210f and 210g, and receiver head electrical connector pins 210r for treatment cartridges (1) and (2). A first treatment cartridge 208 and a second treatment cartridge 208 with their persistent non-volatile read-write memories are electrically connected to 210r (1) and 210r (2) respectively. Cartridge communication is possible at the exact moment the cartridges are fully inserted when power is coupled to the treatment cartridges. Communication with the cartridges can be constant or interrupted as instructed by the microprocessor.

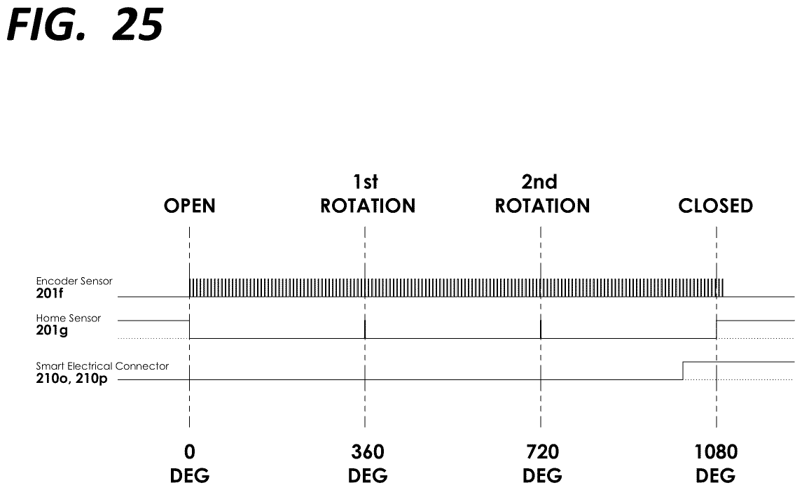

In certain such embodiments, the receiver head electrical connector pins 210r contain at least one conductor, but multiple conductors are also anticipated to carry serial communication and power circuits interior and exterior to the cartridge. Motor 210h is coupled to a respective motor control function which provides forward and reverse power to rotate the motor in both directions. Encoder 210f provides a pulsed signal at a frequency proportional to its rotational speed with each pulse received equal to a specific rotational distance. Home encoder 210g provides a single pulse when the engagement collar 210a is at its reference home position. If, for example, if the engagement collar 210a has 50 timing cam surfaces and is rotated (3) full rotations starting from its home position, there will be a constant signal from the home encoder 210g while at home, a pulse when engagement collar 210a is rotated 360 degrees, a pulse when engagement collar 210a is rotated 720 degrees, and constant signal from the home encoder 210g while resting at home again when stopped at 1080 degrees while encoder 210f sent out 150 pulses. This non-limiting example is shown in FIG. 25.

According to some embodiments, the fluid flow management module 209 is connected to the controller 212 to receive discrete command signals driving the solenoid valves. Each solenoid valve can be toggled by a short positive or negative pulse. For example, applying 6 volts DC in a forward biased connection for 15 milliseconds will actuate a 6-volt bi-stable latching solenoid valve fully open latching it on even when power is removed. Closing the solenoid valve requires a reversed biased 6 volts DC connection for 15 milliseconds. While other solenoids are commonly used in appliances to control water flow, the use of bi-stable latching solenoid valves allows the appliance to operate on battery power for long periods of time and keeps the valves cool. Fluid flow management module 209 also sends signals from any sensor devices present to measure water properties and performance such as; flow 209h, pressure 209i, temperature 209j, and any other sensors 209k. Water performance sensors can be on/off, pulsed, or analog voltage or current, where these signals are connected to the microprocessor for reading and further processing. The water performance data is compiled and processed by microprocessor and decisions are made to display the information on the control panel 211, log data in microprocessor memory, and write data to the smart treatment cartridges. For example, if the water pressure is too high, the microprocessor can selectively choose to shut off the water supply to the appliance, alarm the user with a flashing lamp, produce audible alarm, message a text, and write a fault code to the controller and cartridge memories. If the water flow rate is faster than the treatment cartridge rating, the microprocessor can alarm the user and selectively choose serial flow through the cartridges if permittable. If the amount of pulses counted from the flow meter reaches the capacity of the treatment cartridge, the treatment of the water can be ceased with only bypass water being allowed until new cartridges are installed and restart a new treatment.

According to some embodiments, the door sensor 217 is used to return a voltage to the microprocessor only when the handle 207 is fully rear-ward denoting that the sumps 206b are in the ready-to-thread position. Water leak sensor 216 is used to return a voltage to the microprocessor if excessive moisture is detected in the bottom tray 205b of the cabinet 205. The use of the water leak sensor 216 may identify any problematic leaks from the appliance and disconnect the appliance from the pressurized water supply. The microprocessor can alarm the user with a flashing lamp, audible alarm, message text, and write a fault code to the memories.

According to some embodiments, audio feedback to the user can be provided by the use of a beeper or speaker 212q. Speaker 212q can be of a piezo type, buzzer, or analog speaker. In the case of an analog speaker, the microprocessor will require an audio D/A converter and suitable amplifier circuitry but many more pleasing and attention getting sounds are possible including spoken voice messages.

In some embodiments, the control panel 211 is connected to microprocessor typically via ribbon cable and can provide multiple buttons and LED indicator circuits and provide a multi-conductor connection to drive a suitable display. Display technologies are ever changing and many different types of displays are possible including LCD, TFT, LED, OLED, and ePaper for examples. An ePaper display may allow for more efficient battery operation as it consumes very little power and the display remains persistent.

In some embodiments, controller 212 when integrated with communication IC, WI-FI, Bluetooth 212d, is able to connect to remote devices using wireless radio communication. Wireless radio communication provides a means to connect the smart water treatment appliance 200 to a local internet, smart phone, tablet, PC, etc. With communication IC, WI-FI, Bluetooth 212d, the user can remotely control or see the operational condition of the appliance using a smart phone 107.

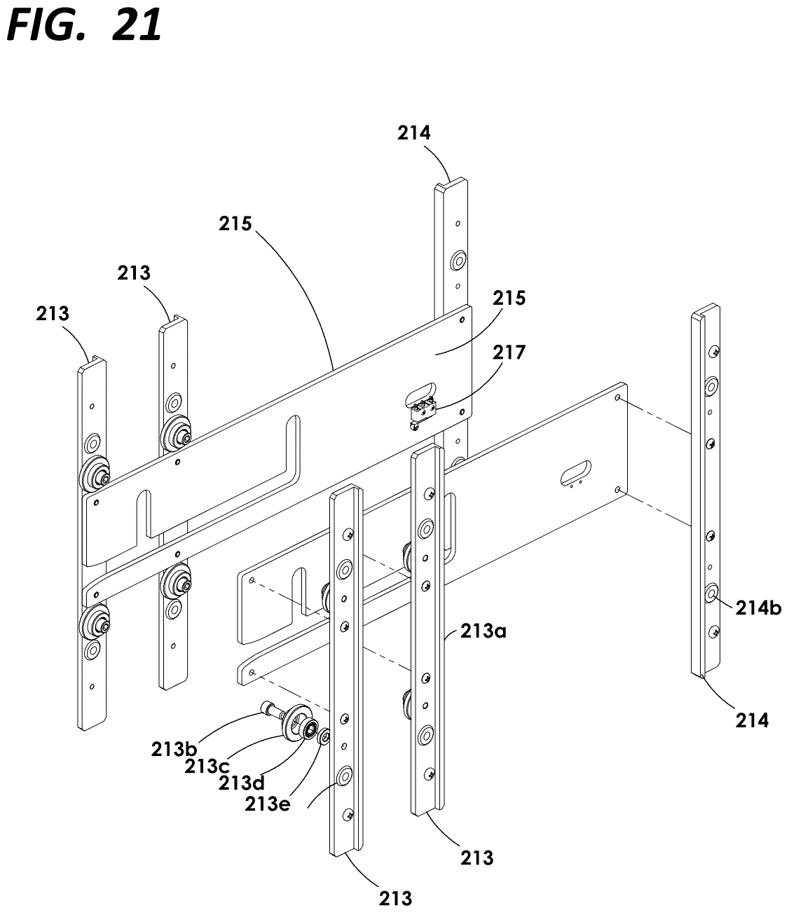

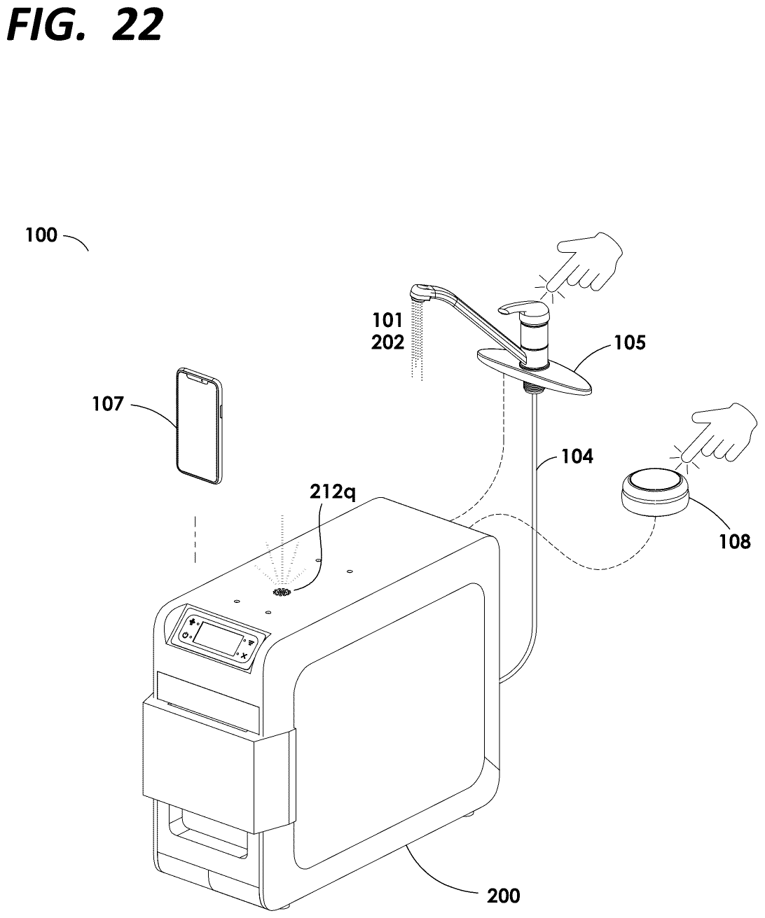

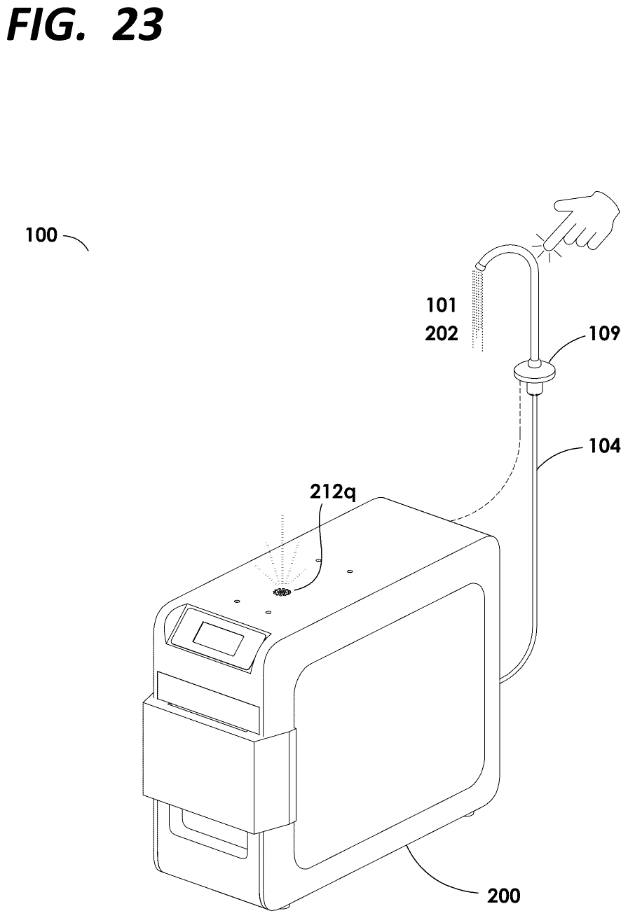

The support structure FIG. 21 for the appliance can be fashioned from any materials such as steel, aluminum, plastic or combinations thereof. Once such construction shows aluminum upright assemblies; (4) upright member, roller 213 and (2) upright member, rear 214 together with (2) master track assembly 215. These upright assemblies serve to connect the cabinet assembly top cover 205a rigidly with bottom try 205b. Upright assemblies attach to the cover and tray structurally, being secured by suitable fasteners such as screws or snap fitting clips. Entire support structure can also be molded as (2) plastic parts for example, a right and left side eliminating many fasteners and features. Upright member, roller 213 has provisions for mounting suitable rollers to constrain and guide the drawer assembly 206. Rollers can be of any suitable type such as ball bearing or plain bushings depending on cost and friction preferences. Upright member 213a is shown with roller axle 213b, drawer roller 213c, roller bearing 213d, and spacer 213e. These individual components can be replaced with a snap-fit plastic roller as desired. Alternately, roller system can be replaced with telescopic drawer guides, glides, or other low friction system to provide constrained drawer motion inward and outward. In this embodiment upright member, roller 213 and upright member, rear 214 have a panel mounting feature 213f and 214b respectively to allow detachable connection with side panels 205c for easy assembly and maintenance with or without tools. Panel mounting features 213f and 214b can be clips, screws, grommets, magnets, snap sockets, pins, or the like. Master track assembly 215 is securely attached to one or both sides to allow additional motion constraint of drawer 206 and handle 207 operations.

The smart water treatment appliance system 100 according to some embodiments is shown in FIG. 22 in operation with a faucet 105, which has its own internal valve to control water flow. The typical kitchen faucet 105 can be completely shut off independent of the smart water treatment appliance 200. When faucet 105 is in the cold-water position and handle positioned to open the faucet valve for the water to flow, smart water treatment appliance 200 is able to provide flowing water to the user. The faucet handle can be positioned to slow the flow rate down or turned off completely. The smart water treatment appliance 200 requires a user input to set the operational mode to treatment or bypass. The operational mode can be selected or changed by several non-limiting example methods:
a. (2) quick open/close motions of the faucet handle can be sensed to trigger the appliance to switch to treated water;
b. A 30 second delay can reset the appliance to provide bypass flow of untreated water;
c. User can select the flow mode from the front control panel of the unit;
d. User can select the flow mode from a smart wireless device 107, such as a smart phone
e. If equipped, user can use a remote wired device 108 to toggle modes; and/or
f. The faucet can be configured with an electrical wire using a capacitance touch sensing circuit during installation such that the user can touch the faucet with a finger to change flow modes.

In each of these examples, the appliance may emit a brief audible tone from 212q and illuminate a lamp to confirm to the user that the correct flow mode; treated or bypass is enabled.

The smart water treatment appliance system 100 according to some embodiments is shown in FIG. 23 in operation with a spout 109, which does not have any valving to control water flow. The spout 109 is always open and will flow when it is driven by pressurized water. Since smart water treatment appliance 200 has control over its own water on/off status, it can be turned on to provide flow or selectively turned off to stop flow. In this spout configuration, the treatment cartridges are only exposed to pressurized water during a request for water. When the request is stopped, the water quickly slows to a stop and remains stopped yet open to atmospheric pressure. The use of a spout provides a gentle water flow start and stop but still can provide fast flowing water. Control of the flow mode and start stop operation can be via touch sensitive capacitance using a wired connection 108, wireless control 107, or select flow from the front panel 211. The spout can also have basic control integral to its base to have an indicator lamp and buttons.

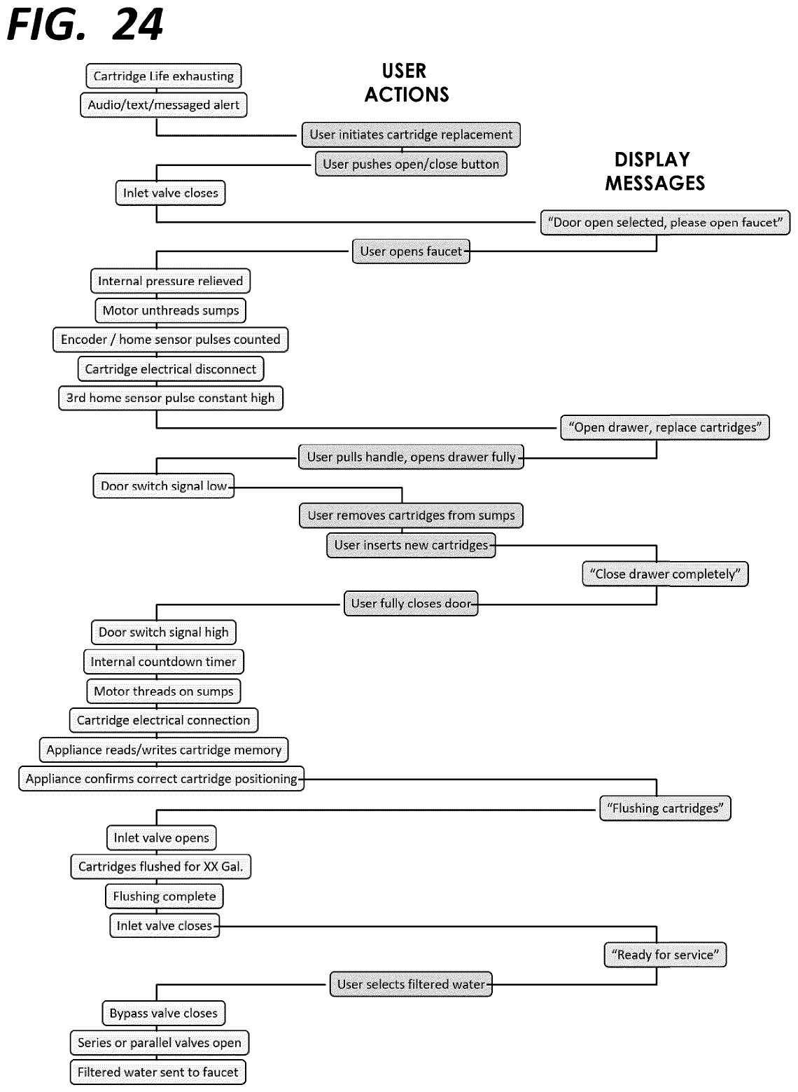

According to the non-limiting example shown in FIG. 24, the smart water treatment appliance uses its control system to facilitate the easy changing of treatment cartridges following the non-limiting example operational process below:
1. Appliance notifies user that cartridge capacity is exhausting;
2. User chooses to change cartridges and pushes the open/close button;
3. Appliance closes the main water valve to off;
4. Appliance displays the message “door open selected, please open faucet”;
5. When the appliance senses that the water pressure is relieved, it uses the motor to unthread the sumps to release them from the receiver;
6. When the cartridges are electrically disconnected and sumps released, the appliance displays “open drawer, replace cartridges”;
7. The user pulls the handle to withdraw the drawer fully exposing spent cartridges;
8. User removes each cartridge by lifting them from the sumps;
9. User places new cartridges into the sumps making sure they are oriented correctly;
10. After a few seconds appliance displays “close drawer completely”;
11. Once the appliance senses the door is fully closed it initiates the motor to secure the sumps to the receiver heads;
12. When the cartridges make electrical contact, the smart memories are read and verified for authorized use;
13. While faucet is still open, display reads “flushing cartridges”;
14. Appliance valves are configured to flow water through the cartridges for XX gallons to flush the cartridges preparing them for service;
15. After flushing is complete, the appliance displays the message “ready for service” and the faucet can be closed; and/or
16. When the user wants to get treated water, the appliance provides treated water when the flow mode is selected and faucet handle is opened.

Of course, it should be known by those of skill in the art that certain of these steps may be performed out of order or skipping certain steps according to some embodiments.

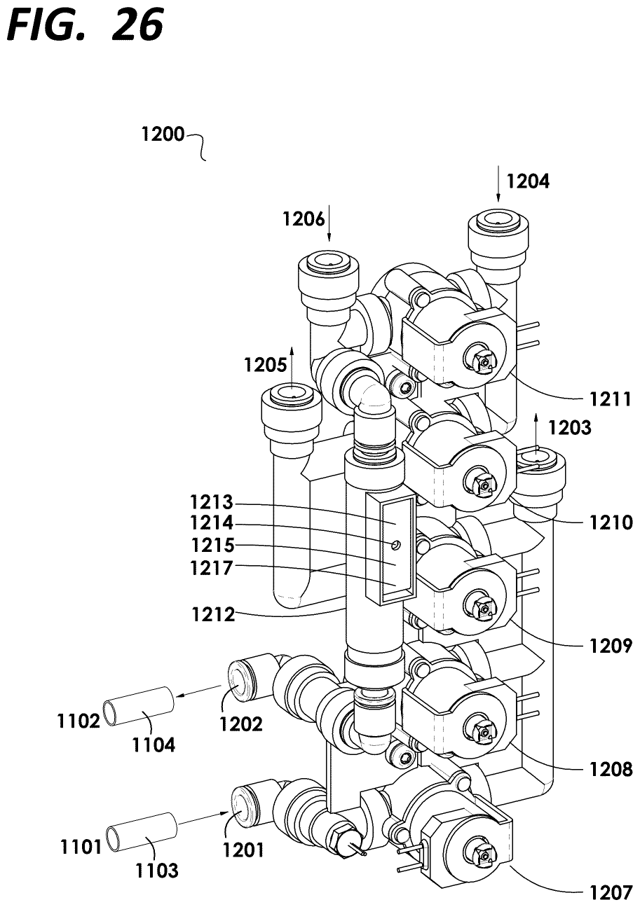

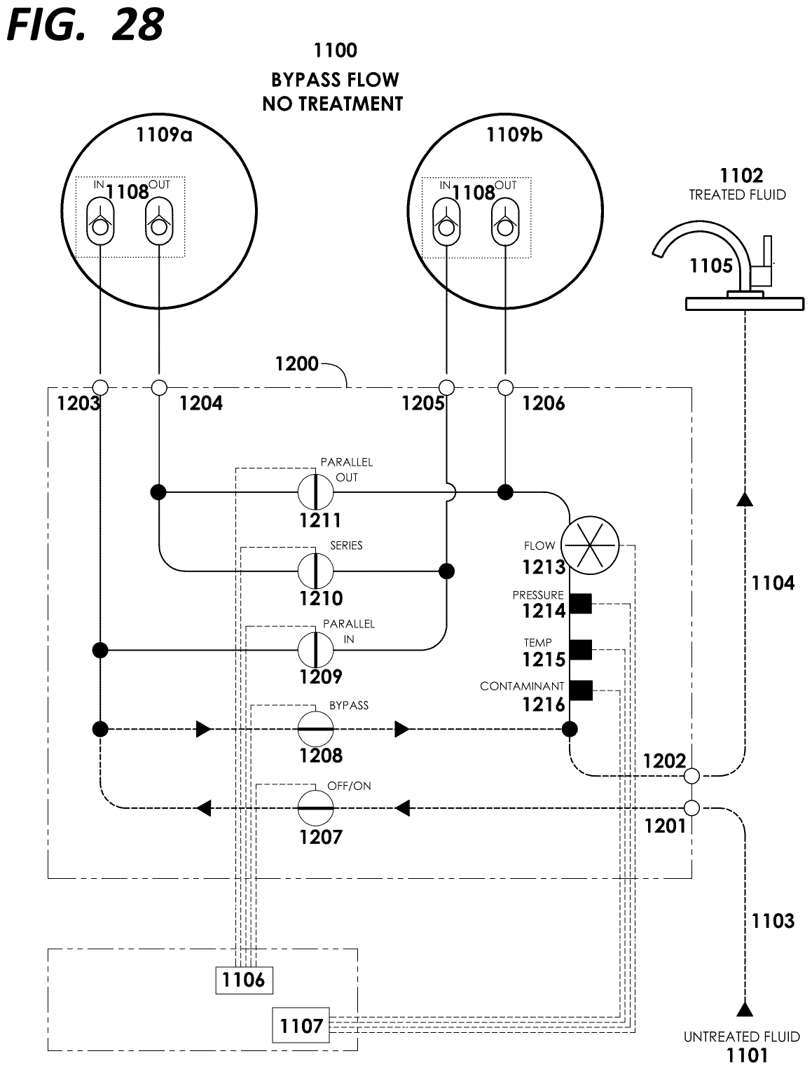

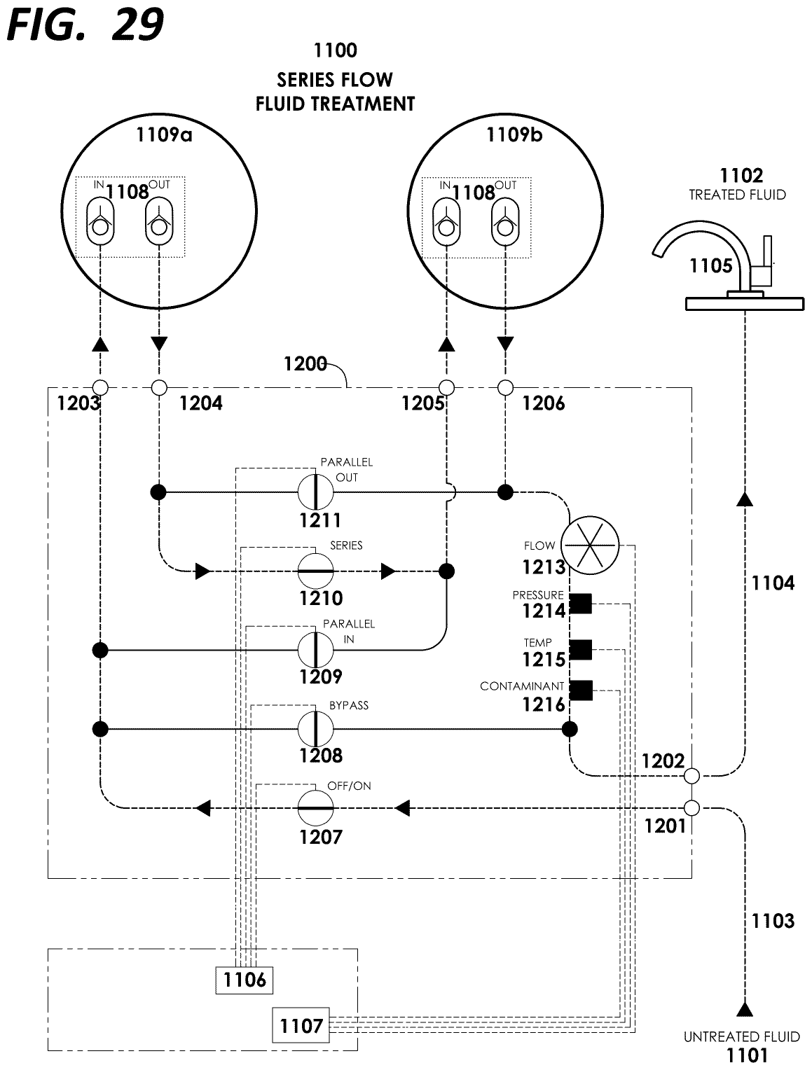

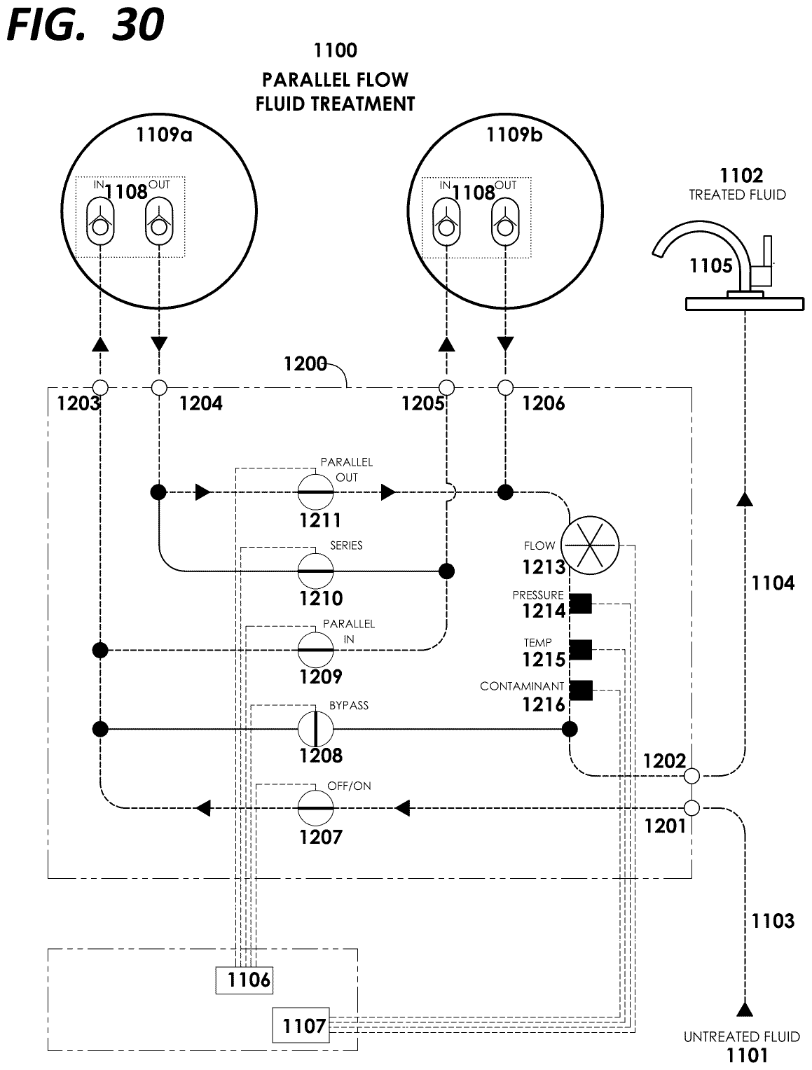

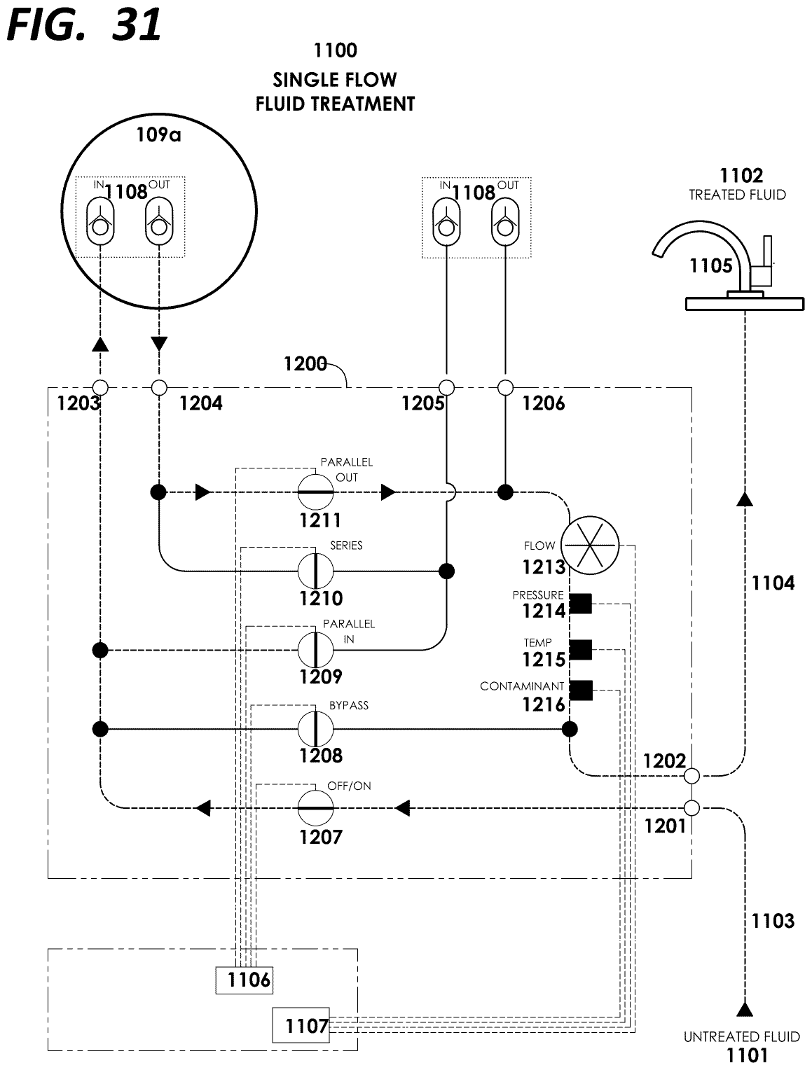

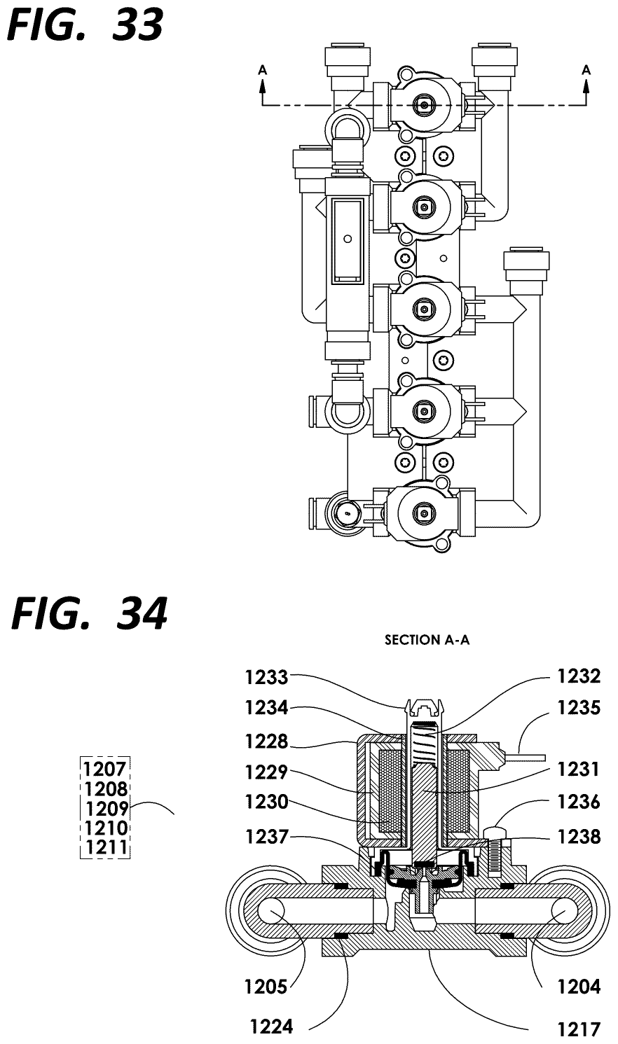

FIGS. 26-38 are directed to a fluid management module according to some embodiments. It should be known that any of the limitations or systems described below may be used with any embodiments shown in FIGS. 1-25 and described above.

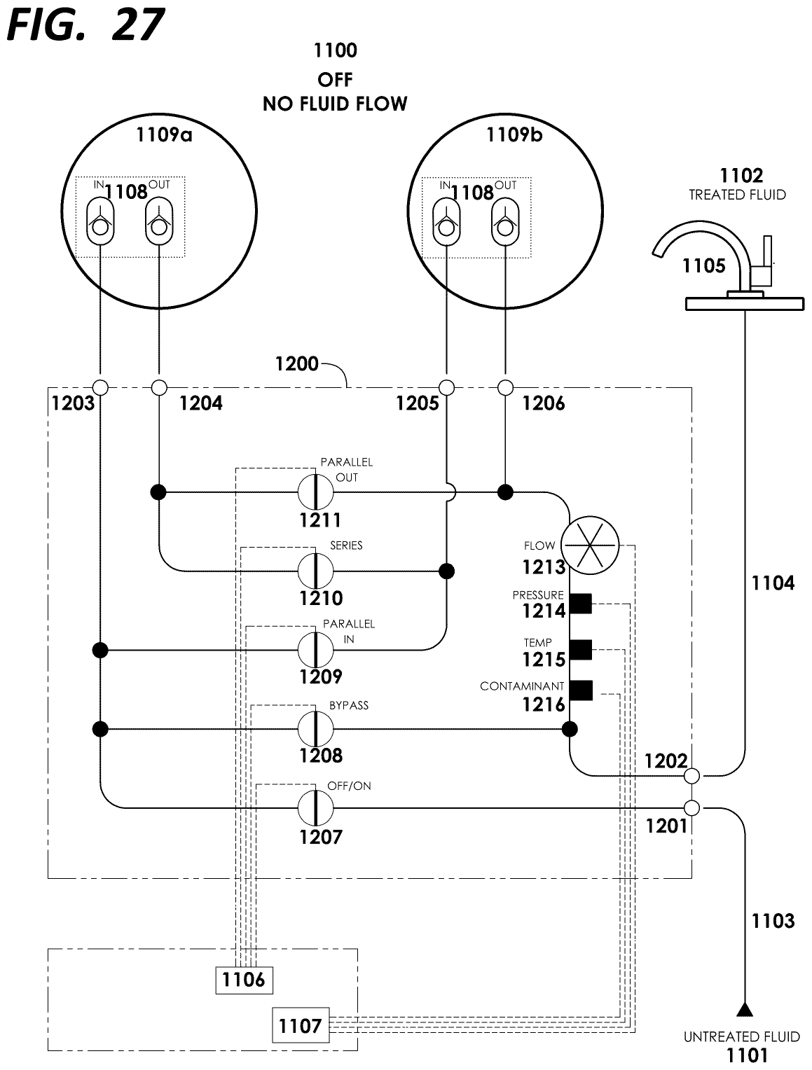

FIG. 26 shows a representative fluid flow management module 1200 according to some embodiments, with its inlet and outlet connections. A source of pressurized untreated water 1101 is supplied to fluid flow management module 1200 via inlet water line 1103 and is connectable to raw water inlet 1201. Similarly, pressurized treated water 1102 is returned via outlet water line 1104 and is connectable to treated water outlet 1202. This representative fluid flow management module 1200 is selectively configured to bypass pressurized untreated water 1101 directly to outlet water line 1104 when BYPASS mode is selected. This representative fluid flow management module 1200 is shown to be connectable to two independent devices, such as treatment cartridges 1109 with said first treatment cartridge 1109a and second treatment cartridge 1109b as shown on FIG. 27.

FIG. 27 depicts two treatment cartridges 1109 which are each removably connectable to treatment cartridge receiver 108 according to some embodiments. Treatment cartridge receiver 1108 is shown with check valve means, which may prevent water flow when any said treatment cartridges 1109 are each not connected. Fluid flow management module 1200 has connection means to supply and receive water from a first treatment cartridge 1109a via inlet treatment cartridge 1 1203 and outlet treatment cartridge 1 1204. Similarly, fluid flow management module 1200 has connection means to supply and receive water from a second treatment cartridge 1109b via inlet treatment cartridge 2 1205 and outlet treatment cartridge 2 1206. Water flow is directed to a point of use device 1105 as desired, such as, but not limited to, an appliance, a faucet, a spout, a tub, a tank, machinery, and the like. Point of use device 1105 may be open to atmospheric pressure or have a valve selectively controllable to allow flow, build pressure, or otherwise modulate flow rates as desired. Point of use device 1105 containing a flow valve may be operated manually or by way of external means such as a lever, cam, gear, diaphragm, piston, solenoid, or servo control, etc.

FIG. 27 also shows a representative internal water flow circuit according to some embodiments, including a plurality of valves 1207, 1208, 1209, 1210, and 1211. Valves depicted are 2-way valves, either normally open (NO) or normally closed (NC). Said valves can be of any type, such as diaphragm, pinch, ball, gate, pintle, butterfly, globe, disk, spool, shuttle, check, and so forth. Said valves 1207, 1208, 1209, 1210, and 1211 are shown in this representative example as direct-acting solenoid valves, which are well known in the industry. Direct-acting solenoid valves are typically either open or closed such that water flow is controlled via an electrical signal as either on or off (discrete control). A NC direct-acting solenoid valve opens when provided an electrical signal of sufficient voltage and current, maintaining its open flow condition while the electrical signal is present. When the electrical signal is not present, the NC direct-acting solenoid valve is closed by way of an internal spring and held closed independent of water pressure in any flow direction up to its rated pressure. If NC indirect-acting solenoid valves are used, such as a pilot-operated diaphragm-type solenoid valve, where a differential water pressure assists in keeping the valve in its open or closed state by way of a diaphragm, careful attention must be given to the valves prescribed flow orientation. Indirect-acting solenoid valves change state when the diaphragm pressure differential is reversed by the solenoid-actuation of a pilot flow path, which affects the diaphragm bias pressure and opens or closes the main flow orifice. For example, the diaphragm employed in a NC indirect-acting solenoid valve can be forced open when its outlet side is exposed to higher pressure than on its inlet side, thereby lifting the diaphragm and opening the valve resulting in a reverse flow condition.

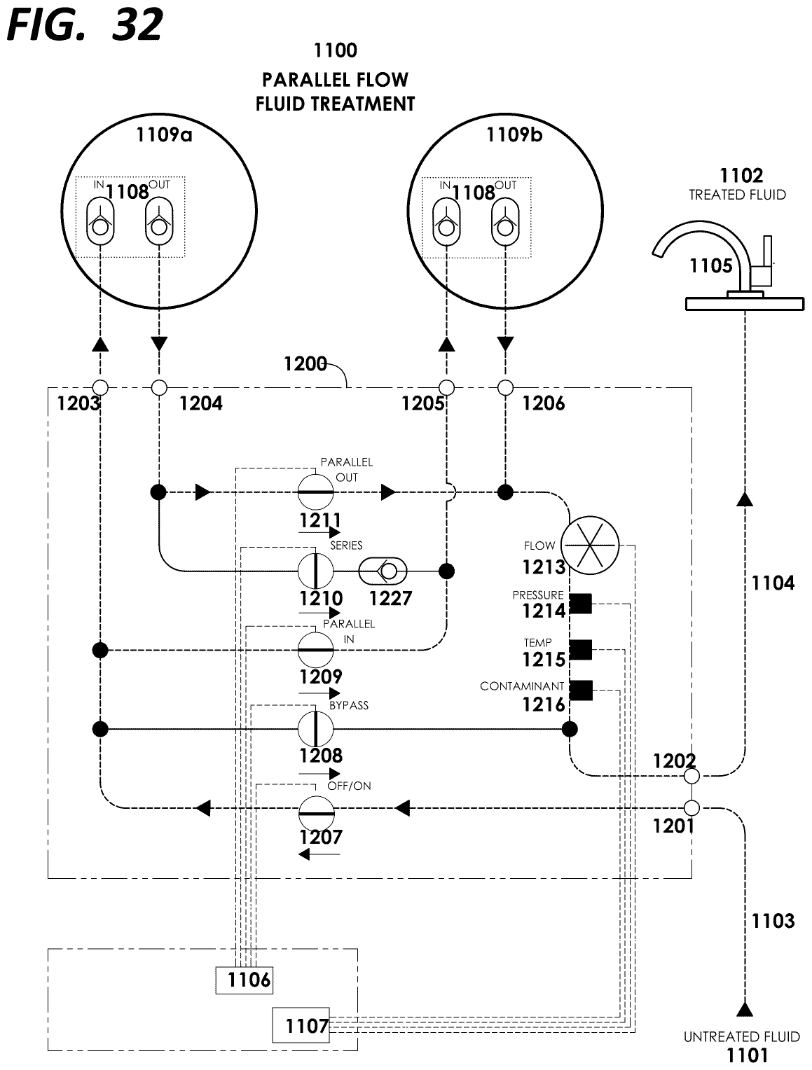

In FIGS. 27-31, the valves 1207, 1208, 1209, 1210, and 1211 are shown as NC direct-acting, whereas FIG. 32 shows an example using NC indirect-acting valves. It should be understood that NC valves can be interchanged with NO valves as desired. If NO valves are desired, the power control signals 1106 need reverse logic such that an electrical signal has the NO valve closed and no signal rendering the valve as off. NO and NC valves can be selected and configured to minimize energy consumption and heat generation. For example, if the fluid flow management module 1200 is intended to be in operation for a majority of time, solenoid valve, on/off 1207 can be chosen to be NO, which allows flow in the absence of power control signal 1106.

FIG. 27 shows valves arranged according to some embodiments with solenoid valve, on/off 1207, solenoid valve, bypass 1208, solenoid valve, parallel in 1209, solenoid valve, series 1210, and solenoid valve, parallel out 1211 indicating their flow function. FIG. 27 shows valves 1207, 1208, 1209, 1210, and 1211 as closed such that no flow is allowed. The operation of solenoid valve, on/off 1207 controls whether or not any rated water pressure can cause water flow for the entire fluid flow management module 1200. For example, according to some embodiments, if it was the intention to divorce the fluid flow management module 1200 from all normal system pressures, the signal can be removed from solenoid valve, on/off 1207, and it will be in its closed state. Valves 1207, 1208, 1209, 1210, and 1211 are shown receiving their discrete power control signals 1106 from an external source. Power control signals 1106 can be direct-current (DC), (forward biased or reverse biased) or alternating-current (AC). DC solenoid valves can be selected to operate with coil voltages typically ranging from 3 VDC to 48 VDC, although other voltages can be used. Popular voltages are 3, 6, 12, and 24 VDC. AC solenoid valves can be selected to operate with coil voltages typically ranging from 24 VAC to 220 VAC, 50 or 60 Hz.

FIG. 27 shows flow sensor 1213, pressure sensor 1214, temperature sensor 1215, and contaminant sensor 1216 according to some embodiments. Sensors 1213, 1214, 1215, 1216 are selectively provided to measure key water properties so as to provide water property signals 1107 as feedback to an external device. Water property signals 1107 can be used to provide input into an external device, such that said external device can monitor or record properties subsequently influencing power control signals 1106. Flow sensor 1213 can be of any type, such as paddle wheel, turbine, diaphragm, ultrasonic, capacitive, mems, Coriolis, vortex, venturi, ultrasonic, etc. Flow sensor 1213 should be selected for the specific application and flow rate. For example, it may be suitable to use magnetic paddle wheel type with hall effect sensor to count pulses proportional to flow rate. Such a flow sensor 1213 would be characteristic of supplying a square wave signal at sensor voltage. Frequency of square wave signal would be associated to water flow rate according to a calibration curve. Other flow sensors can provide analog signals proportional to flow rate, or even digital logic outputs as desired. Flow sensor 1213 can be used to calculate the volume of water used during a time interval by measuring the time of the interval and the flow rate history during the interval and calculating a volume therefrom.

According to some embodiments, the pressure sensor 1214 may be provided to let external device know when system pressure is within operating range, outside of operating range, or the water pressure signal can be used to determine if point of use device 1105 is open or closed. Pressure sensor 1214 may be used to gauge differential pressure of treatment cartridges 1109, or if the solenoid valve, on/off 1207 is operative. Pressure sensor 1214 will provide differing signals based upon the open or closed state of valves 1207, 1208, 1209, 1210, and 1211. Pressure sensor 1214 can of any type or technology, such as bourdon tube, capacitive, piezoresistive, strain gauge, mems, etc. In some embodiments, pressure sensor 1214 provides an analog output proportional to a pressure calibration curve. Pressure sensor 1214 may be used to interpret flow rates of treatment cartridges with respect to the supply pressure or the differential pressures as the valves are selectively operated.

According to some embodiments, temperature sensor 1215 may be provided to provide feedback to external device about the water temperature during use, or even ambient temperature during an extended time not being used. Temperate sensor 1215 is typically that of a thermocouple (active) or a thermistor (passive), each providing an analog voltage output. The use of a thermocouple may require additional circuitry to amplify its millivolt signal, whereas the thermistor requires a voltage input and returns a fraction of it. For example, if temperature sensor 1215 signal is interpreted by external device that it is close to freezing, solenoid valve, on/off 1207 can be commanded to close. If for example, temperature sensor 1215 signal is interpreted by external device that it is operating close to either the upper or lower range of treatment cartridge 1109a or 1109b, solenoid valve, on/off 1207 can be commanded to close. A provision of a temperature sensor 1215 being disposed within digital fluid flow management module 1200 is that an external device biases a calculated volume of water to be slewed upward or downward based upon the temperature profile determined during that calculated volume which may extend or shorten treatment cartridge lifespan.

According to some embodiments, contaminant sensor 1216 may be provided to gauge the performance of a treatment cartridge behavior. For example, if it is considered that the fluid flow management module 1200 is to be employed for the purpose of reducing the amount of perfluoroalkyl and polyfluoroalkyl substances (PFAS), now found in the majority of water supplies throughout the world, a suitable contaminant sensor 1216 may be chosen to be a specialized sensor to detect PFAS chemicals and provide a signal to external device which can be used to modify power control signals to the valves 1207, 1208, 1209, 1210, and 1211 as desired. Similarly, a contaminant sensor 1216 may be chosen to be a specialized heavy metal sensor for arsenic, cadmium, chromium, lead, and mercury, etc. Fluid flow management module 1200 may contain any number and type of water property sensors providing any number and type of water property signals 1107 to an external device.

FIGS. 27-31 show the same representative internal water flow circuit according to some embodiments, and including a plurality of valves 1207, 1208, 1209, 1210, and 1211 as shown in FIG. 27, but operating in 5 different flow states as instantly configured in Chart 1, shown below, FIGS. 27-31 show flowing water with dashed lines. Also, point of use device 1105 must be open for water to be flowing. When point of use device 1105 is closed, water will not flow, but water pressure may be present in some or all internal flow paths.

| | | CHART 1 | | | | |
|---|---|---|---|---|---|---|
| | | VALVE OPEN/CLOSE STATE | | | | |
| VALVE | DESCRIPTION | NO FLOW | BYPASS | SERIAL | PARALLEL | SINGLE |
| 1207 | solenoid valve, | OFF | ON | ON | ON | ON |
| | on/off | | | | | |
| 1208 | solenoid valve, | OFF | ON | OFF | OFF | OFF |
| | bypass | | | | | |
| 1209 | solenoid valve, | OFF | OFF | OFF | ON | OFF |
| | parallel in | | | | | |
| 1210 | solenoid valve, | OFF | OFF | ON | OFF | OFF |
| | series | | | | | |
| 1211 | solenoid valve, | OFF | OFF | OFF | ON | ON |
| | parallel out | | | | | |

FIG. 32 shows the same representative internal water flow circuit according to some embodiments, and including a plurality of NC solenoid valves 1207, 1208, 1209, 1210, and 1211 as shown in FIG. 27, excepting FIG. 32 shows an example using NC indirect-acting valves, as opposed to direct-acting valves. FIG. 32 shows valves in the orientation of flow direction with a directional arrow. The NC indirect-acting valve work as expected in all flow configurations except PARALLEL. In this PARALLEL flow configuration, source water pressure flowing through solenoid valve, on/off 1207 is able to pass through solenoid valve, parallel in 1209 as it provides treatment cartridge 1109b with untreated water 1101. Solenoid valve, series 1210 is in its closed state, but experiences higher water pressure from the exit of solenoid valve, parallel in 1209, such that its diaphragm is lifted upward and forces the valve open causing reverse flow of untreated water to be sent to solenoid valve, parallel out 1211, and as such, contaminating the water being fed to point of use 1105. The integration of check valve 1227 on the downstream side of solenoid valve, series in 1210 prevents its reverse flow and keeps the valve in its closed state as intended. FIG. 32 can take advantage of a bi-stable latching solenoid valves where its open or closed state is held by magnetic armature. When a bi-stable latching solenoid is given a positive polarity electrical signal for a brief moment (15 milli-second pulse), the valve is driven open, and when it is given a reverse polarity pulse, it is driven to a closed position. The valve remains latched in either the open or closed position indefinitely, even without power. The bi-stable latching solenoid is an indirect-acting valve with a pilot operated diaphragm and must be oriented as to not experience reverse pressures or the valve will open, even when latched in its closed position without the addition of a check valve 1227. Bi-stable latching solenoids are well suited for operating on battery power and being used without power for extended times. Since bi-stable latching solenoids only require power to change on or off condition, they do not produce heat and remain at ambient temperatures indefinitely.

FIG. 34 shows a cross-section of a typical NC indirect-driven diaphragm solenoid valve according to some embodiments. Solenoid housing 1228 is a steel frame which holds the solenoid coil insulation 1229 and solenoid coil 1230. Solenoid armature 1231 is steel with a corrosion-inhibiting plating. Solenoid armature spring 1232, typically stainless steel, keeps solenoid armature 1231 biased in its closed position when coil is not energized. Both armature 1231 and armature spring 1232 ride inside of a plastic water-proof solenoid armature sleeve 1233 keeping the coil assembly from getting wet. The solenoid core tube 1234 provides a magnetic conduit to concentrate and convey the toroidal magnetic field produced by the solenoid coil 1230 to act upon the armature. Solenoid wires 1235 are connected to and provide power to the solenoid coil 1230. Solenoid fastener 1236 holds valve assembly to valve manifold 1217, compressing and sealing solenoid diaphragm 1237 to form a water-tight seal. Spring-energized armature bears against solenoid seat 1238 and keeps the pilot orifice closed. When the coil is energized by electrical power, a magnetic field draws the armature upward towards the coil center, against the spring force, and opens the pilot seat. When pilot seat opens, the differential water pressure holding the diaphragm closed is altered resulting in the diaphragm raising upwards and opening the diaphragm valve fully. A NC bi-stable latching solenoid valve is very similar excepting the solenoid armature 1231 is an assembly containing magnets which have a stable (latching) position open and closed. A positive polarity pulse of electricity opens the valve, while a negative polarity pulse closes the valve.

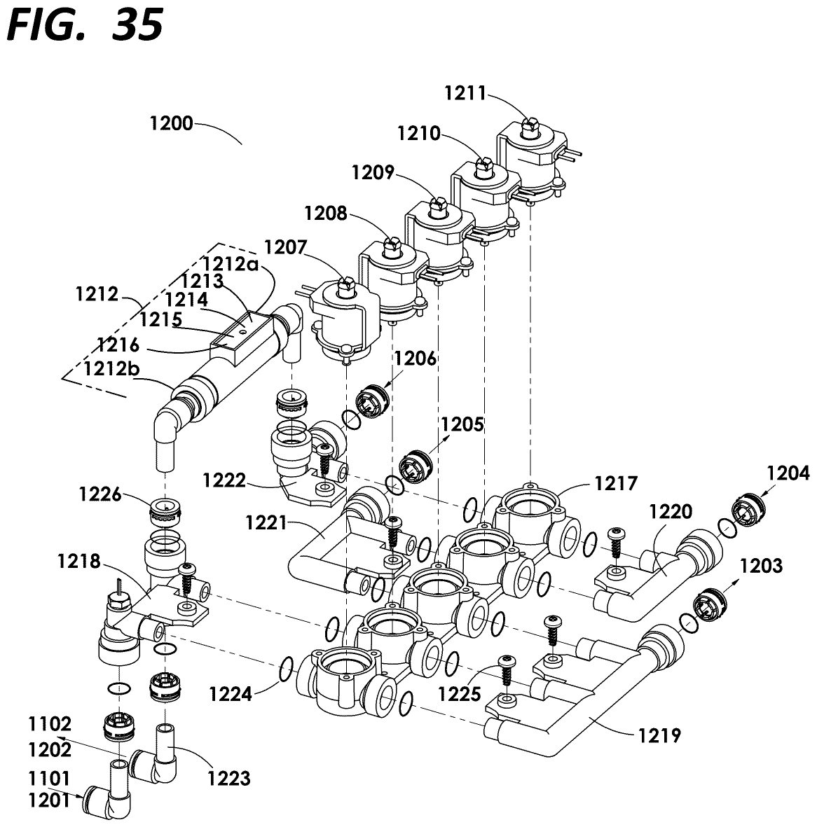

FIG. 35 shows one representative embodiment of a fluid flow management module 1200 using solenoid valves 1207, 1208, 1209, 1210, and 1211. Fluid flow management module 1200 has its inlet and outlet connections shown consistent with FIG. 26 labeled correspondingly. Each connection point is shown in this embodiment as being adapted for use with round plastic tubing such as ¼″, ⅜″, or ½″ OD. Plastic tubing for water lines 1103, 1104 can be, for example, ⅜″ while water lines connectable to 1203, 1204, 1205, and 1206 can be, for example, ¼″. This representative embodiment of a fluid flow management module 1200 is shown with push-fittings 1206 for use with round tubing, in some embodiments PEX, but tubing can be of any material suitable for push fittings in this embodiment. Other fittings, such as threaded, compression, welded, flare, boss o-ring, pipe, etc. are anticipated. O-ring seals 1224 keep separable parts sealed when assembled and are commonly made from EPDM rubber, but may be silicone, buna-N, Kalrez, FKM, Viton, etc. Seals can be round, lip, spring energized, quad-ring, square, u-cup, or other as desired.

According to some embodiments, the valve manifold 1217 may be molded from a polymer such as HDPE, PP, ABS, Nylon, PC, PET, PPO etc. In some embodiments valve manifold is a polymer which is suited for the temperature environment. Nylon works well for hot water, while HDPE works well at or below freezing. Inlet outlet manifold 1218, inlet manifold 1 1219, outlet manifold 1 1220, inlet manifold 2 1221, and outlet manifold 2 1222 are shown as independent components which are assembled onto valve manifold 1217 forming the desired flow paths and connections. Manifolds 1218, 1219, 1220, 1221, and 1222 may be molded from the same polymer as the valve manifold 1217, but can be different as desired. The representative embodiment of a fluid flow management module 1200 shown in this view provides a modular design and assembly architecture allowing different valve operations and manifold connection options with each manifold member being selectively attached as desired with suitable fastener 1225 being used to removably fix members together. The manifold members can be integrally molded, welded, or attached by a variety of other means such as clamps, bolts, clips, brackets, and the like.

Modular sensor assembly 1212 may be a removable module and orientated to function on the treated water outlet path according to some embodiments. Modular sensor assembly 1212 can instead be integrally molded into manifold members and operate with all fluid flows as desired. The arrangement in view here provides for push-fitting attachment to be removeable for field replacement. Additionally, placing the modular sensor assembly 1212 in the treated water path only sends water property data for water, which is being treated as such, and is not confounded by any bypass flows, which can muddle capacity measurements.

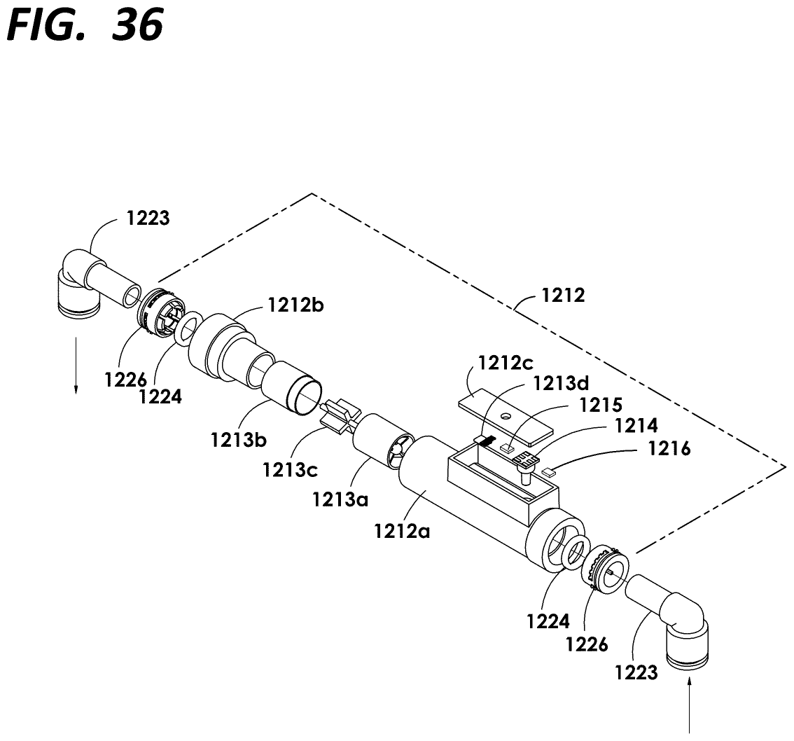

FIG. 36 shows a representative modular sensor assembly 1212 as exploded with its various parts. Sensor assembly 1212 contains at least one sensor to measure physical water properties, such as flow, pressure, and temperature. Sensor assembly 1212 can optionally contain any number of chemical contaminant sensors, such as pH, conductivity, TDS, PFAS, Lead, chlorine, chloramine, hardness, volatile organics, radionuclides, etc. The flow sensor shown in this variant uses a turbine type impellor 1213c, which is magnetic and its rotation can be sensed by magnetic sensor 1213d. Inlet vanes 1213a pre-swirl water to rotate impellor and outlet vanes 1213b straighten out flow and hold axle shaft with integral spherical thrust bearing. Sensor housing, part a 1212a and sensor housing, part b 1212b are assembled to form a water-tight housing with o-ring 1224 and push fitting 1226 at inlet and outlet end. Elbow 1223 is used to connect with manifold 1218 and manifold 1221 to create a flow path and allow field replacement. Sensor PCB 1212c provides mechanical mounting and electrical connections for magnetic sensor 1213d, pressure sensor 1214, temperature sensor 1215, and contaminant sensor 1216. Sensors are provided access to the water flow via suitable apertures, and the sensor housing 1212b can be filled with an encapsulant which seals and protects from moisture and pressure.

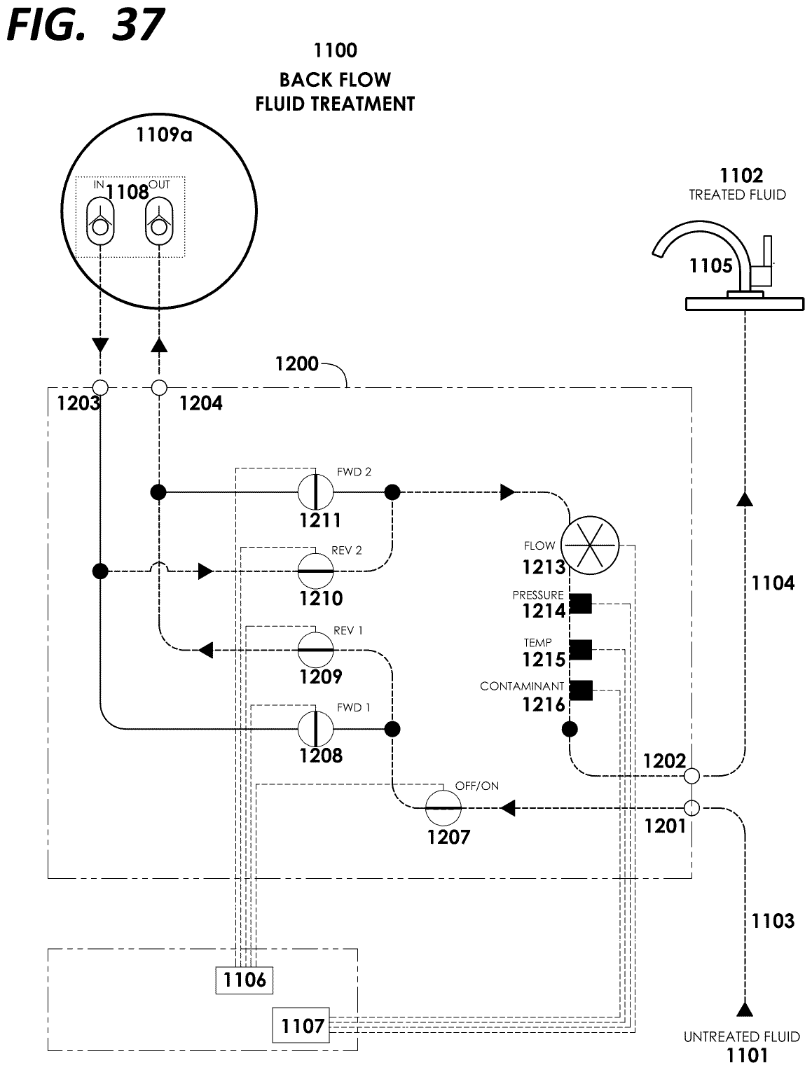

FIG. 37 shows a P&ID for fluid flow management module 1200 with components arranged for operation with a treatment cartridge 1109 installed via treatment cartridge receiver 1108, where the flow of water can be off, in a forward flow path, or in a reverse flow path according to some embodiments. Fluid flow management module 1200 could be used with treatment technologies requiring back washing to clean any treatment media or recharge media. In this representative embodiment, solenoid valves 1207, 1208, 1209, 1210, and 1211 have assignments according to Chart 2 as shown below:

| | | CHART 2 | | |
|---|---|---|---|---|
| | | VALVE OPEN/CLOSE STATE | | |
| | | NO | | |
| VALVE | DESCRIPTION | FLOW | FORWARD | REVERSE |
| 1207 | solenoid valve, on/off | OFF | ON | ON |
| 1208 | solenoid valve, forward 1 | OFF | ON | OFF |
| 1209 | solenoid valve, reverse 1 | OFF | OFF | ON |
| 1210 | solenoid valve, reverse 2 | OFF | OFF | ON |
| 1211 | solenoid valve, forward 2 | OFF | ON | OFF |

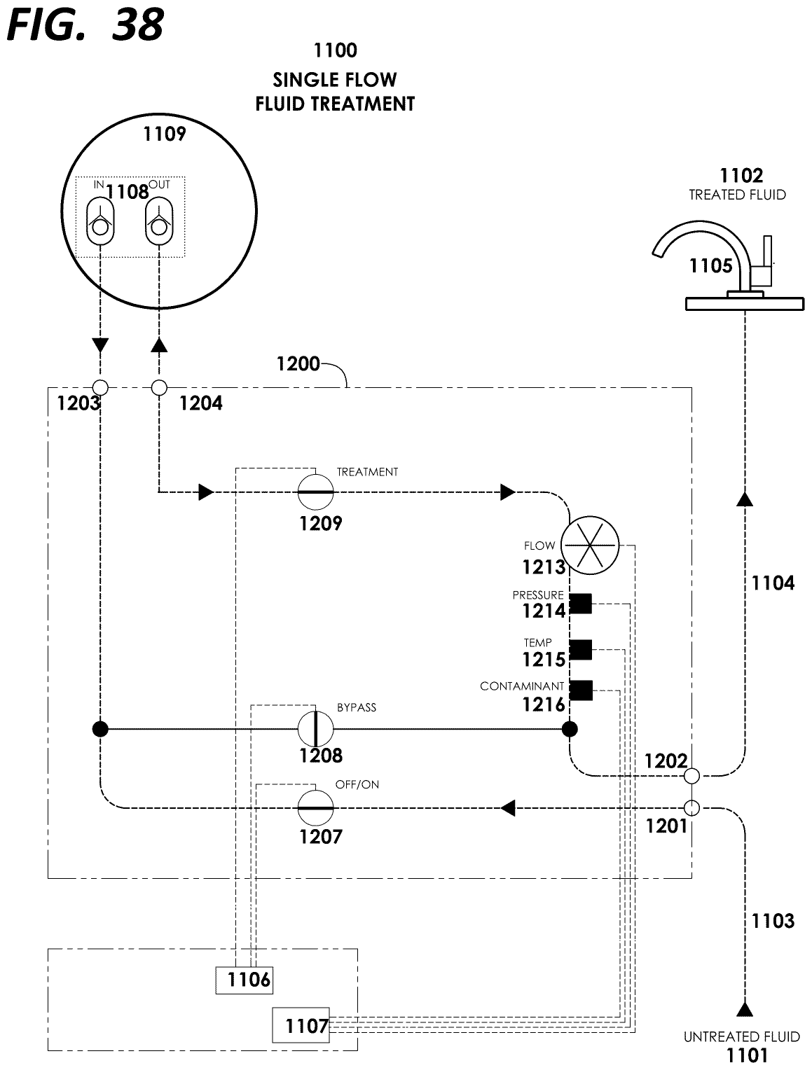

FIG. 38 shows a P&ID for fluid flow management module 200 with components arranged for operation with a treatment cartridge 109 installed via treatment cartridge receiver 108, where the flow of water can be off, bypass, in a treatment flow path according to some embodiments. In this representative embodiment, solenoid valves 207, 208, and 209 have assignments according to Chart 3 as shown below:

| | | CHART 3 | | |
|---|---|---|---|---|
| | | VALVE OPEN/CLOSE STATE | | |
| | | NO | | |
| VALVE | DESCRIPTION | FLOW | BYPASS | TREATMENT |
| 1207 | solenoid valve, on/off | OFF | ON | ON |
| 1208 | solenoid valve, bypass | OFF | ON | OFF |
| 1209 | solenoid valve, treatment | OFF | OFF | ON |

As it can be understood from the various embodiments shown in the piping and instrumentation diagram (P&ID) of FIGS. 27-32, 37, and 38, a wide variety of fluid flow management modules can be constructed to perform many different and complex fluid flow paths through a variety of devices and treatment cartridges. The benefits of such fluid flow management modules are that they can be portable to many different applications and can be instantly configured to provide numerous fluid flow path modes of operation. The instant configuration by way of discrete command signals allows for a water treatment device to be configurable for operation for any future treatment cartridges with unknown technology including serial flow, parallel flow, bypass, and back flow. Additional capabilities are anticipated such as injection flow from a reservoir of concentrate, brine flow, concentrate discharge, and the like. Fluid flow management modules can be used to provide a vast array of water property metrics and adapted for easy configuring in the field.

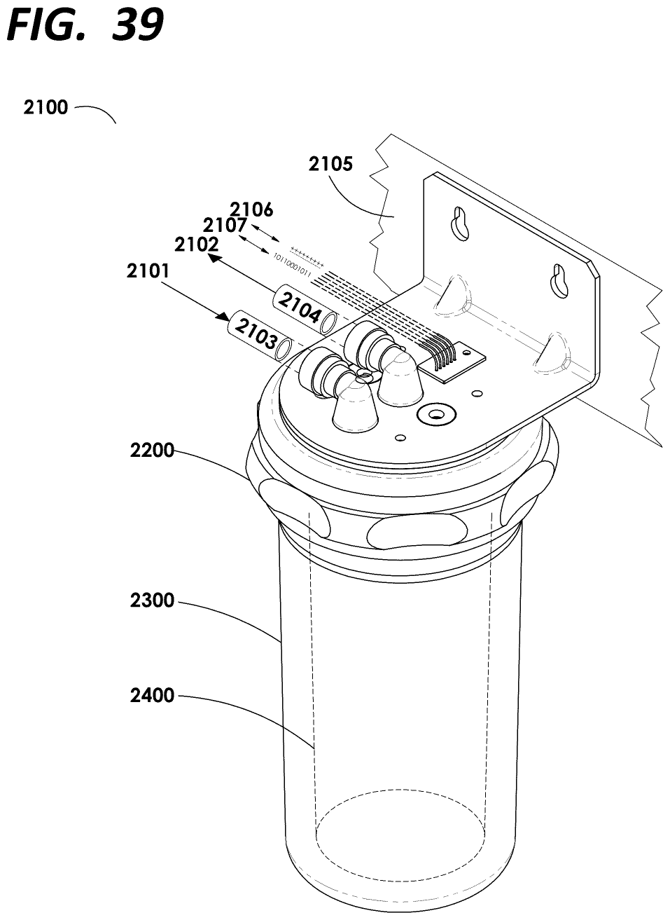

FIGS. 39-57 are directed to a smart fluid treatment cartridge, platform, and/or system according to some embodiments. It should be known that any of the limitations or systems described below may be used with any embodiments shown in FIGS. 1-38 and described in detail above.

FIG. 39 shows a representative smart fluid treatment cartridge platform 2100 according to some embodiments. Smart fluid treatment cartridge platform 2100 is shown with treatment cartridge receiver 2200 rotatably attached to sump 2300, which internally contains smart fluid treatment cartridge 2400. Smart fluid treatment cartridge platform 2100 receives a source of pressurized, untreated, fluid 2101 via untreated fluid line 2103. Smart fluid treatment cartridge platform 2100 provides a means to modify the fluid as desired, for any purpose, and provides pressurized treated fluid 2102 via treated fluid line 2104. Smart fluid treatment cartridge platform 2100 may be connected to a suitable mounting surface 2105 as desired. Smart fluid treatment cartridge platform 2100 may additionally receive a source of electrical power 2106 and can communicate with a read-write data path 2107. In this disclosure, all figures show a representative embodiment of a smart fluid treatment cartridge platform 2100 using a 10″ filter such as a carbon block typically found in wet-change platforms, but the smart fluid treatment cartridge platform 2100 may be used in any size platform, large or small.

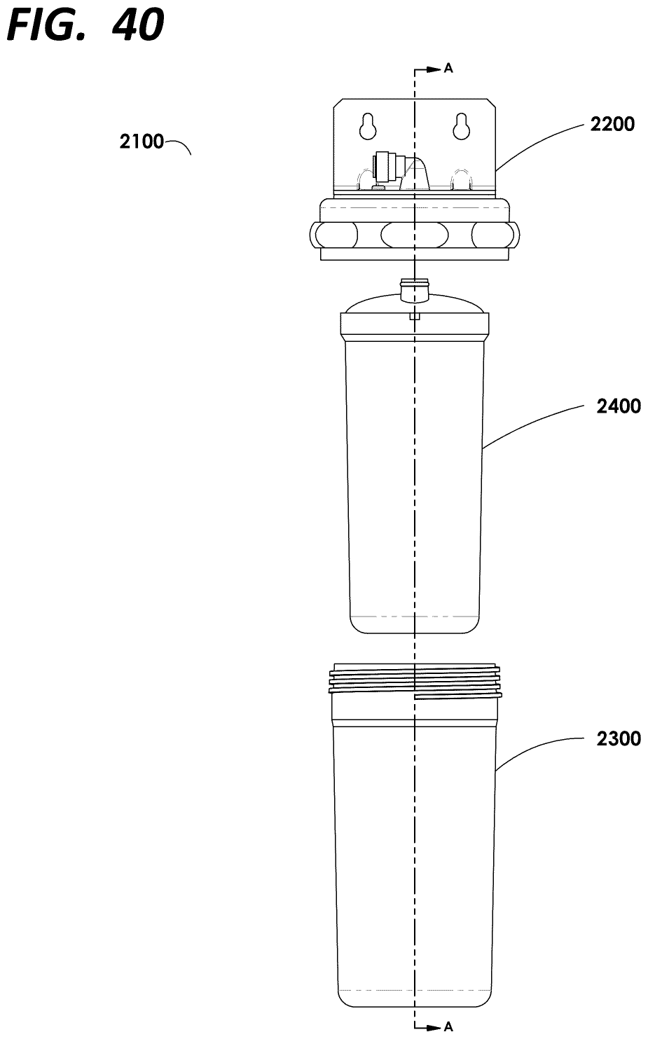

FIG. 40 shows the arrangement of a superstructure according to some embodiments, which is formed when treatment cartridge receiver 2200 is attached to sump 2300, wherein smart fluid treatment cartridge 2400 is provided a structural enclosure. Treatment cartridge receiver 2200 communicates with the source of pressurized untreated fluid 2101, pressurized treated fluid 2102, source of electrical power 2106, and a read-write data path 2107. Treatment cartridge receiver 2200 can be mounted to a suitable surface 2105, which can be a wall or cabinet, part of a drinking water device, or as part of an appliance.

Additionally, in some embodiments, treatment cartridge receiver 2200 could fully contain an electrical power source and any other components interacting with read-write data path 2107, such as a display, processor unit, internet connection, operator buttons, speaker, battery, etc. Smart fluid treatment cartridge 2400 is inserted into and removed from sump 2300. Sump 2300 is aligned with and inserted into treatment cartridge receiver 2200 along a linear path coincident with sump 2300 cylindrical axis and treatment cartridge receiver 2200 cylindrical axis. In some embodiments, smart fluid treatment cartridge 2400 is not intended to rotate as it is inserted into treatment cartridge receiver 2200. When smart fluid treatment cartridge 2400 is inserted into treatment cartridge receiver 2200, the smart fluid treatment cartridge 2400 is connected with the source of pressurized untreated fluid 2101, source of electrical power 2106, a read-write data path 2107, returns a source of pressurized treated fluid 2102, and can send and receive data stored and written to its memory. Treatment cartridge receiver 2200 communicates with an external circuit of fluid and an external circuit of data information and relays these circuits to the smart fluid treatment cartridge 2400. Smart fluid treatment cartridge 2400 communicates with an internal circuit of fluid and an internal circuit of data information and relays these circuits back to the treatment cartridge receiver 2200.

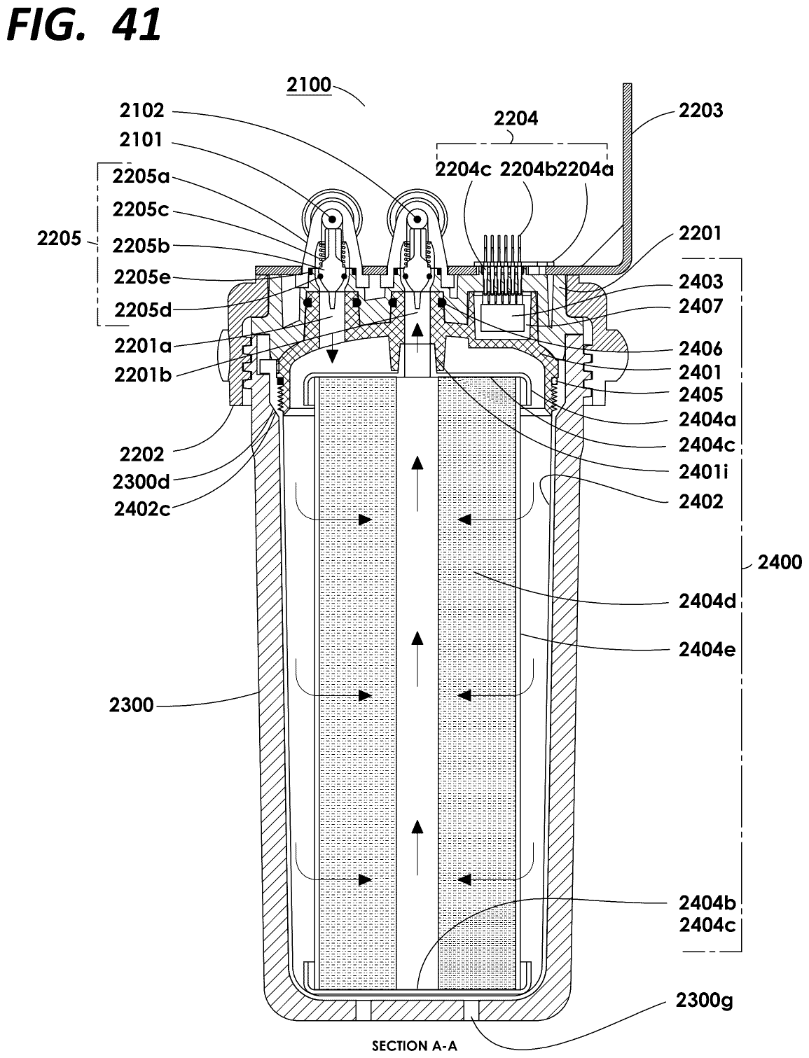

FIG. 41 provides more detail with respect to some embodiments on how the fluid circuit and data communication paths are connected. Treatment cartridge receiver 2200 is provided with a pair of fluidly separate connections via check valve ports 2205 connecting pressurized untreated fluid 2101 to untreated fluid inlet port 2201a and connecting pressurized treated fluid 2102 to treated fluid outlet port 2201b. These fluid connections are adapted to fluidly attach with untreated fluid line 2103 and treated fluid line 2104 respectively. The water lines can be of any type, material, or connection method such as threaded pipe, smooth tubing, flare, compression, O-ring boss, or suitable quick disconnect fittings and the like.

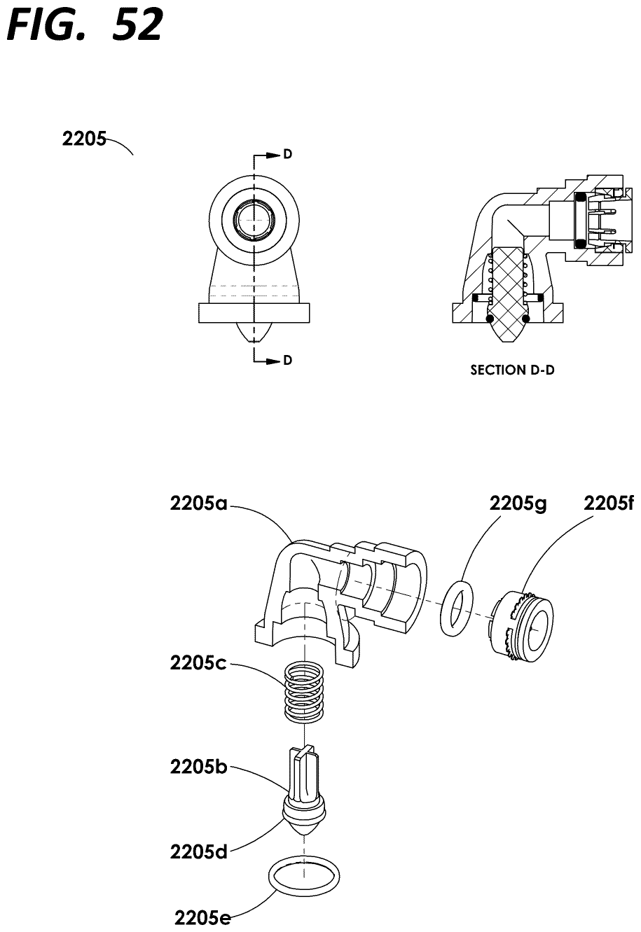

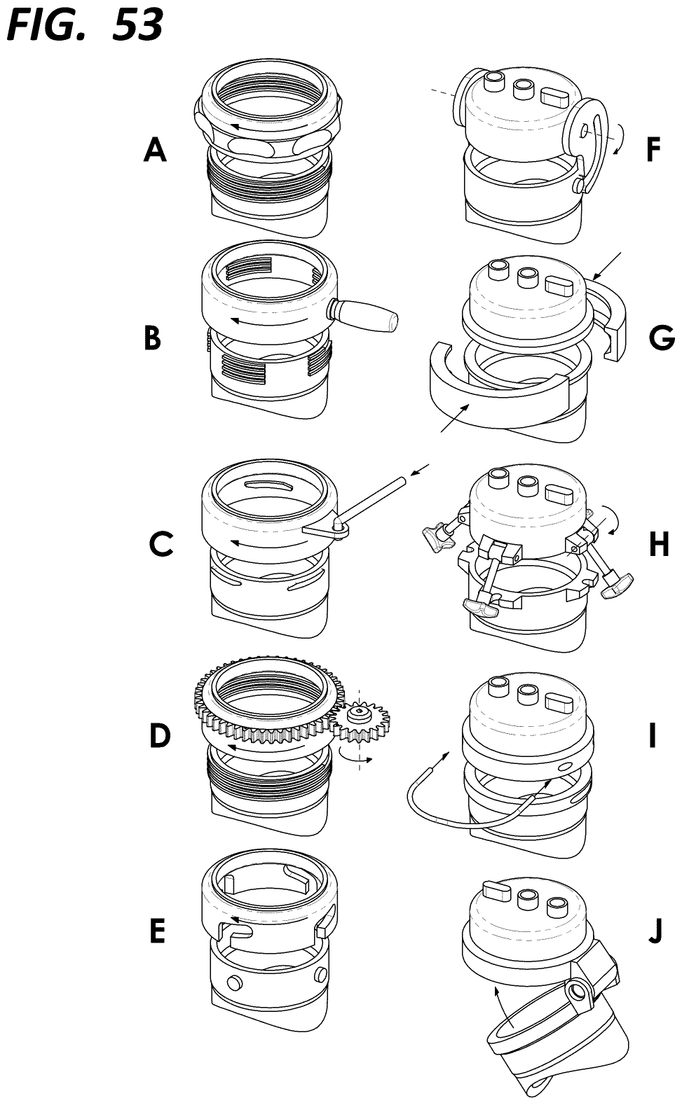

It is well understood that the many water filter cartridges are rotated or twisted to install them into their respective water manifold (receiver head) with the rotary motion of the cartridge operating a valve mechanism thus connecting them with the water system. Additionally, many of these rotary-installed cartridges disengage a water bypass by being installed such that water flows through manifold (receiver head) when the cartridge is removed. In this representative non-limiting embodiment, smart fluid treatment cartridge 2400 only moves in a linear relationship to its treatment cartridge receiver 2200. The removal or absence of the smart fluid treatment cartridge 2400 does not engage fluid flow nor does it allow for bypass flow. Instead, treatment cartridge receiver 2200, in such embodiments, uses a pair of check valve ports 2205 which may include a check valve port body 2205a, check valve 2205b, check valve spring 2205c, and check valve seal 2205d. Check valve ports 2205 may have a tube push-fitting 2205f (FIG. 52) to receive round plastic tubing water lines. Check valve ports 2205 fluidly attach to treatment cartridge receiver head 2201 port mounting face 2201l (FIG. 49) with port sealing surface 2201k (FIG. 49). Check valve seal 2205d seals fluid flow against check valve sealing surface 2201m (FIG. 49) when check valve 2205b is in its closed position. Both check valves 2205b are fully opened and in fluid flow communication when smart fluid treatment cartridge 2400 is installed, and both valves are closed with check valve springs 2205c when no cartridge is present, thereby preventing any fluid attempting to enter superstructure interior. Fluid communication is only allowed when smart fluid treatment cartridge 2400 is present. Check valves are actuated only by linear motion of the smart fluid treatment cartridge 2400.

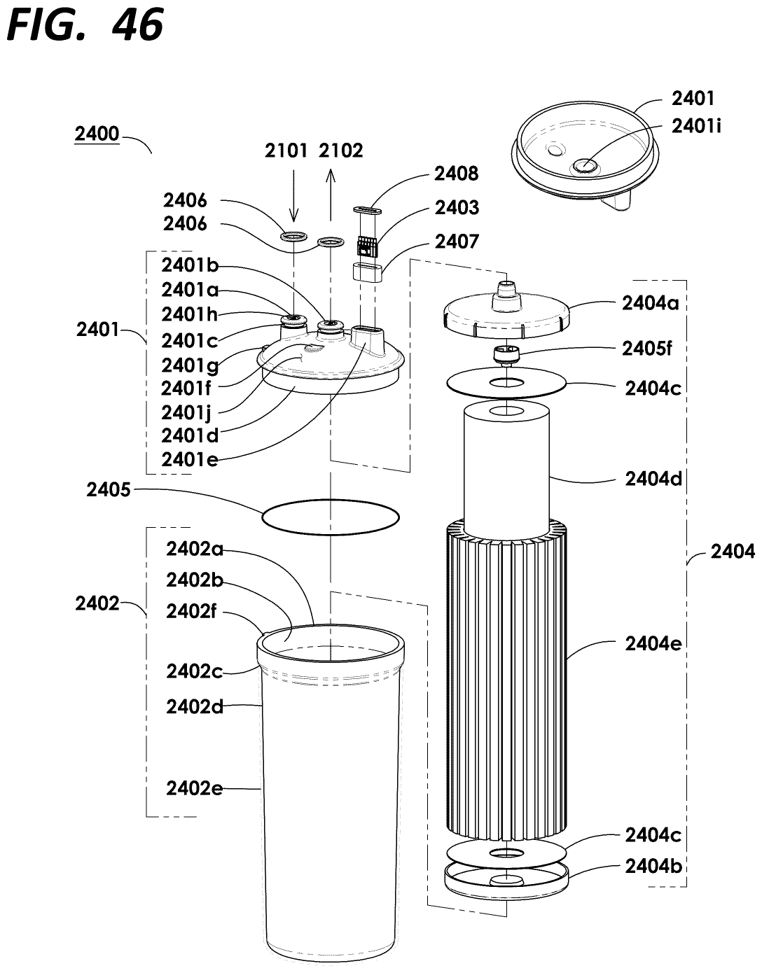

FIG. 41 shows a smart fluid treatment cartridge with a common 10″ carbon block typical treatment element 2404 according to some embodiments. The fluid flow path through the smart fluid treatment cartridge 2400 begins where it receives its fluid to be treated through the tapered inlet socket 2201n (FIG. 49) and enters the inlet plug for untreated fluid 2401a (FIG. 46). Leak tight sealing is accomplished via plug seals 2406. The fluid flows around the outside of the typical treatment element 2404 and fills the volume of the cartridge outside of the treatment element 2404. The untreated fluid then flows radially through the element wall of carbon block 2404d. As the fluid contacts the media in this embodiment, it is treated by way of chemical reduction to remove various organic contaminants.

The rate of water flowing through the media affects the contact time available for chemical activity. Longer contact times provide for more thorough chemical reduction. Generally, the more media available, the more capacity for treatment. The slower the flow rate, the greater the contact time. In some embodiments a media element with sufficient capacity and effective contact time may allow for a desired flow rate. Carbon blocks for water treatment are well known in the industry and have been highly developed for their use.

This smart fluid treatment cartridge 2400 according to some embodiments can provide a larger “dry-change” enclosure with lower-cost to use this 10″ carbon block technology by providing greater capacity with longer contact times as compared to a typical refrigerator carbon filter having only ¼ to ½ of the amount of carbon and flow water faster. As the water is treated through the media wall, it is collected in its center where it is pushed upward and outward through outlet plug for treated fluid 2401b (FIG. 46) and into tapered outlet socket 2201o (FIG. 49). Some embodiments may provide a particulate prefilter wrap 2404e to extend the life of a carbon treatment media. The typical treatment element 2404 is constructed as a cylindrical element from a matrix of carbon particles, polymers, and adsorbents, etc. It is understood that these typical carbon blocks require a means to stop the fluid from flowing through an open end. End cap, blind 2404b can be bonded to the media's distal end using a sealing adhesive 2404c. In like manner, the proximal end of the media block has end cap, outlet 2404a sealed with sealing adhesive 2404c. End cap, outlet 2404a has a fluid outlet plug which seals against treatment cartridge port 2401i. The leak-tight sealing of the typical treatment element 2404 to the treatment cartridge port 2401i can be achieved by gluing, bonding, elastomeric seal, welding, or friction.

It is anticipated that a wide variety of treatment elements be developed and utilized with this smart fluid treatment cartridge platform. It should be understood that it requires at least two flow paths to provide an inlet of untreated water and an outlet for treated water. It is also anticipated to provide an additional port to utilize technologies such as membrane filtration, including reverse osmosis. The addition of a third port provides for a backflow capability for rinsing, back washing, or other discharge.

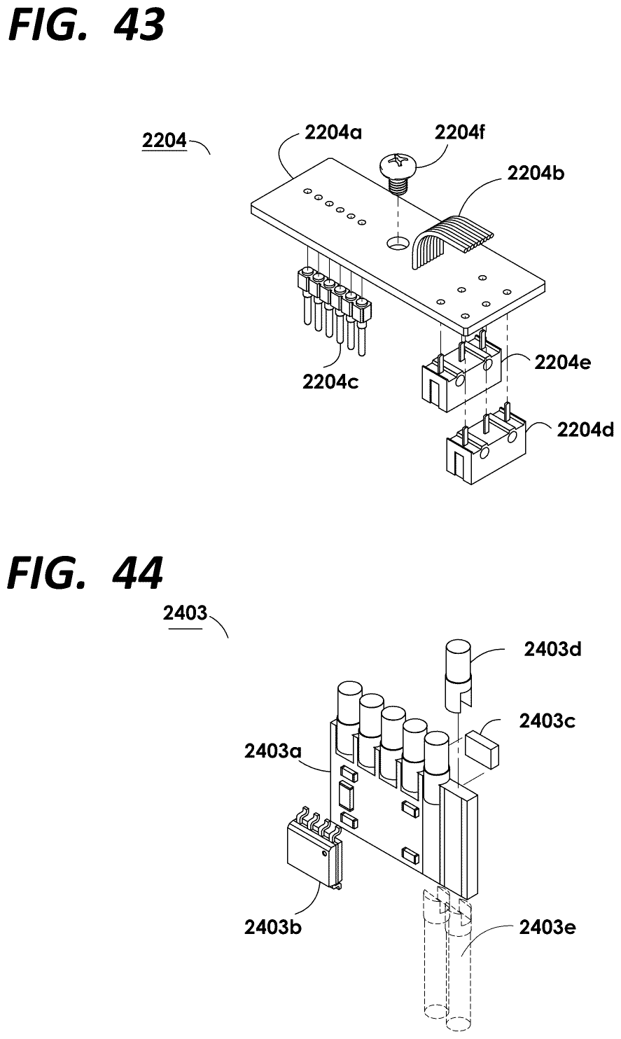

FIG. 41 also shows the circuit for the digital data communication according to some embodiments. Smart fluid treatment cartridge 2400 has a smart memory unit 2403, which can be affixed to the exterior of the treatment cartridge housing cap 2401. It is shown in this typical embodiment that smart memory unit 2403 can be enclosed in a smart memory unit receptacle 2401e (FIG. 46). The smart memory unit 2403 can fit inside this space and be sealed with a suitable material, such as an encapsulant 2407, which completely envelops the memory unit, such that it is rendered immune from corrosion or other detritus. Smart memory unit contact pin, external 2403d (FIG. 44) are positioned, in some embodiments to be easily accessible, yet above the possible water leaks which could cause short circuits or open circuits. A plurality of contact pin, external 2403d are used to provide both power and an effective read-write data path for digital data. Many different buss topographies and architectures exist to provide serial communication and it is intended to be able to accommodate any which may serve to be practical. In some embodiments, at least (3) physical conductors be used; two conductors to provide for electrical power and one conductor for data. It is shown here as a non-limiting example, that (6) conductors be provided to accomplish most all technical platform objectives; (4) for smart read-write memory communication, and (2) for use internal to the smart fluid treatment cartridge 2400, such that electrical power can be used for fluid treatment or fluid measurement technologies. It is also possible to use only (1) single conductor acting as a charged capacitor.

Examples of initial data stored in cartridge memory and readable by external memory controller may include but are not limited to:
a. Treatment cartridge identification;
b. Manufacturer information;
c. Date and time of manufacturer;
d. Treatment capacity;
e. Operating temperature range;
f. Operating pressure range;
g. Flow rate range;
h. Target treatment capability;
i. Serial or parallel flow preference; and/or
j. Position 1 or position 2 preference.

Examples of in-service data that can written to cartridge by an external memory controller may include but are not limited to:
a. Date entering service;
b. Time entering service;
c. Amount of treatment used;
d. Amount of time treatment is in service;
e. Coded fault conditions;
f. Flow rate history;
g. Temperature history;
h. Pressure history;
i. Date withdrawn from service;
j. ID of cartridge platform installed in; and/or
k. Internal treatment sensor performance parameters.

Smart fluid treatment cartridge 2400 of certain embodiments may employ a unique waterproof exterior designed to keep the typical treatment element 2404 enclosed in a hermetic housing. Housing cap 2401 and housing can 2402 may be constructed and joined together, such that their closure keeps the cartridge exterior dry, and the cartridge interior, with is spent media and potentially unsafe contaminants sealed, similar to typical dry-change cartridges. Housing cap 2401 and housing can 2402 can be formed from a variety of materials using numerus fabrication techniques. Particular interest is given to forming housing members from polyether terephthalate (PET), which can be both injection-molded, extrusion blow molded, and stretch blow-molded. PET is the most recycled plastic today and is GRAS (Generally Recognized As Safe) by FDA, TSCA (Toxic Substances Control Act), RoHS (Restriction of Hazardous Substances), REACH (Registration, Evaluation, Authorization and Restriction of Chemicals), DSL (Canada Domestic Substance List), IECSC (the Inventory of Existing Chemical Substances), KECI (Korea Existing Chemicals Inventory), and WGK (German water hazard class).

PET is widely used in the food and beverage industry to form containers for a wide variety of consumer products. PET lends itself to injection molding, extrusion blow molding, and reheat stretch blow molding. The reheat stretch blow molding process can produce an article with both thick and very thin uniform wall thicknesses with great strength, toughness, and optical clarity. Most plastic beverage containers today have wall thicknesses ranging from 0.004″ to 0.035″ produced from a blow molding process.

Since the smart fluid treatment cartridge 2400 of some embodiments is designed to be encased within a superstructure, the housing can be chosen to be as thin as possible borrowing its hydrostatic and hydrodynamic integrity from the superstructure. Cost and complexity within the superstructure are traded such that the replaceable cartridge can be constructed for the least cost, yet still enjoy dry-change advantages. Housing cap 2401 and housing can 2402 can be joined together after typical treatment element 2404 is installed. Housing cap 2401 and housing can 2402 each have large diameter openings to accommodate the treatment element and can be joined together using many methods such as but not limited to:
a. Spin welding;
b. Emabonding (radio frequency heating of metal);
c. Seam welding;
d. Hot plate welding;
e. Compression band, metallic or polymer (PEX);
f. Threads;
g. Bayonet tabs; and/or
h. Snap fits.

Regardless of the joining technique, in some embodiments it may be necessary to join the housing (cap and can) such that it does not leak during use in order to enjoy the benefits of dry-change cartridges.

For example, it is one focus of some embodiments to provide a smart fluid treatment cartridge 2400 sized to accommodate a typical 10″ wet-change carbon block commonly found in home building and hardware stores. A structural housing wet sump commonly sold for these wet-change carbon blocks can weight approximately 24 ounces, whereas a suitably stretch blow-molded housing for this thin-wall smart fluid treatment cartridge would weigh 3 to 4 ounces. The ratio of these weights is approximately 7:1. This weight ratio is predictive of the material required to produce a structurally acceptable “thick-wall” dry-change cartridge. These thick-wall dry-change cartridges are manufactured and sold today mostly for commercial applications as they are very expensive, not recycled, and burden the landfills. The cartridge in this disclosure uses a thin-wall housing to form the cartridge housing from variety of thermoforming processes. The housing cap 2401 can be molded from PET, but would not necessarily benefit from stretch blow molding in this example, as it can be injection molded with sufficiently thin walls initially without a reheat blow molding process. Given that the job of a thin-wall cap is only to provide minimal stiffness for handling and sealing members, it can also be of very low weight. Together, the housing cap 2401 and housing can 2402 provide for a leak-free hermetic closure sufficient to meet its structural demands when installed within a superstructure.

Housing cap 2401 or housing can 2402 of some embodiments may serve the additional purpose of providing a suitable moisture-excluding surface to contain the read-write memory 2403c (FIG. 44). If the authenticating mechanism was for example an RFID tag or wired IC tag, it would be difficult to attach said tag to a wet-change element. While there are water-proof RFID tags available, integrating an RFID tag within or onto a wet-change element would involve practical difficulties and issues with regards to regulatory compliance. Placing a memory device on the exterior of the smart fluid treatment cartridge 2400 may be practical in some embodiments with a thin-wall smart fluid treatment cartridge 2400. The use of external electrical contacts for a memory device with a dry-change cartridge requires that the contacts remain dry and clean. Electrical contact fouling can be mitigated in-part by keeping the contacts at ambient or warmer temperature to reduce or eliminate condensing humidity, positioning and shielding electrical contacts from leaking or spraying water, and even providing various air passageways in the receiver head 2201 to allow contacts to dry out and keep dry.

Receiver head 2201 and sump 2300 of some embodiments may not provide a hermetic closure, nor any leak-tight closure therebetween. The superstructure created by receiver head 2201 and sump 2300 need only prevent treatment cartridge housing from excessive expansion, such that rupturing and or leaking during pressure events is avoided. It should be understood that sufficiently small dry-change treatment cartridges can be made to easily handle the structural challenges of line pressure, such as in typical refrigerator filters and the like. However, as the system scale increases, or the size of the treatment element increases, it becomes increasingly cost-prohibitive to manufacture and change larger dry-change cartridges, such as, for example, restaurant, whole-house, industrial, etc. The larger the treatment element gets; the more likely wet-change elements are used. These larger treatment systems can benefit from using a superstructure to contain thin-walled dry-change treatment cartridges, which also provides a suitable mounting surface for a smart memory device.

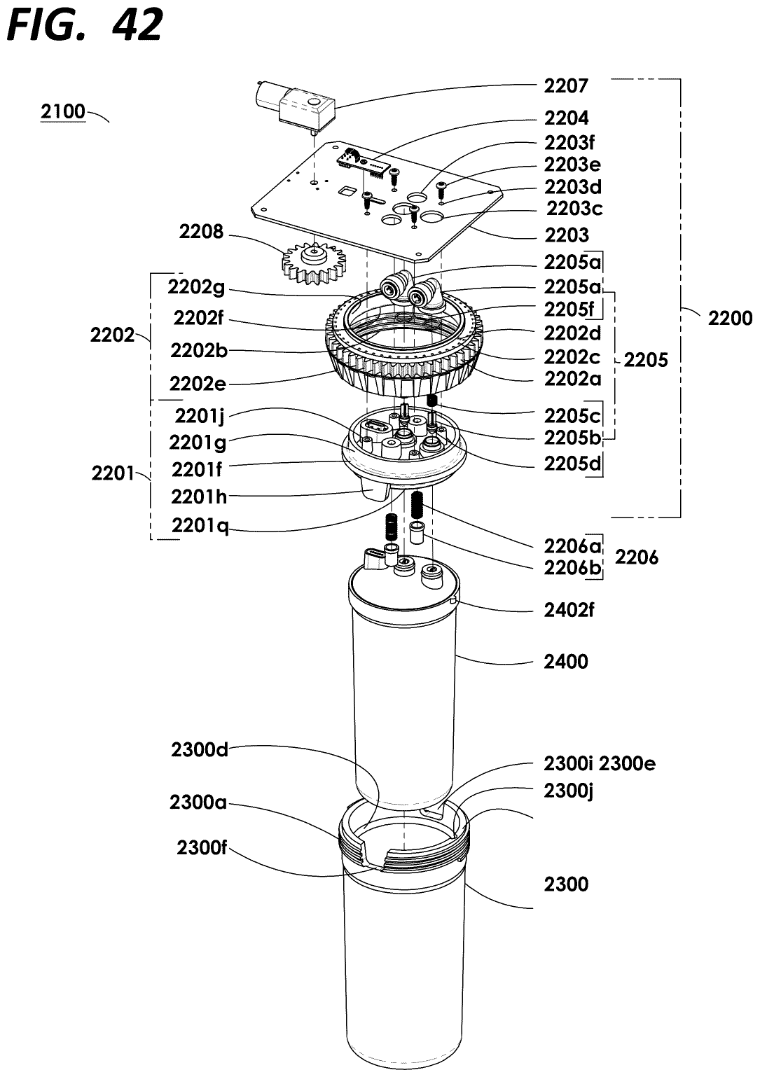

FIG. 42 illustrates a version of an embodiment of the treatment cartridge receiver 2200, which provides powered rotation of engagement collar 2202. Engagement collar 2202, in this embodiment, has engagement collar, torque member 2202a as a gear profile, such that it can be rotated via motor 2207 and pinion gear 2208. Motor 2207 can rotate clockwise (CW) for example, to provide torque to engage sump 2300, and counter-clockwise (CCW) to disengage sump 2300. Pinon gear teeth would mesh with sump engagement member 2300a respectively. A motor-driven engagement collar 2202 could have a means of providing rotational position information to an external motor controller. For example, timing cam surfaces 2202c could be used in conjunction with a microswitch encoder sensor 2204d (FIG. 43) to provide a pulsed output at similarly spaced intervals around the engagement collar 2202. In like manner, home cam surface 2202d could be used in conjunction with a microswitch home sensor 2204e (FIG. 43) to provide a pulsed output at engagement collar 2202 home position, for example. Other methods of rotational sensing can be used, such as, monitoring motor current, cams, linkages, proximity, hall effect, optical, and the like. The use of quadrature encoders can be used which can keep track of an absolute position and provide both direction and rotational position.

Engagement collar 2202 can be made from any desired material including metal and plastic, for example, sufficient for its structural requirement. It is so constructed to provide axial, anti-separation forces, such that the receiver head 2201 maintains intimate contact with sump 2300. More specifically, receiver head contact face 2201q would be held securely with sump contact face 2300j at all times when engagement collar 2202 engages receiver head 2201 with sump 2300. Engagement collar 2202 is held in tension when closed and smart fluid treatment cartridge 2400 is pressurized, thereby providing thrust to collar thrust face 2202f and head thrust face 2201f. Engagement collar 2202 does not need to provide a clamping force when closed unless smart fluid treatment cartridge 2400 is pressurized. For example, engagement collar 2202 can be rotated until its helical threads, or other engagement members, stop the rotation by hitting a travel stop. Said travel stop can prohibit any further rotation. Any further effort to continue to rotate the engagement collar 2202 would require full motor stall torque and full motor current without producing any additional rotation. At this full travel stop condition, engagement collar 2202 might remain slightly loose and not apply a fully intimate clamping force. The engagement collar 2202 would then be able to be easily by rotated in the opposite direction without having to overcome extreme frictional stiction cause by typical threaded tension forces.

In such embodiments, the engagement collar 2202 would easily counter-rotate to affect a disengagement when the treatment cartridge is depressurized or absent. It should be understood that smart fluid treatment cartridge 2400 housing will expand in all directions when pressurized. The expansion is normal and expected. The expansion of housing can 2402 of smart fluid treatment cartridge 2400 produces substantial separation forces between the receiver head 2201 and sump 2300. This places the engagement collar in considerable tension with large thrust forces on its bearing faces; head thrust face 2201f to collar thrust face 2202f, and correspondingly engagement collar, engagement member 2202b against engagement member 2300a. When smart fluid treatment cartridge 2400 housing is relieved of pressure it contracts, thereby removing the forces from the engagement collar 2202, and engagement collar 2202 becomes slightly loose once again, for easy counter rotation.

In some embodiments, concentricity between rotating member engagement collar 2202 and receiver head 2201 is maintained by collar journal face 2202g and head journal face 2201g. In some embodiments, receiver head 2201, engagement collar 2202, and sump 2300 are fabricated from materials selected to be strong and have favorable anti-frictional properties to allow smooth low-stiction rotation.

Some embodiments may have both the receiver head 2201 and sump 2300 both molded from a lower cost plastic. For example, choosing a different, perhaps more expensive material, for the engagement collar 2202, may mitigate sliding friction rather than using the same exact materials, as bearing them together inherently produces unwanted increased sliding friction. For example, receiver head 2201 and sump 2300 can each be molded from a glass-filled polypropylene (GFPP), while the providing various air passageways in the receiver head 2201 molded from polyphenylene oxide (Acetal). If there is a concern with the superstructure being exposed to freezing temperatures, it is important to select a polymer for the sump 2300 which has its glass transition temperature below that of freezing water, such as polybutylene, polyethylene, or a polymer such as polyethylene terephthalate (PET), which does not break from the expansion of water when frozen. Engagement collar 2202 can also experience significant hoop stress as it interfaces with sump 2300 and receiver head 2201 when smart treatment cartridge 2400 expands from water pressure. Engagement collar 2202 can be designed to accommodate radial expansion and even provide circumferential support to sump 2300 and receiver head 2201 when at pressure. Engagement collar 2202 can have features such as a thick wall, ribs, or even an integral metal sleeve or reinforcement band.

FIG. 42 shows the rotational alignment relationships of certain embodiments of the superstructure [sump 2300+receiver head 2201] and smart fluid treatment cartridge 2400. Smart fluid treatment cartridge 2400 can have an orientation reference indicator 2402f, which can assist the end user to correctly orient the smart fluid treatment cartridge 2400 inside the sump 2300. When orientation reference indicator 2402f is rotatably orientated to cartridge orientation indicator 2300e, the user is assured that the treatment cartridge can be fully seated downward within the sump and would thus allow the superstructure to be closed fully. If the smart fluid treatment cartridge 2400 is not fully seated downward within the sump, the engagement collar 2202b will be unable to engage the sump engagement member 2300a. During rotational engagement of the engagement collar 2202, when torque is applied to engagement collar torque member 2202a, the sump 2300 would be predisposed to rotation if it were not for the inclusion of at least one sump anti-torque wedge 2201h.

In some embodiments, sump anti-torque wedge 2201h is used to provide alignment to receiver head 2201 and ensures that when torque is applied to engagement collar torque member 2202a, the sump does not rotate and maintains rotational alignment with receiver head 2201. Sump anti-torque wedge 2201h contacts sump anti torque feature 2300f and maintains alignment independent of smart fluid treatment cartridge 2400 presence or absence. Sump anti-torque wedge 2201h makes interfering contact with sump contact face 2300j unless sump anti-torque wedge 2201h is oriented to align with sump anti torque feature 2300f. Smart fluid treatment cartridge 2400 does not make physical contact with receiver head 2201 until sump anti-torque wedge 2201h is oriented to align with sump anti torque feature 2300f and engagement collar 2202 is able to begin rotational engagement with sump 2300 engagement member 2300a.

The removal of smart fluid treatment cartridge 2400 when it is fully contained within sump 2300 is facilitated by the pair of cartridge access openings 2300i, which allow a convenient finger grab using a thumb and finger to grasp and withdrawal the cartridge. Other cartridge removal features can be used such as tabs, finger grabs, pulls, etc. If the sump 2300 is unconstrained, the sump 2300 can be simply turned upside down as desired.

FIGS. 39, 41, and 42 show an embodiment in which receiver head 2200 receives pressurized untreated fluid 2101 through untreated fluid line 2103 which is connectable to check valve port 2205 using tube push-fitting 2205f. In like manner, receiver head 2200 returns pressurized treated fluid 2102 through treated fluid line 2104 which is connectable to a second check valve port 2205 using tube push-fitting 2205f. Check valve port 2205 may include of its main check valve port body 2205a, which is conveniently provided with integral check valve 2205b, check valve spring 2205c, and check valve seal 2205d.

FIG. 49 shows that in some embodiments check valve ports 2205 can be mated to suitable sealing surfaces that direct and contain the fluid flow paths to correspond with the port sealing surface 2201k and port mounting face 2201l, appropriate to receiver head tapered inlet socket 2201n and tapered inlet socket 2201o. Check valve ports 2205, as shown in this embodiment, are free to rotate about receiver head port mounting face 2201l vertical axis to allow the most convenient alignment for untreated fluid line 2103 and treated fluid line 2104 routing. FIG. 49 shows greater detail for receiver head 2201, and it can be seen that the check valve has a corresponding check valve sealing surface 2201m, where the check valve can eliminate fluid flow into an empty sump when smart fluid treatment cartridge 2400 is absent. FIG. 46 shows check valve actuators 2401h, which serve to open the check valves by way of pushing against their tips as the smart fluid treatment cartridge 2400 is installed.

FIG. 42 shows an example of an embodiment of a mounting bracket 2203 (or plate or member) allowing receiver head 2201 to be fastened in relationship to a pitch circle relationship to pinion gear 2208 and engagement collar, engagement member 2202b (gear teeth). Mounting bracket 2203 can be fastened to receiver head 2201 by any convenient manner including snap clips, screws, welding, staking, etc. Mounting bracket 2203 is shown in this view as being in a form which has flat plate construction, in some embodiments aluminum or painted steel, for example, but can be any shape, material, or provide for any suitable attachment as desired. In such an embodiment, an aluminum flat plate mounting bracket 2203 has port retention holes 2203c which retain check valve ports 2205 captively under full pressure and are allowed freedom to rotate about their vertical axis. Mounting bracket 2203 head mounting fastener holes 2203d align with receiver head mounting bosses 2201j (FIG. 49) and mounting fasteners 2203e suitable for releasable, robust, connection as examples.

Smart electrical connector 2204 of some embodiments may be configured to provide electrical connection means to attach and detach at least one electrical circuit between an external source of electrical power 2106 and external read-write data path 2107, as shown in FIG. 39. FIG. 43 provides detail for an embodiment of a smart electrical connector 2204. Example smart electrical connector 2204 is shown constructed as a removable unitary element and can be removably fastened with a suitable fastener 2204f. Printed circuit board 2204a may provide a means to physically and electrically hold together elements; wire harness 2204b, electrical contacts 2204c, encoder sensor 2204d, and home sensor 2204e. Actual electrical contact is accomplished by conductive, spring-energized pogo-pins, or the like which provide reliable low-resistance electrical connections intended for repeated attachments and limiting corrosive contact degradation. In some embodiments, the contacts would be brass with gold-plating. It is another embodiment to construct mounting bracket 2203 as a fully molded plastic member with integral electrical contacts for example.

According to some embodiments, sensors such as a normally open microswitch, when fed a voltage, can return that voltage as a pulsed output each time it is actuated by the timing cam surfaces 2202c and home cam surface 2202d on the engagement collar 2202. Smart fluid treatment cartridge platform 2100 can be practiced by a manual sump connection or an automatic sump connection. Encoder sensor 2204d and home sensor 2204e are not required when used manually, and are optional if used automatically. Further, the function of encoder sensor 2204d and home sensor 2204e can be combined into a quadrature encoder system, an absolute encoder, or a wide variety of methods (analog resistance, motor current, switch, optical, magnetic, proximity, hall effect, etc.) to provide rotational feedback should an external controller be used for motor positioning. Wire harness 2204b is provided to enable treatment cartridge receiver 2200 to be connected to external source of electrical power 2106 and read-write data path 2107.

It should be understood that according to some embodiments, the smart fluid treatment cartridge platform 2100 can have a treatment cartridge receiver 2200 fitted with an integral battery to provide source of electrical power 2106 and be configured with an alternate means to connect smart fluid treatment cartridge platform 2100 to a read-write data path 2107 such as an optical or radio frequency data path. Bluetooth, Wi-Fi, NFC, are non-limiting examples of this type of interface. It is anticipated that smart fluid treatment cartridge platform 2100 will be connectable to the internet and internet of things (IoT). Wire harness 2204b requires at least (2) conductors to establish an electrical circuit, but is anticipated to be used with as many as 6 conductors or more. In the case where a security IC is used to authenticate, there are IC's capable of 1-wire bus communication using its on-board internal capacitor for power. Many other IC's have a 2-wire bus. Examples wire harness pin-outs may include:

### Manual Wire Harness 2204b;

a. Power;
b. Ground;
c. Serial bus communication;
d. Serial bus communication (optional);
e. Internal treatment;
f. Internal treatment;

### Automatic Wire Harness 2204b;

a. Power;
b. Ground;
c. Serial bus communication;
d. Serial bus communication (optional);
e. Internal treatment;
f. Internal treatment;
g. Timing sensor; and/or
h. Home sensor.

FIG. 44 depicts an exemplar smart memory unit 2403 with its main elements. PCB 2403a is used to provide support for electrical components, such as security element 2403b, read-write memory 2403c, contact pin, external 2403d, and can additionally include contact pin, internal 2403e. Smart memory unit 2403 can be further simplified and less expensive if consisting of only a small PBC, integral IC, and some potting material with via contacts as integral to the PCB. Smart memory unit 2403 is capable of read-write memory communication, containing information written during its manufacturing processes, and new information written during its fluid treatment usage.

FIG. 46 provides a representative example of a smart fluid treatment cartridge 2400 for use in a superstructure. Numerous other replaceable smart fluid treatment cartridge designs and purposes can be developed with similar fluid and electrical circuits using a housing capable of high-pressure structural integrity when supported by a superstructure. FIG. 46 shows only one basic smart fluid treatment cartridge 2400 with a carbon block 2404d. Further, it is anticipated that an additional fluid circuit be used when smart fluid treatment cartridge 2400 is used for membrane filtration, such as reverse osmosis (not shown). It should be known to one skilled in the art, that in certain embodiments, the male and female fluid circuit features can be reversed. It is intended that this disclosure be enabled to consider female sockets on the replaceable cartridge with corresponding male plugs on the mating receiver head or combinations thereof. FIG. 46 shows how a widely-used 10″ activated carbon chemical-reduction media can be used advantageously in the smart fluid treatment cartridge 400 disclosure. Smart fluid treatment cartridge 2400 may include of housing cap 2401, and housing can 2402, which when joined together provide for a hermetic closure to seal the treatment media, demonstrated in this embodiment as carbon block 2404d. Carbon block 2404d is widely used as a wet-change treatment element, and is typically provided with other elements to provide similar functionality as typical treatment element 2404. Typical treatment element 2404 is widely practiced today with end cap, outlet 2404a and end cap, blind 2404b, which are sealingly bonded to opposite ends of carbon block 2404d, thereby directing fluid to flow through the carbon block's cylindrical outer diameter surface, through its media wall, and collect within its center, being pushed out the end cap, outlet 2404a. In some disclosed embodiments, the disclosure of the smart fluid treatment cartridge 2400 uses a similar 10″ carbon block wet-change element and provides a light weight covering around it so as to keep users from any fluid contact during replacement. This lightweight covering herein described is the combination of joined housing cap 2401 to housing can 2402. Said housing is sufficiently lightweight, such that it is not able to provide any structural integrity sufficient to withstand high-pressure environments. Some embodiments may have the housing of a thickness that provides some firmness for handling during the manufacturing packaging process and user handling during cartridge replacement.

It should be understood that for this example embodiment, typical treatment element 2404 may include of a typical 10″ carbon block 2404d with typical said 10″ block being approximately 2.500″ in outer diameter. Given an outer pre-filter wrap 2404e thickness of approximately 0.500″, and end cap 2404b side wall thickness of 0.063″, the housing can 2402 should have a minimum internal diameter at least 3.500″. A minimum inner diameter of 3.700″ provides extra clearance to receive various similar typical treatment elements 2404.

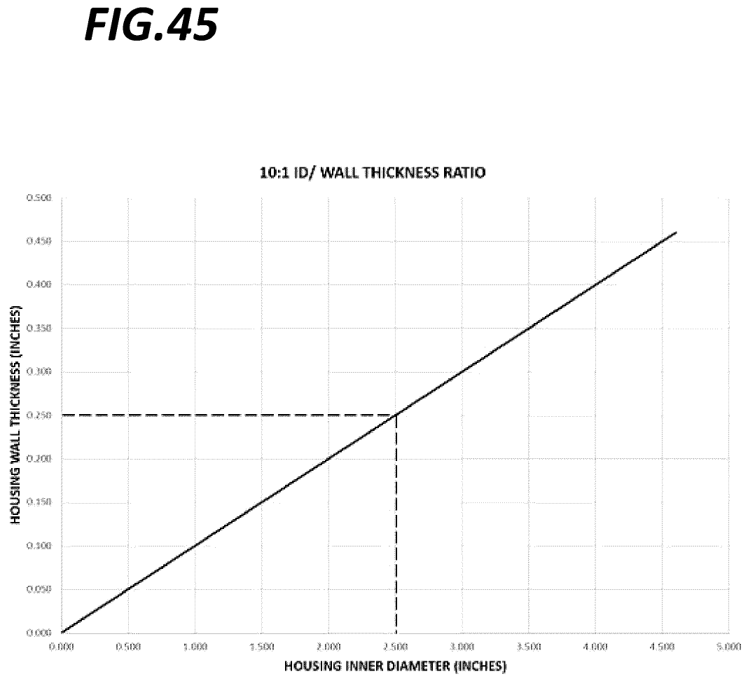

Typical dry-change cartridges that connect to the municipal water supply capable of meeting the NSF-42 standard for structural integrity are typically molded from a talc-filled polypropylene, or the like. These cartridges have an inner diameter (ID) to wall thickness ratio ranging from 9.3:1 to 12.5:1. Using a 10:1 ratio as an example, a 2.000″ ID cylindrical cartridge would have a 0.200″ wall thickness to provide enough strength to withstand 360 psi for 15 minutes and 480 psi minimum burst strength, while undergoing at least 10,000 cycles from 0-150 psi at ambient temperature. FIG. 45 depicts the ID and wall thickness relationship for structurally capable housings molded from polypropylene.

It can be seen in FIG. 45 that the thickness of a wall section increases as the cartridge diameter increases. The choice of material has a significant affect on this ratio, but it is common in the industry to provide plastic injection molded dry-change cartridges using this ratio for a 20% talc-filled polypropylene. The chart has dashed lines identifying a reasonable boundary such that when approached, the wall thickness plays a significant role in long molding cycle times, and correspondingly requires considerable amounts of plastic to be used, which is then discarded in a local landfill. Stating it in another way, small diameter housings can be molding quickly and use less plastic thereby being favorably used as thick-wall dry-change cartridges. Chart 4 tends to depict that the replaceable media used in water treatment becomes more likely to be wet-change when the housing requires a diameter approaching and greater than 2.500″. It is typical for dry-change cartridges to be injection molded. It is well understood that the cost increases with longer molding times where thick walls require extended molding times to allow for the molded part to cool enough before ejection, such that its shape doesn't sag or deform after cooling fully. There are many replaceable dry-change cartridges practicing the use of thick-wall housings being manufactured and in use today, but the thick wall sections add considerable cost and a waste of materials for the convenience of dry-change cartridges. If a dry-change cartridge housing were designed according to a diameter to wall thickness ratio of 10:1, a 3.700″ ID dry-change cartridge would require a 0.370″ housing wall section, being prohibitively expensive to manufacture and wasteful to discard.

Thin-walled plastic housings can be produced by a variety of methods, such as, injection molding, blow molding, vacuum forming, pressure forming, extruding, and so forth. Each process has it advantages and disadvantages. For example, injection molding produces very accurate geometry with different wall thickness, but has difficulty providing for thick walls with sufficiently large area thin walled sections. It is not reliably practical to mold a plastic bag, for example, by injection molding. Vacuum forming of suitably thin sheets of plastic provide for various thin-walled articles, but these articles normally do not have regions with thicker wall-sections. Blow molding provides for many types of bottles with suitably thin walls, and even threaded portions, such as milk jugs and gas cans. The region with the threaded portion is of a mostly uniform thickness as the extruded parison wall is blown into the threaded mold shape, leaving behind a rolled interior wall. The process of stretch blow molding combines the best of both injection molding and blow molding into a 2-step process. A typical beverage bottle is stretch blow molded today for these reasons, and is arguably the lowest cost manufacturing method used when robust threaded connections are used.

Two step Stretch Blow Molding steps typically include injection molding a preform (aka. parison), and then the preform is reheated and blow molded into final hollow shape.

There are a variety of stretch blow molding processes in use today, which initially injection mold a preform, and subsequentially blow that preform into its final shape. These processes include variations that pre-stretch the preform axially and then blow them radially (biaxial stretching), or transferring the hot injection molded preform to a blow-molding tool and blow them immediately without reheat. The 2-step reheat biaxial process produces the lowest cost part with the strongest and thinnest walls.

The actual molded thickness of the housing can 2402 is chosen to provide the minimal handling strength for manufacturing methods and sufficient for the end user to hold and replace. In this representative embodiment, it is considered that 0.020″ is an acceptable guideline but thicker or thinner is also anticipated and can be used to enjoy the low cost and minimal impact to the environment. For example, a wall thickness of 0.004″ can be used for a water bottle, but has a squishy feel and can be easily bent when the water is emptied out. A large-mouth jar can have a wall section of 0.010″ to 0.020″ thick and becomes rather strong feeling when handled. If we take the example of a 3.700″ ID housing and mold it with a 0.020″ wall, we get a diameter to wall ratio of 185:1.

CHART 4

| ID (inch) | Wall Thickness (inch) | Weight (lb.) | ID to Wall Ratio |
|---|---|---|---|
| 3.700 | 0.050 | 0.391 | 74.0 |
| 3.700 | 0.040 | 0.335 | 92.5 |
| 3.700 | 0.030 | 0.287 | 123.3 |
| 3.700 | 0.020 | 0.225 | 185.0 |
| 3.700 | 0.010 | 0.171 | 370.0 |
| 3.700 | 0.370 | 2.536 | 10.0 |

Chart 4 shows the relationship between the majority portion wall thickness, housing weight, and ID to wall thickness ratio. Chart 4 data has housing 2402 with the same thick wall threaded portion. As shown, a 3.700″ ID housing with a 0.020″ thick wall is 18.5 times thinner than the same thick-walled housing. It may be that a wall thickness of 0.010″ will suffice for the housing can once installed in its super structure. A 0.020″ thick housing only saves 0.054 lbs., whereas the majority savings comes from comparing the 2.536 lb. thick wall dry-change equivalent housing. The weight savings from a traditional thick-wall dry-change cartridge to this thin-wall cartridge requiring a superstructure, is 2.311 lbs. In other words, you could mold approximately 11 thin-walled housings for every single thick-walled one.

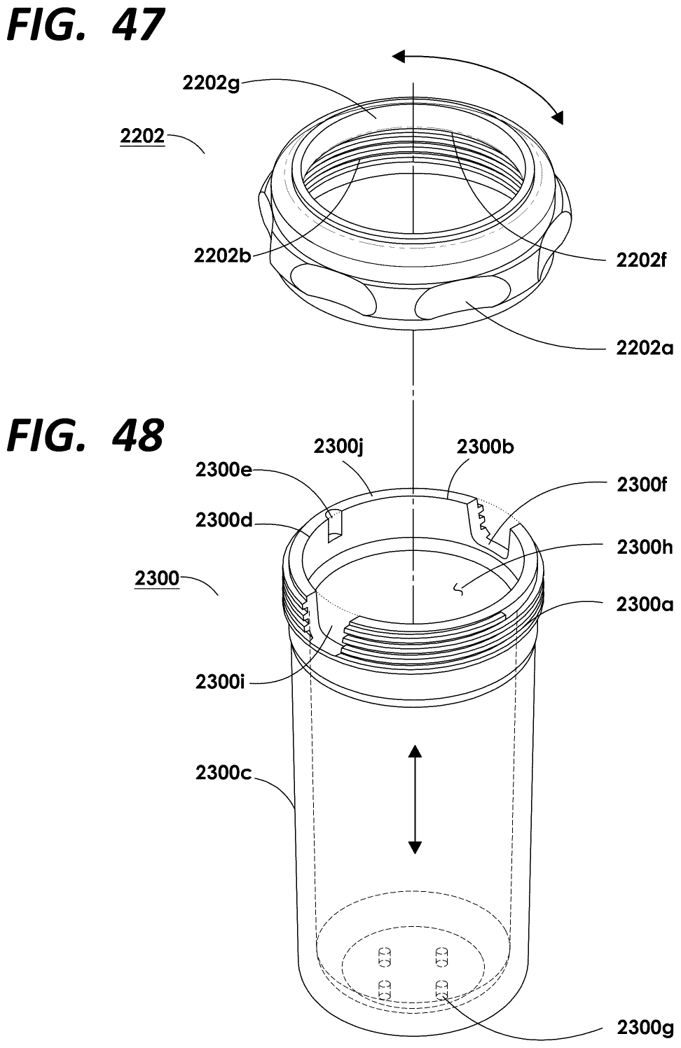

The thin-wall housing can 2402 according to some embodiments is shown in FIG. 46 with an exterior surface 2402e, which will expand under water pressure until it becomes intimate with sump interior surface 2300h as shown in FIG. 48. The housing can 2402 has treatment element opening 2402a large enough to allow typical treatment element 2404 to be installed. Cap sealing connection 2402b interfaces with can sealing connection 2401d to form a tight leak-free connection. The connection can be made by any manner of clamping, welding, friction, threading, etc., or any other manufacturing process as desired. Spin welding is commonly used when joining dry-change cartridge members and can be used for thin-wall dry-change housings if there is sufficient wall thickness at the spin-weld joint portion. Further, housing sealing element 2405 can be optionally used to affect a hermetic seal in the event the joint is non-welded, for example. Housing sealing element 2405 can include an O-ring, adhesive, caulking, rib, or other elements which provide sealing properties, particularly when the joined housing is at full system pressure and when undergoing structural testing.

In some embodiments, the smart fluid treatment cartridge 2400 is placed into sump 2300 with its cartridge bearing surface 2402c resting on the sump cartridge bearing surface 2300d (FIG. 48). Housing can 2402 has thin-wall portion 2402d, which may include the majority of housing can 2402 surface area. Thin-wall portion 2402d is designed to expand and contract due to fluid pressure changes and receives its ultimate structural performance only when expanded to be intimate with sump interior surface 2300h. Housing cap 2401 is used to seal the large opening of housing can 2402 and provide the necessary connections for the fluid and/or communication circuit. Housing cap 2401 is illustrated to have at least two male connections, such as inlet plug for untreated fluid 2401a, and outlet plug for treated fluid 2401b as shown, capable to be fluidly connected with pressurized untreated fluid 2101 from treatment cartridge receiver 2200 and return pressurized treated fluid 2102 back to treatment cartridge receiver 2200. It is possible to have coaxial or triaxial structures for connection to the fluid; male, female, round, elliptical, and the like as desired. Variations of the thin-walled treatment cartridge can be used with membranes, such as reverse osmosis treatment elements, which may require a third fluid connection for concentrate, etc.

FIG. 46 shows an embodiment that has housing cap 2401 with external plug seal 2406 being used with plug sealing surfaces 2401c to provide fresh seals with each replacement cartridge. Plug seal 2406 is anticipated to be a typical O-ring, but can be any shape, such as lip, u-cup, quad ring, square, etc., and can be any material such as Buna-n, silicone, Viton, EPDM, perfluoroelastomers (FKM), and as so forth. Proper material selection can reduce stiction and reduce the forces required to install and remove the smart fluid treatment cartridge 2400 when undergoing replacement. Surface treatments, such as silicone, Teflon, and Parylene are also non-limiting examples in reducing friction and stiction.

According to some embodiments, the housing cap 2401 has integral check valve actuators 2401h which interact with the check valves 2205b to open them during the last small increment of installation. Check valve actuators 2401h are integrally formed within the fluid passageway of inlet plug for untreated fluid 2401a and outlet plug for treated fluid 2401b to push on the check valve. Housing cap 2401 can have at least one surface, such as eject pad 2401f, intended to be used to self-eject the smart fluid treatment cartridge 2400 when the superstructure is opened. Eject pad 2401f has a surface shape to cooperate with eject plunger 2206b (FIG. 42). Housing cap 2401 may have a reference feature 2401g, which can assist with orientation of the smart fluid treatment cartridge 2400 and sump 2300 cartridge orientation indicator 2300e. Reference feature 2401g can be a molded element or a colored item, such as paint, sticker, label, molded feature, arrow, etc. Housing cap 2401 can have external threads, for example, on can sealing connection 2401d area, or be provided with a suitable surface structure geometry for spin welding, or other joining methods well known in the industry.

The most common joining method for a dry-change cartridge is spin welding, which requires similar polymers, allowing them to melt and stick together with rotational friction. Its arguably the lowest cost method and works well for cylindrical shapes which have a minimum thickness to allow for the required spin welding torque. Some embodiments may provide at least one feature which can receive the torque necessary for spin welding. Optionally, housing cap 2401 may be threaded together using an elastomeric seal or the like. There can be concern regarding a threaded together connection for dry-change cartridges, such that they do not unwantedly disassemble when rotationally removed. In this disclosure, smart fluid treatment cartridge 2400 is not rotated with respect to the receiver head and therefore will not experience anti-rotational torques during its installation or removal from the receiver head 2201. In some embodiments, if threading were the method to securely join housing cap 2401 with housing can 2402, the threaded joint is entirely constrained between the receiver head housing cap shoulder 2201r (FIG. 49) and cartridge bearing surface 2300d (FIG. 48). Further, loads arising from increasing water pressure cause the housing cap 2401 to expand, thereby compressing housing sealing element 2405 against housing can 2402.

FIG. 46 shows a raised portion of housing cap 2401 smart memory unit receptacle 2401e according to some embodiments, which serves to provide a mounting provision for smart memory unit 2403. Smart memory unit 2403 can be fitted within the smart memory unit receptacle and then sealed with encapsulant 2407, which fully envelopes the smart memory unit 2403, excluding the exposed contact pins, external 2403d. Receptacle cover 2408 provides a clean covering keeping any encapsulant from spilling during assembly. While it is anticipated that smart memory unit receptacle 2401e can be placed anywhere on the smart fluid treatment cartridge 2400, in some embodiments it may be located in a position which is not easily affected by corrosion or moisture, as it can affect the ability of the memory to communicate without error. When a device, such as a water device, is located within a warm humid environment, and that water device is connected to a source of cooler water, the device can become cooler than the environment causing the humidity to condense and wet the device's surface. In the case of a water filter, the surface of said filter can become moist if it is sufficiently cooler than ambient in a humid environment.

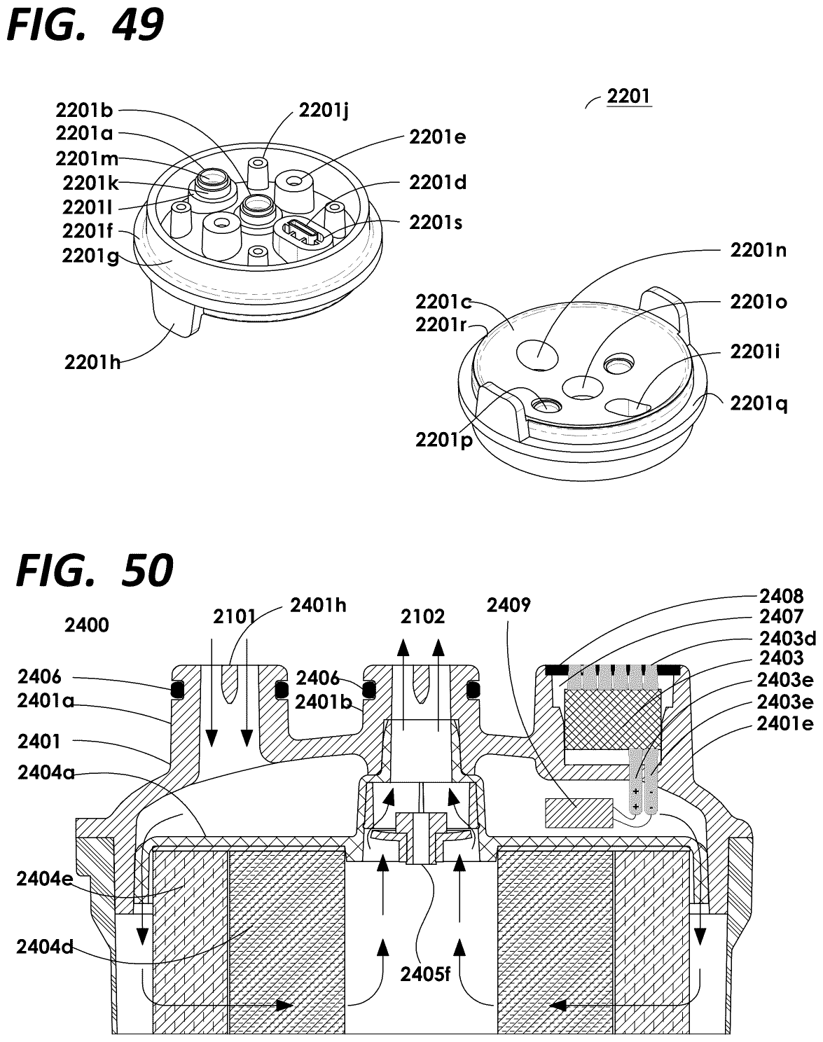

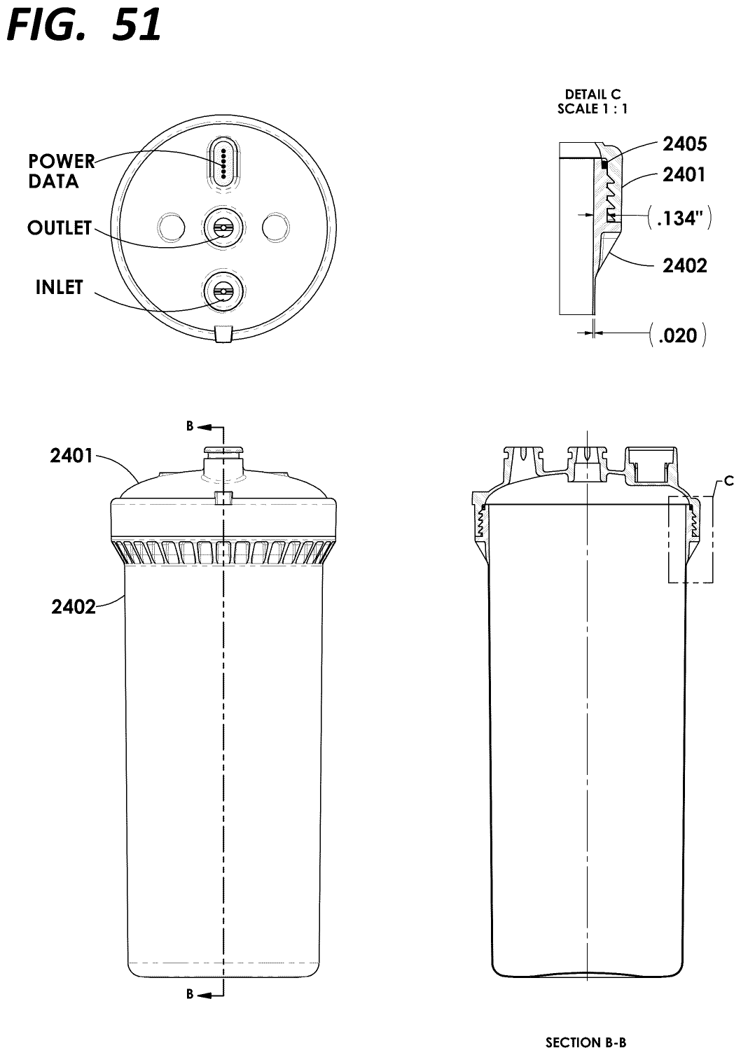

If smart memory unit 2403 is located on a portion of the treatment cartridge that becomes cold, it can get fouled or corroded by moisture. The placement of smart memory unit 2403, in such embodiments, is at the highest possible location and separated by a thermal barrier to assist in keeping smart memory unit 2403 closer to ambient temperatures. FIG. 50 shows the smart memory unit 2403 contact pin, external 2403d being at its furthest distance from a potential cold region, and at its highest location when installed in operating orientation. Additionally, receiver head electrical contact socket 2201i (FIG. 49) can have a wiper or sealing member, such that the contact pin, external 2403d is sealably removed from the untreated fluid inlet port 2201a and treated fluid inlet port 2201b to eliminate any drips or sprays of water impinging upon the contact pin, external 2403d. Finally, the receiver head electrical pin apertures 2201d can be associated with additional electrical contact vents 2201s to provide ambient air to keep the contact pin, external 2403d dry while in service.

FIG. 47 shows greater detail of the engagement collar 2202 according to some embodiments. In this embodiment, the engagement collar may be used for manual rotation with its engagement collar torque member 2202a configured as finger grips. Engagement collar 2202 is also shown as having a series of helical threads such as acme type threads, though many thread designs or assembly techniques will work. In one example, engagement collar 2202 could have (3) full revolutions of 0.250″ pitch threads as engagement collar, engagement member 2202b. In this configuration, engagement collar 2202 would have (3) threads fully in contact with sump engagement member 2300a threads. It would also follow, that during three full rotations, the engagement collar 2202 would pull sump 2300 upward 0.750″ into secure connection. When engagement collar 2202 fully secures receiver head 2201 with sump 2300, the combination produces a superstructure. Said superstructure being sufficiently robust to provide the necessary support for the thin-walled smart fluid treatment cartridge 2400 to comply with NSF-42 structural standards or the like. It is understood that one skilled in the art would also consider a variety of engagement collar, engagement member 2202b types such as, but not limited to, bayonet tabs, breach threads, cams, and or an interrupted thread as shown in FIG. 53.

In some embodiments, a two-stage thread or tab arrangement can be used, allowing for a safe disconnect under pressure, keeping the sump structurally attached yet allowing the smart fluid treatment cartridge 2400 to detach a small amount sufficient to release any entrapped water pressure. Once the pressure is relieved, further rotation could release the engagement collar 2202 from the sump 2300 entirely. Collar thrust face 2202f bears against receiver head thrust face 2201f and imparts any tension forces within engagement collar 2202 into thrust forces upon these faces, and equally and conversely upon the engagement collar, engagement member 2202b and corresponding sump engagement member 2300a (FIGS. 47-48). Careful design of the engagement member contact faces limits any angular or sloped faces on the sump and collar that will reduce the likelihood of separation forces attempting to jump the members. For example, square and buttress threads provide nearly parallel contact faces (best), which do not promote expansion or jumping when under tension, as compared to 29-degree acme, 30-degree ISO trapezoidal (better), or 60 degree American national and unified (worst). Collar journal face 2202g provides concentric alignment with receiver head journal face 2201g. Engagement collar 2202 is subject to large forces. For example, assuming sump 2300 has an opening of 3.700″ and is required to instantaneously handle 480 psi, the engagement collar is subject to contain 5150 pounds of tension. While this force appears rather high, the entire superstructure must be designed to withstand this type of stress when considering 480 pounds for every square inch of surface area. A plastic molded engagement collar 2202 may be reinforced with a metallic band, such as stainless steel, to provide greater hoop-strength and resistance to stress cracking over time.

FIG. 48 shows the corresponding sump 2300 with its sump engagement member 2300a, sump opening 2300b sufficiently sized to contain smart fluid treatment cartridge 2400, and sump wall 2300c according to some embodiments. Sump wall is designed to easily withstand at least four times labeled water pressure. Four times the 120-psi label pressure equates to 480 psi for design pressure. Engagement collar 2202 and Sump 2300 can be constructed of metal or plastic, for example. Aluminum, steel, and stainless steel, drawn, formed, cast, or forged and machined are certain processes to consider. In some embodiments, sump 2300 can be molded from many different polymers, such as, but not limited to, polypropylene (PP), nylon (PA), polyphenylene oxide (PPO), acetal (POM), polyester (PET), polyethylene (PE), cross-linked polyethylene (PEX), acrylonitrile butadiene styrene (ABS), poly carbonate (PC), Isoplast (ETP), and the like. Some embodiments may choose a different material for the mating engagement collar 2202 as compared to sump 2300 to reduce or eliminate stiction or galling on their mating surfaces. Also, selecting a material that will expand nearly 10% without fracturing is necessary if accidental freezing will be anticipated. Possible choices for cartridge freeze tolerance are PE olefins, PET, and PC. Polypropylene resin can be modified by metallocene to provide resistance to cracking during freezing. Another option is polyethylene-octene and polypropylene-octene, which have adequate elongation at or below freezing temperatures. Metal sumps are not recommended for use outdoors as the treatment cartridge may freeze and expand the sump. For example, a sump of copper or aluminum may be able to stretch enough not to fracture the first time it is solidly frozen, but each subsequent time it is frozen, it stretches a further amount until it fractures, as the metal will not fully recover to its original shape when stretched during a freezing event. Sump wall 2300c is sized to be suitably thick such that it can handle the hoop stresses when the smart fluid treatment cartridge is pressurized to 480 psi minimum and requires a wall thickness approaching or exceeding the 10:1 ID to wall thickness ratio for injection molded polymers.

In some embodiments, cartridge bearing surface 2300d serves to support the smart fluid treatment cartridge, such that the housing can 2402 bottom may remain unsupported if desired, allowing room for clearance and/or expansion. When sump 2300 is in secured engagement with receiver head 2201, cartridge bearing surface 2300d and housing cap shoulder 2201r (FIG. 49) form a closure around the treatment cartridge joint keeping it from expansion or other uncontrolled deformation while under pressure. Cartridge bearing surface 2300d contacts the cartridge housing sealing joint where its manufacturing critical tolerances can be controlled accurately from the injection molding process. The use of other thermoforming processes may result in tolerances which are difficult to control, which may affect the housing joint diameter. If housing joint diameter is small, it may allow too much expansion causing leaks and failures. If housing joint diameter is large, it may jam into sump 2300.

In some embodiments, cartridge orientation indicator 2300e can be used to ensure that the treatment cartridge is oriented correctly within the sump. Cartridge orientation indicator 2300e can be a molded feature, a colored mark, or other identifying element. Sump interior surface 2300h becomes intimate with exterior surface 2402e (FIG. 46) when under operational pressure. It might be advantageous to provide texturing, splines, or other features that allow leaking or condensed water to flow in-between the sump interior surface 2300h and cartridge exterior surface 2402e at service pressures, such that cartridge exterior surface 2402e does not blind off or entirely seal minute flow paths. The allowance of leaking or condensed water, which is permitted to flow in-between the sump interior surface 2300h and cartridge exterior surface 2402e, can be directed to migrate to the bottom of the sump and exit through leak aperture 2300g.

FIG. 49 shows detail for receiver head 2201 which may be molded from the same material as sump 2300 according to some embodiments. Untreated fluid inlet port 2201a connects with corresponding tapered inlet socket 2201n and directs pressurized untreated fluid 2101 therethrough. In like manner, treated fluid outlet port 2201b connects with corresponding tapered outlet socket 2201o and directs pressurized treated fluid 2102 therethrough. Cartridge contact face 2201c provides a geometry correspondingly compatible to support housing cap surface exterior 2401j (FIG. 46) while at pressure. Electrical pin apertures 2201d provide support structure for the electrical connection means, such as, but not limited to, pogo pins, contacts, magnets, springs, etc. Electrical pin apertures 2201d can increase pin robustness while providing precision pin location. Cartridge ejector aperture 2201e provides an external access to assist with ejecting a treatment cartridge which has become stuck. Cartridge ejector aperture 2201e can also provide a visual indication if a treatment cartridge is installed or not. Collar thrust face 2202f (FIG. 47) bears against receiver head thrust face 2201f to keep receiver head contact face 2201q securely attached to sump contact face 2300j. Head journal face 2201g keeps concentric alignment along a vertical cylindrical axis corresponding with engagement collar journal face 2202g (FIG. 47). Sump anti-torque wedge 2201h is provided to maintain rotational orientation between sump 2300 and receiver head 2201 during the connection and disconnection process. Sump anti-torque wedge 2201h is any feature, male or female, that can be receivably engaged to maintain rotational orientation, before engagement members can interact.

According to some embodiments, the electrical contact socket 2201i receives the treatment cartridge smart memory unit receptacle 2401e, and provides enclosure to align, protect, and even seal against damage, moisture, spraying water, and the like. Electrical contact socket 2201i may be associated with electrical contact vents 2201s to provide access to dry ambient air, which can help keep electrical contacts 2204c at ambient temperatures, even when treatment cartridge is operating with cold water. Mounting bosses 2201j provide secure anchor features for alignment and to receive suitable fasteners 2203d (FIG. 42). Mounting bosses 2201j can be other features, such as integral snap-fit members, or can interact with clips, pins, or other detachable fastening means. In this embodiment as shown, mounting bosses 2201j should be sized to hold the mounting bracket 2203 securely to receiver head 2201, such that check valve ports 2205 remain sealed and constrained as shown in FIG. 42. For example, if check valve port 2205 has a 0.700″ connection diameter, valve port 2205 can see 45 lbs. thrust force at service pressure.

Some embodiments include (4) head mounting fasteners 2203e, each needing to provide at least 12 lbs. tensile force when fully tightened, and 48 lbs. force each at burst pressures. Port sealing surface 2201k provides a surface to create a radial seal with check valve port seal 2205e (FIG. 41). Port mounting face 2201l provides a mounting face to support the check valve port 2205, wherein check valve port 2205 mounting flange is sandwiched between mounting plate 2203 and port sealing surface 2201k. Check valve sealing surface 2201m is integrally provided to seal against check valve seal 2205d when biased closed via check valve spring 2205c. Check valve seal 2205d may be elastic, such as an O-ring to securely seal against imperfect surfaces and debris. Tapered inlet socket 2201n and tapered outlet socket 2201o each receive the treatment cartridge inlet plug for untreated fluid 2401a and outlet plug for treated fluid 2401b respectively. Said sockets may be tapered providing necessary draft to assist with injection molding, and tapering provides a funnel shape to easily receive the cartridge plugs with associated plug seals 2406. The taper provides a larger opening initially, providing easy mating location, and allows the seal compression to be gradual over the length of the bore, increasingly tightening until the last increment of motion provides the effective compression to affect a leak-tight seal. Conversely, the removal of the smart fluid treatment cartridge 400, during disconnection, provides a very short distance in which the plug seals 406 are fully in sealing compression, and further, gradual, removal expands the seal rapidly with little or no friction.

In some embodiments, the sockets may be molded with smooth sealing surfaces to promote secure sealing, and to limit surface irregularities which promote O-ring stiction that can develop over time. Eject plunger aperture 2201p provides an integral structure to enclose and guide cartridge ejector 2206 (FIG. 42), which is energized during its compression during installation, and stays in an energized state during service. When engagement collar 2202 is rotated and sump 2300 is released, cartridge ejector 2206 expands, placing a force against the treatment cartridge eject pads 2401f, thereby breaking any stiction, forcibly pushing the treatment cartridge away from the receiver head, and disconnecting both the fluid and electrical circuits. As the treatment cartridge is released, the check valves 2205b are closed by springs 2205c to seal off both fluid conduits. Monitoring the data communication 2107 or power connection 2106 provides certain feedback that a treatment cartridge is operatively installed or fluidly and electrically removed.

Referring to FIG. 50, the smart fluid treatment cartridge 2400 according to some embodiments is shown sectioned across its fluid and electrical ports. It can be seen from the figure that pressurized untreated fluid 2101 flows around check valve actuator 2401h, into inlet plug for untreated fluid 2401a and inside the housing cap 2401, where it flows around the end cap, outlet 2404a, and permeates around and through prefilter wrap 2404e and carbon block 2404d. As the pressurized untreated fluid 2101 flows through the typical treatment element 2404, it is treated and becomes pressurized treated fluid 2102 flowing towards the center, moving upward and through outlet plug for treated fluid 2401b. In some embodiments, flow restrictor 2405f is operatively installed, such that the rate of fluid being treated is modulated to a design flow rate. Said flow restrictor 2405f being so configured as to ensure a design flow rate throughout a wide range of pressures. Said flow restrictor 2405f ensures that the treatment being desired is not being rushed or too fast to have its fullest effect. Said flow restrictor 2405f being unique and configured for each type of treatment cartridge application and technology.

FIG. 50 also shows smart memory unit 2403 according to some embodiments being contained within smart memory unit receptacle 2401e encapsulated by encapsulant 2407 with receptacle cover 2408. Smart memory unit 2403 having its contact pin, external 2403d communicating with the receiver head 2200. In addition, smart memory unit 2403 is shown with at least one contact pin, internal 2403e penetrating within the wetted interior volume of the smart fluid treatment cartridge 2400, such that it can carry either power, data, or another electrical field. For example, contact pin, internal 2404e can be connected to internal electrical device 2409, such as a performance sensor. Examples of performance sensors can be, at least, but not limited to, lead sensor, pH sensor, PFAS sensor, etc. It is anticipated that performance sensors may become able to detect very small amounts of key water properties, such as lead in ppb, and PFAS in ppt, yet require replacement with every treatment cartridge. Other internal electrical device 2409 elements can be integrated within the treatment cartridge to augment the treatment process by boosting media electrical charge, reverse plating, or electrolytically evolving gaseous species. The capability of the treatment cartridge is therefore unlimited in scope or technology.

FIG. 51 shows a representative stretch blow molded embodiment of the smart fluid treatment cartridge 2400 in three views, including a section view of a threaded joint. Housing cap 2401 is securely joined to housing can 2402 with a helical thread, such as, but not limited to, a buttress type thread profile. The housing can 2402 is formed from plastic, such that it includes a majority thin-wall portion and a thicker joint portion, which has helical threads. For this example, we can choose the same internal diameter to be 3.700″ as in the other examples. The wall section of the majority thin-wall portion ranges from 0.005″ to 0.0625″ in thickness, while the joining wall section ranges from 0.063″ to 0.200″ in thickness. In some embodiments, majority thin-wall portion wall section ranges from 0.010″ to 0.030″ in thickness, and the joining wall section ranges from 0.063″ to 0.125″ in thickness. The ratio of housing can 2402 wall section thicknesses ranges from 40:1 to 1:1.

For example, an extrusion blow molded HDPE housing could retain a 1/16″ thick constant wall section throughout, whereas a stretch blow molded housing could have a variable wall section thickness as thin as 0.005″ thick to 0.250″ thick. Some embodiments may reduce the thickness of the joint section closer to 0.125″ to save space and material. Using a majority wall section of 0.020″ and a joint thickness of 125″ yields a wall section ratio of 6.25:1. Normally, injection molding is restricted to similarly thick wall sections throughout the part design. It is common to have a majority wall thickness of 0.100″ for example, and then have other features such as ribs at 0.050″ thickness for example, yielding a ratio of 2:1. To put this in context, injection molding a housing can 2402 could have a joint section thickness of 0.125″, for example, and the majority thin-wall portion being 0.063″ thick. Typically, injection molding has a limit of 200:1 flow length to wall thickness ratio. This means for a typical 10″ tall cartridge, the minimum wall thickness would be at least 0.050″.

Additionally, it is common knowledge that ribs, or thin wall sections in this case, are to be no less than 50-60% the thickness of the thick wall areas, though 30-70% is achievable. This means that for a 10″ tall cartridge using the minimum wall thickness of 0.050″, and the minimum rib percentage of 30%, the thickest achievable wall section would be 0.167″, yielding a ratio of 3.33:1. A more reasonable injection molding scenario would allow for 150:1 flow length to wall thickness and 55% rib thickness ratio making for a cartridge with a thin wall of 0.067″ and a thick wall section of 0.121″, yielding a ratio of 1.82:1. An injection molded housing can 2402 can successfully be used to practice this disclosure, but it will use more raw materials than necessary and be difficult to control the injection molding process over the entire thin-wall portion, producing such things as sinks, cosmetic lines, poorly bonded knit lines, short shots, burned plastic, and cloudiness.

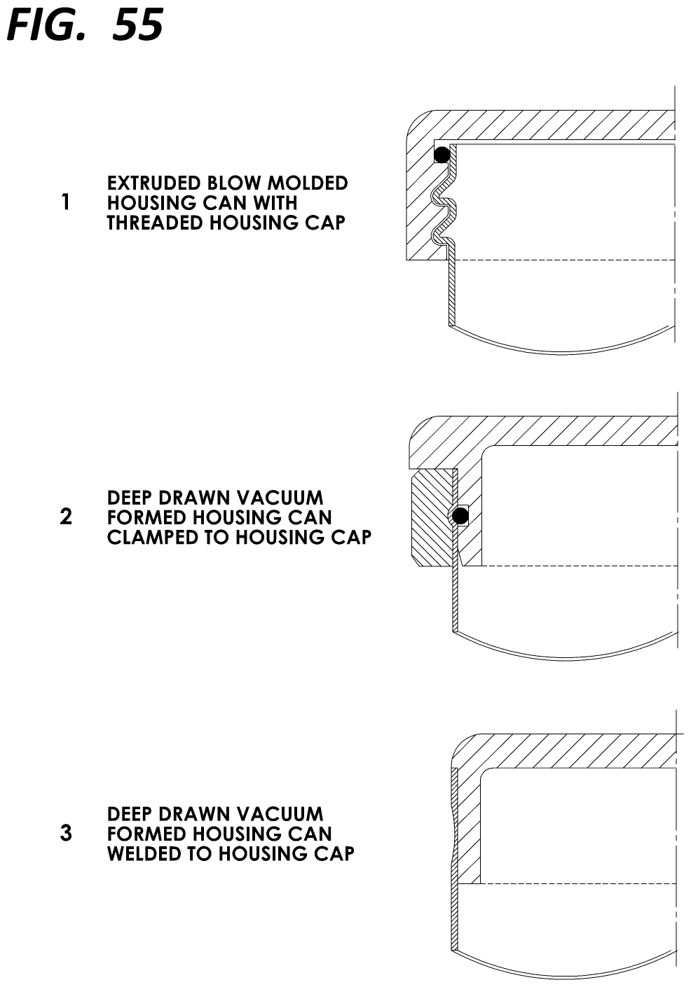

Creating a housing can 2402 from a blow molding process in which a robust threaded joint is desired, results in a relatively thick wall throughout, as the extruded parison has a constant wall thickness and when blown, it lies against the blow mold wall proportional to its diameter changes. If it is desired to have threaded section thickness of at least 0.125″, for example, then that thickness is largely maintained throughout the entire can at around 0.125″ thick. One either needs to use a thick wall approach, or compromise on the joint thickness area. In another aspect not shown in FIG. 55, housing can 2402 can be formed by a thermoforming deep drawn process that takes a film of heated plastic material, captures it in a mold, pushes it with a mandrel, and vacuums out the air to form a cup or can. The open edge can be thicker or even rolled much like a disposable drink cup. The materials can be styrene, PP, PE, etc., and are used in the food and beverage industry. Since this production process produces a uniform thin wall, it can be used to produce a housing can 2402, excepting that it will not be able to be threaded or spin-welded as its joining method. A deep drawn vacuum formed housing can 402 would need to be slipped over a male cylindrical portion of the housing cap 401, and then be crimped with a band or clamp.

Alternately, in some embodiments, a deep drawn vacuum formed housing can 2402 could be heat welded to housing cap 2401 using a thermal process. It is also a method to use an O-ring sealing element to be compressed radially against the cup and cap with a pressed-on band clamp member. Any of the welding or clamping processes makes recycling more difficult, but any of these manufacturing processes can produce a housing with reduced material amounts, such that the housing requires a superstructure for strength at service pressures. In still another embodiment, the housing can be of an elastomeric material such as rubber such that it inflates and seals up against the sump 2300 at service pressures. The inflation of the elastomeric material stores a pressurized volume of water and must be released each time the housing is depressurized which can negatively interact on/off water usage, disconnection leaks, and elastomeric membranes can easily be torn, punctured, or damaged. If elastomeric materials are used, they would need to be able to pass toxicological testing and be compatible with water concentrated sanitizers etc.

FIG. 53 depicts a variety of methods according to various embodiments to provide a superstructure engagement. In methods A-E, an equivalent receiver head 2202 is not shown for clarity so as to more easily communicate internal engagement member structures. Methods A-E denote 3-piece superstructure arrangements whereas methods F-J denote 2-piece superstructure arrangements with the functionality of the receiver head integrated into the treatment cartridge receiver.

Method A, as shown, uses a manually rotated collar with helical threads formed on the inside, which correspond with external helical threads on the sump. Methods A and D have been used and detailed as representative embodiments of the disclosure throughout this disclosure.

Method B uses an interrupted helical thread, also known as breach threads. The interruptions can be staggered to allow rapid linear engagement and reduce the rotation amount from some number of turns to one half turn or less. When the collar and sump are fully engaged by partial rotation, at least two threaded sections are simultaneously engaged and provide faster connections with a partial rotation and still have significant strength.

Method C provides two further variations; a bell-crank type linkage which converts linear linkage motion to rotary collar motion, and the use of bayonet tabs engaging the collar to the sump. Bayonet tabs can be flat or have an amount of pitch to cause linear motion during rotation.

Method D is a variation on Method A where the collar is provided with external gear teeth, such as a spur gear, which is rotated automatically by a pinion gear. Method D can also have alternate rotation provided by a belt, chain, or other gear teeth such as worm, bevel planetary, rack, and the like.

Method E provides for slot and pin operation. Collar can have at least one slot or groove which can be engaged with a corresponding pin or boss feature on the sump. Rotation of the collar can secure the sump without linear motion sump if the slot (groove) does not have any pitch or camming features which ramp the collar and sump together. If linear motion is also desired, the slot (groove) can have a relative pitch such that a ramping motion is achieved during rotation. Method E as illustrated has ramped slots which either draws sump in closer or further away axially during collar or sump rotation. In some embodiments, sump does not rotate the cartridge relative to the receiver head.

Methods F-J depicts 2-piece arrangements where no collar is used, and the upper member is shown with receiver head fluid and electrical connections. Method F provides for a rotary cam arranged to draw the sump into the head in CW rotation and withdraw upon CCW rotation. Rotary cam is shown with a slot which engages a pin or boss on the sump, but the rotary cam can also be a linear one to accomplish the same effect.

Method G shows a pair of clamp members being used to secure the sump to the head. Clamps are widely used to connect pipe and plumbing components together and can be arranged for use with or without tools for attachment and removal using levers, pins, screws, latches, etc. Clamps can be hinged and or multi components.

Method H shows a swing bolt type of joining system widely used for securing pressure vessels such as used for bag-filters, pressure pots, and the like. Swinging eyebolt hand knobs can be attached to either the head or sump as desired.

Method I shows a simple clip arrangement that can provide a secure and simple attachment. Method I shows the sump fitting inside the bell-shaped head, but the head may fit inside the sump if desired. Clip can be separate or integral to any member.

Method J shows a hinged arrangement which retains the sump after disconnection such that it remains in relationship to the head. Hinge joint can be provided with an additional degree of motion to allow linear motion with the head or swinging as desired. Sump is retained by a latching mechanism which is not shown but can include a cam, lever, bolt, knob, latch, etc.

It is also anticipated that the sump in the 3-piece arrangements in methods A-E can be retained during disconnection such that the sump is being held independent of a user's hand for example. Sump can be held by a tray, cables, arms, tracks, and so forth.

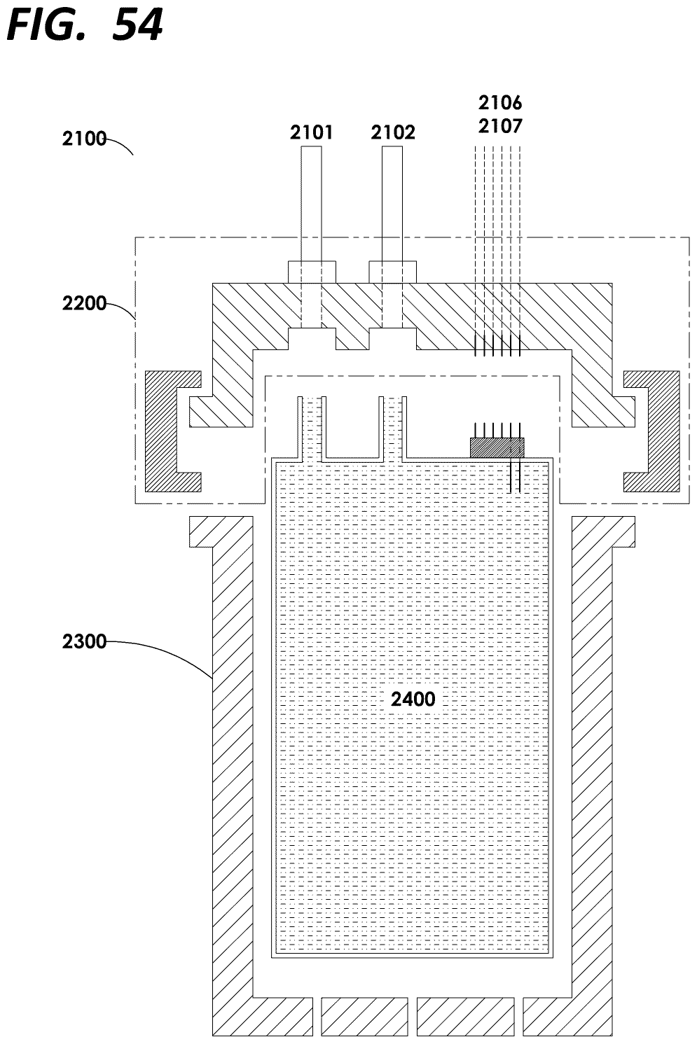

FIG. 54 schematically represents the relationship of the treatment cartridge receiver 2200, sump 2300, and smart fluid treatment cartridge 2400 according to some embodiments. Treatment cartridge receiver 2200 can be easily understood as a translator member which serves to connect and disconnect a fluid circuit from the outside environment 2100 to the smart fluid treatment cartridge 2400. Additionally, treatment cartridge receiver 2200 can connect and disconnect an electrical circuit from the outside environment 2100 to the smart fluid treatment cartridge 2400. It is also understood that treatment cartridge receiver 2200 can connect and disconnect both a fluid circuit and an electrical circuit from the outside environment 2100 to the smart fluid treatment cartridge 2400 at approximately the same time. It is also shown that smart fluid treatment cartridge 2400 is provided a structural enclosure when treatment cartridge receiver 2200 is securely engaged with sump 2300.

FIG. 52 shows the detail of check valve port 2205 according to some embodiments. Check valve port body 2205a can be provided as shown being a 90-degree elbow, or any angular relationship, such as straight or 45 degrees as desired. Check valve 2205b is oriented to prevent all fluid from being able to flow into the treatment cartridge receiver 2200 unless the check valve is forced open by the presence of a treatment cartridge with its check valve actuators 2401h shown in FIG. 46 and FIG. 50. Check valve 2205b is biased in a closed position by check valve spring 2205c, which causes contact and compression of check valve seal 2205d against check valve sealing surface 2201m shown in FIG. 49. Check valve port body 2205a is sealed with port seal 2205e with radial compression against receiver head 2201 port sealing surface 2201k. Check valve port body 2205a allows connection and sealing with tubing as desired using tube push-fitting 2205f and tube seal 2205g. Check valve port 2205 can be configured to connect with any known type of fluid connection including pipe threads, flare fittings, compression fittings, barb connections, etc. and using tubing materials such as PE, HDPE, LLDPE, PEX, copper, brass, stainless, nylon, etc.

FIG. 55 Shows some joining methods according to certain embodiments that can be used with different housing manufacturing processes. These examples show distinctions in the forming method for the housing can 2402. In these embodiments, housing cap 2401 is presumed to be injection molded plastic.

In Method 1, a representative extruded blow molded housing can 2402 is first formed by the extrusion of heated plastic resin such as polypropylene or polyethylene in a tubular parison and is clamped between metal mold halves which crimp and blind-off the parison when closed. Pressurized air is injected into the parison, and it inflates to the boundary defined by the mold halves. The housing can 2402 be formed in this manner and can have threads as shown typical of beverage containers. Note that the thickness of the blow-molded wall section is nearly constant throughout and even produces indents in the formed threads. Injection molded cap can be fitted with a suitable seal to create a water-tight joint.

In Method 2, a representative deep-drawn vacuum molded housing can 2402 is formed by using suitably thin film which is heated and drawn over a hollow cavity, clamped, and a mandrel then presses the heated film into the cavity while air is vacuumed away. Articles formed this way include disposable drinking cups and yogurt containers, etc. The deep-drawn vacuum molded housing can 2402 can be fitted to a sturdy diameter on the housing cap exterior as shown, and an outer band can be placed around the housing can 2402 by pressing, shrinking, welding, and so forth. An elastomeric seal can be used to provide increased sealing capability.

In Method 3, a similarly formed housing can 2402 as in Method 2 above, is shown as welded around its circumference, such that it melts and is bonded to a cylindrical diameter of housing cap 2401. Methods of welding include, but are not limited to, roller seam welding, laser welding, hot air welding, hot plate welding, etc. Care is taken to not reduce the housing can wall strength during the joining process as to cause subsequent failures when under high pressure, or even freezing. Another method of thermal joining can involve using radio-frequency electromagnetic radiation to heat metal disposed within the plastic members.

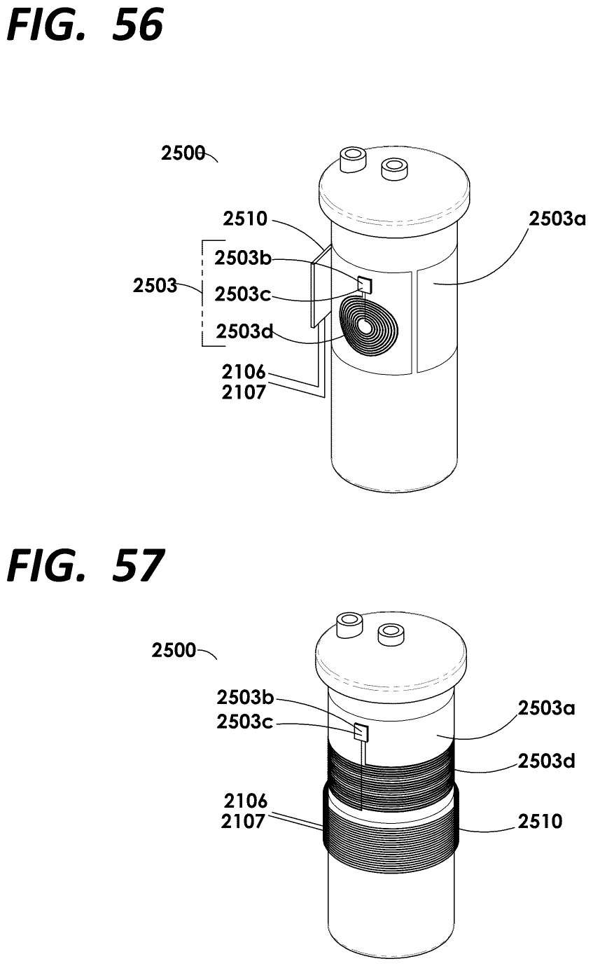

FIGS. 56 and 57 show representative alternate means to provide data and power to treatment cartridge with wireless circuit according to some embodiments. FIG. 56 has smart fluid treatment cartridge 2500 with a wireless smart memory unit 2503. Wireless smart memory unit 2503 can include a large variety of existing and future electromagnetic technologies such as RFID, NFC, BLE, Wi-Fi, Z-Wave, etc. Some of the technologies work on low frequency inductance for transferring power, such as 50 Hz-300 Khz for example, while other frequencies provide much higher data bandwidth such as 800 MHz-60 GHz, for example. Antennas suitable for wireless transfer of power and data are required on both the sending components and receiving components.

These antennas are found in many devices, such as a charging dock for a smart phone and chips within credit cards. FIG. 56 shows an example of smart fluid treatment cartridge 2500 with a local antenna 2503d integrated with a flexible PCB 2503a, such as a label film which can contain security element 2503b and/or read-write memory 2503c electrically connected to the antenna according to some embodiments. External antenna 2510 is necessary to communicate with the smart fluid treatment cartridge 2500 and is shown in close proximity in relation to the smart fluid treatment cartridge 2500. An established communication connection is not instantaneous as with a wired connection, but can occur wirelessly in about one second. The source of electrical power 2106 and read-write data path 2107 are required to be available to connect with external antenna 2510, and may involve additional external components such as a microprocessor, capacitors, transformer, resistors, ICs, etc., to condition and encode/decode data from power as required.

FIG. 57 shows an alternate example of antennas used in establishing an electro-magnetic couple for conveying electrical power and data according to some embodiments. Flexible PCB 2503a can be arranged around the cylindrical axis of smart fluid treatment cartridge 2500 and is able to couple with external antenna 2510 correspondingly arranged along the same axis, such that the cooperative antennas couple efficiently. It is well known that the antenna design for devices at low frequencies with longer wavelengths require proportionally longer antenna lengths, such as with the illustrated coils in FIGS. 56 and 57. As frequencies increase, the antenna size and orientation can change along with effective range. High frequencies promote high data bandwidth and low power, whereas low frequencies promote higher power and lower data bandwidth.

As it can be understood from the various piping and instrumentation diagram (P&ID) FIGS. 40-46, 51, and 52, a wide variety of fluid flow management modules can be constructed to perform many different and complex fluid flow paths through a variety of devices and treatment cartridges. The benefits of such fluid flow management modules are that they can be portable to many different applications and can be instantly configured to provide numerous fluid flow path modes of operation. The instant configuration by way of discrete command signals allows for a water treatment device to be configurable for operation for any future treatment cartridges with unknown technology including serial flow, parallel flow, bypass, and back flow. Additional capabilities are anticipated such as injection flow from a reservoir of concentrate, brine flow, concentrate discharge, and the like. Fluid flow management modules can be used to provide a vast array of water property metrics and adapted for easy configuring in the field.

Smart water treatment appliance 2200 can be used in certain embodiments, if connected to the internet, to order replacement cartridges to be automatically shipped to the end user. Further, end user may return the spent cartridges for factory recycling and disposal.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A liquid treatment system, comprising:
a) a containment superstructure;
b) a replaceable fluid treatment cartridge comprising:
i) a thin-walled housing disposed within the containment superstructure;
ii) a treatment media within the housing, the treatment media fluidly connected to a fluid inlet and a fluid outlet;
iii) a smart memory unit;
c) a plurality of electrically driven valves configured to control the flow of liquid through the replaceable fluid treatment cartridge;
wherein the superstructure is configured to provide the necessary structural support to the thin-walled housing of the replaceable fluid treatment cartridge to withstand pressurized liquid conditions; and
wherein the smart memory unit controls the opening and closing of at least one of the plurality of electrically driven valves.

2. The liquid treatment system of claim 1, wherein the containment superstructure comprises a cartridge sump and a receiver head.

3. The liquid treatment system of claim 1, wherein the containment superstructure is contained within a cabinet.

4. The liquid treatment system of claim 1, wherein the smart memory unit is configured to communicate with an external controller to provide data related to the cartridge's status.

5. The liquid treatment system of claim 1, wherein the plurality of electrically driven valves is disposed on a manifold.

6. The liquid treatment system of claim 5, wherein the manifold is disposed within a cabinet.

7. The liquid treatment system of claim 1, wherein the liquid treatment system further comprises a sensor, and wherein the smart memory unit is configured to log historical data from the sensor for analysis of liquid treatment performance over time.

8. The liquid treatment system of claim 1, further comprising a liquid leak sensor configured to detect leaks within a cabinet of the liquid treatment system and at least one of provide an alert to the user and disconnect the liquid treatment system from a source of pressurized and untreated liquid.

9. The liquid treatment system of claim 1, wherein the plurality of electrically driven valves are configured to operate in at least one of multiple flow modes, including serial flow, parallel flow, and bypass flow.

10. The liquid treatment system of claim 9, wherein the multiple flow modes comprise on, off, serial flow, parallel flow, through flow, bypass flow, forward flow, and backward flow.

11. A cartridge for use in a liquid treatment system, comprising:
a) a thin-walled housing;
b) a treatment media within the housing; and
c) a smart memory unit;
wherein the thin-walled housing is configured to be disposed within a superstructure to provide the necessary structural support to the thin-walled housing of the replaceable fluid treatment cartridge to withstand pressurized liquid conditions.

12. The cartridge of claim 11, wherein the smart memory unit is configured to communicate with the liquid treatment system.

13. The cartridge of claim 11, wherein the liquid treatment system is configured to adjust mode of liquid through the treatment media.

14. The cartridge of claim 13, wherein the liquid treatment system comprises a plurality of electrically driven valves configured to control the flow of liquid through the treatment media.

15. The cartridge of claim 11, wherein the containment superstructure comprises a cartridge sump and a receiver head.

16. The cartridge of claim 11, wherein the cartridge further comprises at least one internal sensor, and wherein the internal sensor is one of a lead sensor, a pH sensor, a PFAS sensor, a chlorine sensor, a heavy metals sensor, and a total dissolved solids (TDS) sensor.

17. A method for replacing a thin-walled replaceable cartridge from a liquid treatment system, comprising:
notifying a user that a useful life of a cartridge has expired;
activating a removal process on the liquid filtration system, wherein the removal process comprises automatically and without user intervention:
setting a main liquid valve to an off position; and
unsecuring the cartridge from an installed position by mechanically disengaging a sump containing the thin-walled replaceable cartridge from a receiver within the liquid treatment system;
removing the expired cartridge;
placing an unexpired cartridge into the sump; and
activating a securing process, wherein the securing process comprises automatically and without user intervention:
mechanically engaging the sump containing the unexpired cartridge to the liquid filtration system; and
setting the main liquid valve to an on position.

18. The method of claim 17, wherein the removing the expired cartridge step and the placing an unexpired cartridge step are performed by hand and without the use of tools.

19. The method of claim 17, further comprising;
configuring a plurality of valves to flush the unexpired cartridge such that the unexpired cartridge is prepared for service.

20. The method of claim 17, wherein the unsecuring the cartridge from position step and the securing the unexpired cartridge steps are each performed by a motor in electrical communication with the liquid filtration system.
